(19) United States
(12) Patent Application Publication
(10) Pub. No.: US 2011/0014504 A1
(43) Pub. Date: Jan. 20, 2011

(54) LITHIUM SECONDARY BATTERY

(75) Inventors: Masamichi Onuki, Ibaraki (JP); Shinichi Kinoshita, Ibaraki (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI CHEMICAL CORPORATION, Tokyo (JP)

(21) Appl. No.: 12/888,753

(22) Filed: Sep. 23, 2010

Related U.S. Application Data
(62) Division of application No. 11/917,656, filed on Dec. 14, 2007.

(51) Int. Cl. H01M 10/02

(52) U.S. Cl. 429/50

(57) ABSTRACT

In order to provide a lithium secondary battery having high terminal-to-terminal open circuit voltage at the end of charge, suppressed amount of evolved gas on continuous charge, and superior cycle characteristics, the electrolyte solution thereof comprises either both vinylethylene carbonate compound and vinylene carbonate compound, lactone compound having a substituent at its α position in an amount of 0.01 weight % or more and 5 weight % or less, lactones having an unsaturated carbon-carbon bond in an amount of 0.01 weight % or more and 5 weight % or less, or sulfonate compound represented by the formula below.

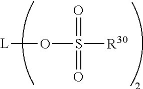

In the formula, L represents a bivalent connecting group consisting of at least one carbon atom and hydrogen atoms, and R30 represents, independently of each other, an unsubstituted or fluorine-substituted aliphatic saturated hydrocarbon group.

This is a divisional application of U.S. application Ser. No. 11/917,656, filed Dec. 14, 2007, which is a 371 of PCT/JP05/10977 filed on Jun. 15, 2007.

### TECHNICAL FIELD

The present invention relates to a lithium secondary battery using a non-aqueous electrolyte solution.

### BACKGROUND ART

A lithium secondary battery has an advantage that it has a high energy density and is not prone to self-discharge. Accordingly, it has been widely used recently as a power source of consumer-oriented mobile devices such as cellular phones, notebook computers and PDA.

An electrolyte solution of a lithium secondary battery hitherto known consists of a lithium salt, which is a supportive electrolyte, and a non-aqueous solvent. The non-aqueous solvent used for this purpose is required to have a high dielectric constant necessary for the dissociation of the lithium salt, to achieve high ion conductivity in the broad temperature range, and to be stable in the battery. It is difficult for any one solvent to satisfy all these requirements and, therefore, the non-aqueous solvent is usually used as a combination of a high boiling point solvent represented by propylene carbonate and ethylene carbonate, and a low boiling point solvent such as dimethyl carbonate and diethyl carbonate.

Furthermore, in order to improve various characteristics of a lithium secondary battery such as initial capacity, rate characteristics, cycle characteristics, high-temperature storage characteristics, low-temperature characteristics, trickle charge (continuous charge) characteristics, self-discharge characteristics and overcharge prevention characteristics, a number of methods have been reported in which small amounts of various auxiliary agents were added to the electrolyte solution. However, an ideal electrolyte solution superior in all these characteristics has not yet been developed.

On the other hand, attempts are being made to charge the battery to a high final voltage exceeding 4.2 V, in order to increase energy density. Specifically, when an ordinary lithium secondary battery hitherto known is charged at 25° C., the terminal-to-terminal open circuit voltage at the end of charge is usually 4.2 V or lower. Therefore, attempts have been made to develop a lithium secondary battery whereby terminal-to-terminal open circuit voltage at the end of charge at 25° C. exceeds 4.2 V. However, as the voltage increases, a side reaction originating from decomposition of the electrolyte solution at the positive electrode can not be avoided, leading to serious deterioration of cycle characteristics. Thus, it has been practically impossible so far to charge an ordinary lithium secondary battery until terminal-to-terminal open circuit voltage exceeds 4.2 V.

Furthermore, application of an electrolyte solution hitherto known, which has been claimed to be effective in improving cycle characteristics at a voltage of 4.2 V or lower, does not necessarily bring about improvement in battery performance at a voltage exceeding 4.2 V. For example, an electrolyte solution containing cyclohexylbenzene, disclosed in Patent Document 1, failed to bring about improvement in cycle characteristics at 4.4 V, as will be shown later in Comparative Example.

In response to a request to heighten the terminal-to-terminal open circuit voltage at the end of charge, a proposal has been made to use an electrolyte solution consisting of a non-aqueous solvent containing 50 volume % or more of γ-butyrolactone and a lithium salt, as described in Patent Document 2. In this Patent Document 2, it is also described that, by using this technique, the capacity of the secondary battery, whose terminal-to-terminal open circuit voltage at 25° C. on full charge is 4.3 V or higher, can be increased and, in addition, cycle characteristics can be improved.

According to Patent Document 3, it was found possible to suppress the elution of transition metals from lithium composite oxides by maintaining protonic impurities and water content in the electrolyte at a low level, and to increase discharge capacity after accelerated storage test at 60° C. in a battery whose voltage on charge registered 4.25 V or higher. It was also described that, by using an electrolyte solution containing less than 10 volume % of vinylene carbonate or vinylethylene carbonate, a coat was formed on the surface of the negative electrode.

Furthermore, in the Patent Document 4, it is described that, by using an electrolyte solution containing a sultone compound with a 5 to 7-membered cyclic sulfonate structure as the main skeleton, cycle characteristics at 4.3 V can be improved.

[Patent Document 1] Japanese Patent Publication No. 3417228

[Patent Document 2] Japanese Patent Laid-Open Publication (Kokai) No. 2003-272704

[Patent Document 3] The pamphlet of International Publication No. 03/019713

[Patent Document 4] Japanese Patent Laid-Open Publication (Kokai) No. 2004-235145

### DISCLOSURE OF THE INVENTION

### Problem to be Solved by the Invention

Recently, there has been an increasing demand for higher performance of a lithium secondary battery, and it has been requested that a number of characteristics such as capacity, cycle characteristics, high-temperature storage characteristics and continuous charge characteristics are realized simultaneously at a high level. Of these characteristics, improvement in continuous charge characteristics and cycle characteristics are particularly being sought, as the demand for notebook computers for office use is expanding.

However, as mentioned above, a cycle test, conducted at a final charge voltage exceeding 4.2 V, failed to give a satisfactory result, with marked deterioration of a battery. This was also true for the previously proposed techniques described in Patent Documents 1 to 4, in which a lithium secondary battery having a high terminal-to-terminal open circuit voltage at the end of charge was claimed to have been obtained.

The present invention is an attempt to solve the above problems and aims at providing a lithium secondary battery which realizes a high terminal-to-terminal open circuit voltage at the end of charge, is capable of suppressing the amount of evolved gas on continuous charge and, further, is accompanied by less extensive capacity deterioration on charge/discharge cycle.

### Means for Solving the Problem

The inventors of the present invention have made an intensive investigation in order to solve these problems. They found that it is possible to heighten a terminal-to-terminal open circuit voltage at the end of charge by including in the non-aqueous electrolyte solution both vinylethylene carbonate compound and vinylene carbonate compound, or by including at least one kind of compounds selected from among lactone compound having a substituent at its a position, lactone compound having an unsaturated carbon-carbon bond, and sulfonate compound of specific structure. It was also found possible to suppress the amount of evolved gas on continuous charge and improve cycle capacity retention rate, which led to the completion of the present invention.

Accordingly, a lithium secondary battery of the present invention comprises: a positive electrode; a negative electrode; and a non-aqueous electrolyte solution containing both at least one vinylethylene carbonate compound and at least one vinylene carbonate compound, wherein the terminal-to-terminal open circuit voltage at 25° C. at the end of charge is 4.25 V or higher.

As one preferred feature, said vinylene carbonate compound is vinylene carbonate.

As another preferred feature, said vinylethylene carbonate compound is at least one type selected from the group consisting of vinylethylene carbonate, 1,2-divinylethylene carbonate and 1-methyl-1-vinylethylene carbonate.

Another lithium secondary battery of the present invention is a lithium secondary battery comprising: a positive electrode; a negative electrode; and a non-aqueous electrolyte solution satisfying at least one of the following (i) to (iii) Conditions, wherein the terminal-to-terminal open-circuit voltage at 25° C. at the end of charge is 4.25 V or higher. Here,

Condition (i) represents that said non-aqueous electrolyte solution contains lactone compound having a substituent at its α position in an amount of 0.01 weight % or more, and 5 weight % or less,

Condition (ii) represents that said non-aqueous electrolyte solution contains lactone compound having an unsaturated carbon-carbon bond in an amount of 0.01 weight % or more, and 5 weight % or less, and

Condition (iii) represents that said non-aqueous electrolyte solution contains sulfonate compound represented by the formula (3-1) below,

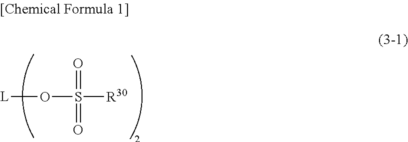

wherein in the formula (3-1), L represents a bivalent connecting group consisting of at least one carbon atom and hydrogen atoms, and R³⁰ represents, independently of each other, an unsubstituted or fluorine-substituted aliphatic saturated hydrocarbon group.

As one preferred feature, said non-aqueous electrolyte solution contains unsaturated carbonate compound.

As another preferred feature, the lactone ring belonging to said lactone compound having a substituent at its α position is either a 5-membered ring or a 6-membered ring.

As still another preferred feature, the substituent of said lactone compound having a substituent at its α position is a hydrocarbon group with 1 to 15 carbon atoms.

As a further preferred feature, the substituent of said lactone compound having a substituent at its α position is a methyl group or a phenyl group.

It is also preferred that said lactone compound having a substituent at its α position are compounds selected from the group consisting of lactide, α-methyl-γ-butyrolactone, α-phenyl-γ-butyrolactone, α,α-dimethyl-γ-butyrolactone and α,α-diphenyl-γ-butyrolactone.

It is also preferred that the lactone ring belonging to said lactone compound having an unsaturated carbon-carbon bond is either a 5-membered ring or a 6-membered ring.

It is also preferred that said lactone compound having an unsaturated carbon-carbon bond are either α,β-unsaturated lactone compound or β,γ-unsaturated lactone compound.

It is also preferred that said lactone compound having an unsaturated carbon-carbon bond are compounds represented by the formula (2-1) below,

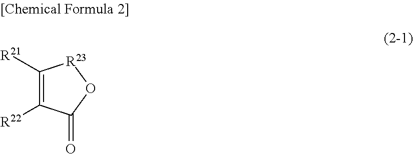

wherein in the formula (2-1), R²¹ and R²² represent, independently of each other, a hydrogen atom or a univalent hydrocarbon group that may have a substituent, and R²³ represents a bivalent hydrocarbon group that may have a substituent.

It is also preferred that said lactone compound having an unsaturated carbon-carbon bond is compound represented by the formula (2-2) below,

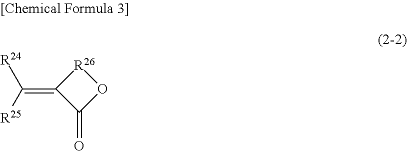

wherein in the formula (2-2), R²⁴ and R²⁵ represent, independently of each other, a hydrogen atom or a univalent hydrocarbon group that may have a substituent, and R²⁶ represents a bivalent hydrocarbon group that may have a substituent.

It is also preferred that said lactone compound having an unsaturated carbon-carbon bond is compound represented by the formula (2-3) below,

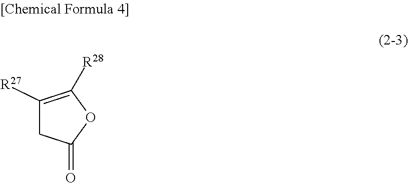

wherein in the formula (2-3), R²⁷ and R²⁸ represent, independently of each other, a hydrogen atom or a univalent hydrocarbon group that may have a substituent.

It is further preferred that the content of said lactone compound having an unsaturated carbon-carbon bond in said non-aqueous electrolyte solution is 0.1 weight % or more and 2 weight % or less.

It is also preferred that said lactone compound having an unsaturated carbon-carbon bond are compounds selected from the group consisting of 3-methyl-2(5H)-furanone, α-methylene-γ-butyrolactone, α-angelica lactone, 4,6-dimethyl-α-pyrone, 5,6-dihydro-2H-pyran-2-one and α-pyrone.

It is also preferred that the above-mentioned terminal-to-terminal open circuit voltage is 4.3 V or higher.

### ADVANTAGEOUS EFFECT OF THE INVENTION

According to the present invention, in a lithium secondary battery, it is possible to charge the battery up to a high terminal-to-terminal open circuit voltage, suppress the amount of gas evolved on continuous charge, and improve the cycle characteristics.

### BRIEF DESCRIPTION OF THE DRAWINGS

FIG. 1 is a schematic cross-sectional view illustrating the structure of a lithium secondary battery prepared in Examples, Comparative examples and Reference examples of the present invention.

### BEST MODE FOR CARRYING OUT THE INVENTION

An embodiment of the present invention will be explained below. It is to be noted that this embodiment is by no means restrictive and any modifications can be added thereto insofar as they do not depart from the scope of the present invention.

The lithium secondary battery of the present invention comprises a non-aqueous electrolyte solution, a positive electrode and a negative electrode as components. However, other components may be added to the lithium secondary battery of the present invention.

[I. Non-Aqueous Electrolyte Solution]

The non-aqueous electrolyte solution used in the lithium secondary battery of the present invention (hereinafter referred to as “the non-aqueous electrolyte solution of the present invention” as appropriate) contains at least both vinylethylene carbonate compound and vinylene carbonate compound, or satisfies at least one of the conditions described below as (i) to (iii).

Condition (i) represents that said non-aqueous electrolyte solution contains lactone compound having a substituent at its α position in an amount of 0.01 weight % or more, and 5 weight % or less.

Condition (ii) represents that said non-aqueous electrolyte solution contains lactone compound having an unsaturated carbon-carbon bond in an amount of 0.01 weight % or more, and 5 weight % or less.

Condition (iii) represents that said non-aqueous electrolyte solution contains sulfonate compound represented by the formula (3-1) below.

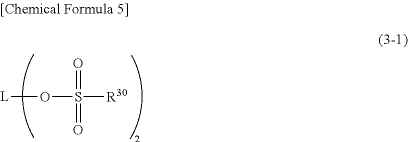

(In the formula (3-1), L represents a bivalent connecting group consisting of carbon atoms and hydrogen atoms. R³⁰ represents, independently of each other, an unsubstituted or fluorine-substituted aliphatic saturated hydrocarbon group.)

Further, the non-aqueous electrolyte solution of the present invention is a non-aqueous electrolyte solution which contains at least an electrolyte and a non-aqueous solvent.

[I-1. In Case a Non-Aqueous Electrolyte Solution of the Present Invention Contains Both Vinylethylene Carbonate Compound and Vinylene Carbonate Compound]

[I-1-1. Vinylethylene Carbonate Compound]

[I-1-1-1. Kind of Vinylethylene Carbonate Compound]

In case a non-aqueous electrolyte solution of the present invention contains both vinylethylene carbonate compound and vinylene carbonate compound, the vinylethylene carbonate compound contained in the non-aqueous electrolyte solution of the present invention (hereinafter referred to as “vinylethylene carbonate compound of the present invention”, as appropriate) indicates vinylethylene carbonate itself and vinylethylene carbonate in which its hydrogen atom is substituted by at least one substituent.

There is no special limitation on the kind of the substituent of vinylethylene carbonate compound of the present invention insofar as the advantage of the present invention is not significantly impaired. As examples can be cited alkyl group such as methyl group and ethyl group; alkenyl group such as vinyl group and allyl group; aryl group such as phenyl group and tolyl group; alkoxy group such as methoxy group and ethoxy group; halogen group such as fluoro group, chloro group and bromo group. Particularly preferred are hydrocarbon groups such as alkyl group, alkenyl group and aryl group.

Vinylethylene carbonate compound of the present invention suppresses the reaction of the electrolyte solution through forming a protective coat on the negative electrode and positive electrode on initial charge and, therefore, can improve cycle characteristics of the lithium secondary battery of the present invention.

There is no special limitation on the molecular weight of vinylethylene carbonate compound of the present invention insofar as the advantage of the present invention is not significantly impaired. The molecular weight is usually 100 or higher, and usually 300 or lower, preferably 200 or lower, more preferably 150 or lower. In case the molecular weight exceeds the upper limit of the above range, compatibility or solubility of vinylethylene carbonate compound of the present invention in the non-aqueous electrolyte solution decreases, and sufficient advantage of improvement in cycle characteristics of a lithium secondary battery, based on this non-aqueous electrolyte solution, can not be guaranteed.

As concrete examples of vinylethylene carbonate compound of the present invention can be cited vinylethylene carbonates such as vinylethylene carbonate, 1,1-divinylethylene carbonate, 1,2-divinylethylene carbonate; alkyl-substituted vinylethylene carbonates such as 1-methyl-1-vinylethylene carbonate, 1-methyl-2-vinylethylene carbonate, 1-ethyl-1-vinylethylene carbonate, 1-ethyl-2-vinylethylene carbonate, 1,1-dimethyl-1-vinylethylene carbonate, 1,2-dimethyl-1-vinylethylene carbonate, 1,1-diethyl-1-vinylethylene carbonate, 1,2-diethyl-1-vinylethylene carbonate, 1,2,2-trimethyl-1-vinylethylene carbonate, 1,2,2-triethyl-1-vinylethylene carbonate; aryl-substituted vinylethylene carbonates such as 1-phenyl-1-vinylethylene carbonate, 1-phenyl-2-vinylethylene carbonate, 1,1-diphenyl-1-vinylethylene carbonate and 1,2-diphenyl-1-vinylethylene carbonate.

Of these, preferable are vinylethylene carbonates such as vinylethylene carbonate, 1,1-divinylethylene carbonate and 1,2-divinylethylene carbonate; mono-substituted alkyl vinylethylene carbonates such as 1-methyl-1-vinylethylene carbonate, 1-methyl-2-vinylethylene carbonate, 1-ethyl-1-vinylethylene carbonate and 1-ethyl-2-vinylethylene carbonate. Furthermore, more preferable are vinylethylene carbonate, 1,2-divinylethylene carbonate and 1-methyl-1-vinylethylene carbonate.

The vinylethylene carbonate compound of the present invention mentioned above can be used either singly or as a mixture of two or more kinds in any combination and in any ratio.

[I-1-1-2. Composition of Vinylethylene Carbonate Compound]

In case the non-aqueous electrolyte solution of the present invention contains both vinylethylene carbonate compound and vinylene carbonate compound, there is no special limitation on the concentration of vinylethylene carbonate compound insofar as the advantage of the present invention is not significantly impaired. The concentration is usually 0.1 weight % or higher, preferably 0.3 weight % or higher, more preferably 0.5 weight % or higher, and usually 8 weight % or lower, preferably 5 weight % or lower, more preferably 3 weight % or lower. When the concentration is below the above lower limit, it may not be possible to improve the cycle characteristics of the non-aqueous electrolyte solution of the present invention. On the other hand, when the concentration exceeds the upper limit, a thick film will be formed on the negative electrode and, because of high resistance of this film, migration of lithium ions between the non-aqueous electrolyte solution and the negative electrode becomes difficult, leading possibly to deterioration of battery characteristics such as rate characteristics. In case two or more kinds of vinylethylene carbonate compounds of the present invention are used in combination, the sum of the concentration of those vinylethylene carbonate compounds should be adjusted to fall within the above range.

[I-1-2. Vinylene Carbonate Compound]

[I-1-2-1. Kind of Vinylene Carbonate Compound]

In case the non-aqueous electrolyte solution of the present invention contains both vinylethylene carbonate compound and vinylene carbonate compound, the vinylene carbonate compound contained in the non-aqueous electrolyte solution of the present invention (hereinafter referred to as “the vinylene carbonate compound of the present invention”, as appropriate) indicates vinylene carbonate itself and vinylene carbonate in which its hydrogen atom is substituted by at least one substituent.

There is no special limitation on the kind of the substituent of vinylene carbonate compound of the present invention insofar as the advantage of the present invention is not significantly impaired. As examples can be cited alkyl group such as methyl group and ethyl group; alkenyl group such as vinyl group and allyl group; aryl group such as phenyl group and tolyl group; alkoxy group such as methoxy group and ethoxy group; halogen group such as fluoro group, chloro group and bromo group. Particularly preferred are hydrocarbon groups such as alkyl group, alkenyl group and aryl group.

There is no special limitation on the molecular weight of vinylene carbonate compound of the present invention insofar as the advantage of the present invention is not significantly impaired. The molecular weight is usually 80 or higher, and usually 300 or lower, preferably 200 or lower, more preferably 120 or lower. In case the molecular weight exceeds the upper limit of the above range, compatibility or solubility of vinylene carbonate compound of the present invention in the non-aqueous electrolyte solution decreases, and sufficient advantage of improvement in cycle characteristics of a lithium secondary battery of the present invention, based on this non-aqueous electrolyte solution, can not be guaranteed.

As concrete examples of vinylene carbonate compound of the present invention can be cited vinylene carbonate, methylvinylene carbonate, 1,2-dimethylvinylene carbonate, 1,2-diethylvinylene carbonate, 1-ethyl-2-methylvinylene carbonate, phenylvinylene carbonate, 1,2-diphenylvinylene carbonate, 1-methyl-2-phenylvinylene carbonate.

Of these, preferable are vinylene carbonate, 1,2-dimethylvinylene carbonate and 1,2-diphenylvinylene carbonate. Particularly preferable is vinylene carbonate. This is because vinylene carbonate forms a particularly stable interface-protecting film on the negative electrode, bringing about improvement in cycle characteristics of a lithium secondary battery of the present invention.

The vinylene carbonate compound of the present invention mentioned above can be used either singly or as a mixture of two or more kinds in any combination and in any ratio.

[I-1-2-2. Composition of Vinylene Carbonate Compound]

In case the non-aqueous electrolyte solution of the present invention contains both vinylethylene carbonate compound and vinylene carbonate compound, there is no special limitation on the concentration of vinylene carbonate compound insofar as the advantage of the present invention is not significantly impaired. The concentration is usually 0.1 weight % or higher, preferably 0.3 weight % or higher, more preferably 0.5 weight % or higher, and usually 10 weight % or lower, preferably 5 weight % or lower, more preferably 3 weight % or lower. When the concentration is below the above lower limit, it may not be possible for the non-aqueous electrolyte solution of the present invention to improve the cycle characteristics. On the other hand, when the concentration exceeds the upper limit, a thick protective film will be formed on the negative electrode and, because of high resistance of this film, migration of lithium ions between the non-aqueous electrolyte solution and the negative electrode becomes difficult, leading possibly to deterioration of battery characteristics such as rate characteristics. In case two or more kinds of vinylene carbonate compounds of the present invention are used in combination, the sum of the concentration of those vinylene carbonate compounds should be adjusted to fall within the above range.

[I-1-3. Ratio of Vinylethylene Carbonate Compound and Vinylene Carbonate Compound]

In case the non-aqueous electrolyte solution of the present invention contains both vinylethylene carbonate compound and vinylene carbonate compound, there is no special limitation on the ratio of vinylethylene carbonate compound and vinylene carbonate compound in the non-aqueous electrolyte solution of the present invention, insofar as the advantage of the present invention is not significantly impaired. However, the molar ratio of vinylethylene carbonate compound to the total number of moles of vinylethylene carbonate compound and vinylene carbonate compound is usually 0.01 or more, preferably 0.1 or more, more preferably 0.2 or more, and usually 0.9 or less, preferably 0.8 or less, more preferably 0.7 or less. When the above ratio is too low, the stability of a negative electrode protective coat is not guaranteed, leading possibly to inadequate improvement of cycle characteristics and, when it is too high, the evolution of gas is not adequately suppressed at the positive electrode, leading possibly to deterioration of cycle characteristics.

[I-1-4. Non-Aqueous Solvent]

In case the non-aqueous electrolyte solution of the present invention contains both vinylethylene carbonate compound and vinylene carbonate compound, there is no special limitation on the kind of the non-aqueous solvent and any known non-aqueous solvent can be used. Usually, organic solvents are used. As examples of the non-aqueous solvent can be cited chain carbonate, cyclic carbonate, chain ester, cyclic ester (lactone compound), chain ether, cyclic ether, sulfur-containing organic solvent. Of these solvents, chain carbonate, cyclic carbonate, chain ester, cyclic ester, chain ether and cyclic ether are usually preferred because they can achieve high ionic conduction.

As concrete examples of chain carbonate can be cited dimethyl carbonate, diethyl carbonate, ethylmethyl carbonate, methylpropyl carbonate and ethylpropyl carbonate.

As concrete examples of cyclic carbonate can be cited ethylene carbonate, propylene carbonate and butylene carbonate.

As concrete examples of chain ester can be cited methyl formate, methyl acetate and methyl propionate.

As concrete examples of cyclic ester can be cited γ-butyrolactone and γ-valerolactone.

As concrete examples of chain ether can be cited 1,2-dimethoxyethane, 1,2-diethoxyethane and diethyl ether.

As concrete examples of cyclic ether can be cited tetrahydrofuran, 2-methyltetrahydrofuran, 1,3-dioxolan, 4-methyl-1,3-dioxolan.

As concrete examples of sulfur-containing organic solvent can be cited sulfolane and dimethyl sulfoxide.

The non-aqueous solvent can be used either singly or as a mixture of two or more kinds in any combination and in any ratio. It is preferable, however, that two or more kinds of non-aqueous solvents are used as a mixture in order to achieve the desired characteristics, namely, desired cycle characteristics. It is highly preferable that the solvent consists mainly of cyclic carbonate and chain carbonate or cyclic ester. The term ‘mainly’ used here means specifically that the non-aqueous solvent contains cyclic carbonate, chain carbonate or cyclic ester to the extent of 70 weight % or more in total.

In case two or more kinds of non-aqueous solvents are used in combination, examples of preferable combination include two-solvent system such as ethylene carbonate and methyl ethyl carbonate, ethylene carbonate and diethyl carbonate, and ethylene carbonate and γ-butyrolactone; three-solvent system such as ethylene carbonate, dimethyl carbonate and ethylmethyl carbonate, ethylene carbonate, ethylmethyl carbonate and diethyl carbonate. A non-aqueous solvent consisting mainly of these components realizes various characteristics in a well-balanced manner and, therefore, can be used conveniently.

In case an organic solvent is used as non-aqueous solvent, there is no special limitation on the number of carbon atoms of the organic solvent, insofar as the advantage of the present invention is not significantly impaired. The number is usually 3 or more, and usually 13 or less, preferably 7 or less. When the number of carbon atoms is too large, the solubility of the electrolyte in the electrolyte solution becomes small and improvement of cycle characteristics, which is the advantage of the present invention, may not be achieved adequately. On the other hand, when the number of carbon atoms is too small, the volatility tends to be high, leading possibly to high internal pressure of the battery, which is not desirable.

Furthermore, there is no special limitation on the molecular weight of organic solvent used as non-aqueous solvent, insofar as the advantage of the present invention is not significantly impaired. It is usually 50 or more, preferably 80 or more, and usually 250 or less, preferably 150 or less. When the molecular weight is too large, the solubility of the electrolyte in the electrolyte solution becomes small and viscosity increases also and improvement of cycle characteristics, which is the advantage of the present invention, may not be achieved adequately. On the other hand, when the molecular weight is too small, the volatility tends to be high, leading possibly to high internal pressure of the battery, which is not desirable.

In case two or more kinds of non-aqueous solvents are used in combination in two- or more than two-solvent system, the ratio of cyclic carbonate in the non-aqueous solvent of the two- or more than two-solvent system is usually 10 volume % or more, preferably 15 volume % or more, more preferably 20 volume % or more, and usually 60 volume % or less, preferably 50 volume % or less, more preferably 40 volume % or less. When the ratio is below the lower limit of the above-mentioned range, dissociation of the lithium salt is difficult to occur, leading to lowering of electroconductivity and therefore a decrease in high-load capacitance. When the ratio exceeds the upper limit, the viscosity of the solution becomes too high and the migration of lithium ions is not easy, leading to a decrease in high-load capacitance.

It is to be noted that, in case γ-butyrolactone is used, it is usually preferable to adjust its concentration to 20 weight % or less.

[I-1-5. Electrolyte]

In case the non-aqueous electrolyte solution of the present invention contains both vinylethylene carbonate compound and vinylene carbonate compound, there is no special limitation on the kind of the electrolyte used and any known electrolytes, which are known to be used as electrolytes of a lithium secondary battery, can be used. Usually, a lithium salt is used.

As lithium salt used as electrolyte, both an inorganic lithium salt and an organic lithium salt can be used.

As examples of inorganic lithium salts can be cited inorganic fluorides such as LiPF₆, LiAsF₆, LiBF₄ and LiSbF₆; inorganic chlorides such as LiAlCl₄, perhalogenates such as LiClO₄, LiBrO₄ and LiIO₄.

As examples of organic lithium salts can be cited fluorine-containing organic lithium salts as listed below: perfluoroalkane sulfonates such as CF₃SO₃Li, and C₄F₉SO₃Li; perfluoroalkane carboxylates such as CF₃COOLi; perfluoroalkane carbonimide such as (CF₃CO)₂NLi; perfluoroalkane sulfonimide such as (CF₃SO₂)₂NLi and (C₂F₅SO₂)₂NLi.

Of these electrolytes, preferable are LiPF₆, LiBF₄, CF₃SO₃Li and (CF₃SO₂)₂NLi because of their high solubility in the non-aqueous solvent and high dissociation capability.

The electrolyte can be used either singly or as a mixture of two or more kinds in any combination and in any ratio.

In particular, combined use of LiPF₆ and LiBF₄, or LiPF₆ and (CF₃SO₂)₂NLi is preferable because it is effective in improving continuous charge characteristics.

There is no special limitation on the concentration of the electrolyte in the non-aqueous electrolyte solution, insofar as the advantage of the present invention is not significantly impaired. The concentration in the non-aqueous electrolyte solution is usually 0.5 mol/L or higher, preferably 0.75 mol/L or higher, and usually 2 mol/L or lower, preferably 1.75 mol/L or lower. When the concentration of the electrolyte is too low, the electric conductivity of the non-aqueous electrolyte solution may be insufficient.

On the other hand, when the concentration of the electrolyte is too high, the viscosity of the solution becomes high, the electric conductivity becomes low and precipitation of the electrolyte tends to occur at low temperature, which may lead to lower performance of the lithium secondary battery.

[I-1-6. Other Auxiliary Agent]

In case the non-aqueous electrolyte solution of the present invention contains both vinylethylene carbonate compound and vinylene carbonate compound, the non-aqueous electrolyte solution of the present invention may contain other auxiliary agent in order to improve such characteristics as permeability of the non-aqueous electrolyte solution and overcharge characteristics of the battery, insofar as the advantage of the present invention is not significantly impaired.

As examples of auxiliary agent can be cited acid anhydrides such as maleic anhydride, succinic anhydride and glutaric anhydride; carboxylic acid esters such as vinyl acetate, divinyl adipate and allyl acetate; sulfur-containing compounds such as diphenyl disulfide, 1,3-propane sultone, 1,4-butane sultone, dimethylsulfone, divinylsulfone, dimethylsulfite, ethylenesulfite, 1,4-butanediol dimethanesulfonate, methyl methanesulfonate and methanesulfonic acid-2-propinyl; aromatic compounds or fluorine-substituted aromatic compounds such as t-butylbenzene, biphenyl, o-terphenyl, 4-fluorobiphenyl, fluorobenzene, 2,4-difluorobenzene, cyclohexylbenzene, diphenylether, 2,4-difluoroanisole and trifluoromethylbenzene.

The auxiliary agent can be used either singly or as a mixture of two or more kinds in any combination and in any ratio.

There is no special limitation on the concentration of the auxiliary agent in the non-aqueous electrolyte solution, insofar as the advantage of the present invention is not significantly impaired. The concentration is usually 0.01 weight % or higher, preferably 0.05 weight % or higher, and usually 10 weight % or lower, preferably 5 weight % or lower. In case two or more kinds of auxiliary agents are used in combination, the sum of their concentrations should fall within the above range.

[I-1-7. State of Non-Aqueous Electrolyte Solution]

In case the non-aqueous electrolyte solution of the present invention contains both a vinylethylene carbonate compound and a vinylene carbonate compound, the non-aqueous electrolyte solution, when used for the lithium secondary battery of the present invention, usually exists in the liquid state. It is possible to make it, for example, to be a semi-solid electrolyte, by adding polymer to gelate it. There is no special limitation on the polymer used for making a gel. Examples are polyfluorovinylidene, copolymer of polyfluorovinylidene and hexafluoropropylene, polyethylene oxide, polyacrylate and polymethacrylate. The polymer to be used for making a gel can be used either singly or as a mixture of two or more compounds in any combination and in any ratio.

In case the non-aqueous electrolyte solution is used in the state of semi-solid electrolyte, there is no special limitation on the ratio occupied by the non-aqueous electrolyte solution in the semi-solid electrolyte insofar as the advantage of the present invention is not significantly impaired. The preferable range of ratio of the non-aqueous electrolyte solution in the total amount of the semi-solid electrolyte is usually 30 weight % or higher, preferably 50 weight % or higher, more preferably 75 weight % or higher, and usually 99.95 weight % or lower, preferably 99 weight % or lower, more preferably 98 weight % or lower. When the ratio of the non-aqueous electrolyte solution is too high, the retention of the electrolyte solution is difficult and leakage of the solution is liable to occur. On the other hand, when the ratio is too low, efficiency during charge/discharge and capacity tend to be insufficient.

[I-1-8. Production Method of Non-Aqueous Electrolyte Solution]

In case the non-aqueous electrolyte solution of the present invention contains both vinylethylene carbonate compound and vinylene carbonate compound, the non-aqueous electrolyte solution of the present invention can be prepared by dissolving in the non-aqueous solvent electrolyte, vinylethylene carbonate compound and vinylene carbonate compound of the present invention, and, as needed, other auxiliary agents.

In the preparation of the non-aqueous electrolyte solution, it is preferable that each material of the non-aqueous electrolyte solution, namely electrolyte, vinylethylene carbonate compound and vinylene carbonate compound of the present invention, non-aqueous solvent and other auxiliary agent, is dehydrated before use. The extent of dehydration, in terms of water content, is usually 50 ppm or lower, preferably 30 ppm or lower. In this specification, ppm indicates a proportion based on weight.

When water is present in the non-aqueous electrolyte solution, reactions such as electrolysis of water, reaction between water and metallic lithium, hydrolysis of lithium salt, are likely to occur, which is not desirable.

There is no special limitation on the method of dehydration. When dehydrating liquid such as non-aqueous solvent, molecular sieve or the like can be used. When dehydrating solid such as electrolyte, drying can be applied at a temperature where decomposition of that solid does not occur.

[I-2. In Case the Non-Aqueous Electrolyte Solution of the Present Invention Contains Lactone Compound Having a Substituent at its α Position in an Amount of 0.01 Weight % or More and 5 Weight % or Less.]

[I-2-1. Lactone Compound Having a Substituent at its α Position]

[I-2-1-1. Kind of Lactone Compound Having a Substituent at its α Position]

The lactone compound having a substituent at its α position contained in the non-aqueous electrolyte solution of the present invention (hereinafter referred to as “the α-substituted lactone compound” as appropriate) is at least one lactone selected from the group of lactones each of which possesses a substituent at its α position. Any such lactone can be used.

Therefore, the above α-substituted lactone may be either a saturated lactone or an unsaturated lactone.

The size of the lactone ring, which belongs to the α-substituted lactone, is also arbitrary. However, a 5-membered lactone and 6-membered lactone are preferable because they are easy to prepare, chemically stable and inexpensive.

This α-substituted lactone compound may have an additional substituent at α position other than α.

As the α-substituted lactone compound, preferable are usually those represented by the formulae (1-1) and (1-2) below, because they are stable in the non-aqueous electrolyte solution of the present invention, relatively easy to prepare and inexpensive to obtain.

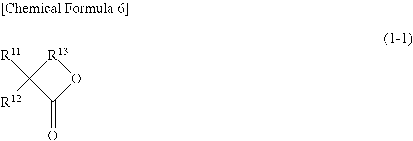

(In the above formula (1-1), R¹¹ and R¹² represent a hydrogen atom or a univalent substituent and at least one of R¹¹ and R¹² represents a substituent. R¹³ represents a divalent substituent with 1 to 8 carbon atoms.)

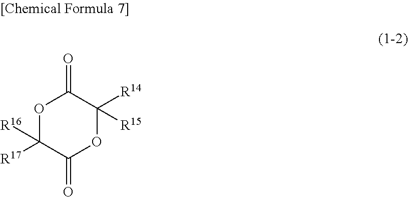

(In the above formula (1-2), R¹⁴ to R¹⁷ represent a hydrogen atom or a univalent substituent. At least either R¹⁴ or R¹⁵ represents a substituent and at least either R¹⁶ or R¹⁷ represents a substituent.)

In the above formula (1-1), R¹¹ and R¹² represent a hydrogen atom or a substituent, and at least one of R¹¹ and R¹² is a substituent. This is instrumental in suppressing the decomposition reaction mainly at the negative electrode.

Furthermore, it is preferable that both R¹¹ and R¹² are substituents. This is because the decomposition reaction is remarkably suppressed at the negative electrode.

In case R¹¹ and R¹² are substituents, there is no special limitation on their kind. Usually, a hydrocarbon group and halogen group are preferred. This is because these compounds are relatively stable in the non-aqueous electrolyte solution.

In case R¹¹ and R¹² are a hydrocarbon group, the numbers of their carbon atoms are usually one or more, and 15 or less.

As hydrocarbon group preferable as R¹¹ and R¹² can be cited alkyl group, aryl group, alkenyl group and aralkyl group.

In case R¹¹ and R¹² are an alkyl group, the number of carbon atoms of the alkyl group is usually one or more, and usually 8 or less, preferably 3 or less, more preferably 2 or less. If this upper limit is exceeded, the solubility of the α-substituted lactone compound in the non-aqueous electrolyte solution decreases and the viscosity and, therefore, resistance of the non-aqueous electrolyte solution containing the α-substituted lactone compound increases, leading possibly to insufficient battery capacity of a lithium secondary battery based on this non-aqueous electrolyte solution.

Concrete examples of alkyl groups preferable as R¹¹ and R¹² include methyl group, ethyl group, propyl group and butyl group. Of these, methyl group and ethyl group are more preferable and methyl group is particularly preferable. This is because methyl group is small in steric hindrance and can form a coat on active spots of the positive electrode surface more easily.

In case R¹¹ and R¹² are an aryl group, the number of carbon atoms of the aryl group is usually 6 or more, and usually 15 or less, preferably 8 or less. If this upper limit is exceeded, similarly to the case of alkyl group, the solubility of the α-substituted lactone compound in the non-aqueous electrolyte solution decreases and the viscosity and, therefore, resistance of the non-aqueous electrolyte solution containing the α-substituted lactone compound increases, leading possibly to insufficient battery capacity of a lithium secondary battery based on this non-aqueous electrolyte solution.

Concrete examples of aryl groups preferable as R¹¹ and R¹² include phenyl group, tolyl group, ethylphenyl group, dimethylphenyl group, α-naphthyl group and β-naphthyl group. Of these, phenyl group and tolyl group are more preferable and phenyl group is particularly preferable.

In case R¹¹ and R¹² are an alkenyl group, the number of carbon atoms of the alkenyl group is usually 2 or more, and usually 8 or less, preferably 4 or less. If this upper limit is exceeded, similarly to the case of alkyl group and aryl group, the solubility of the α-substituted lactone compound in the non-aqueous electrolyte solution decreases and the viscosity and, therefore, resistance of the non-aqueous electrolyte solution containing α-substituted lactone compound increases, leading possibly to insufficient battery capacity of a lithium secondary battery based on this non-aqueous electrolyte solution.

Concrete examples of alkenyl groups preferable as R¹¹ and R¹² include vinyl group, isopropenyl group and allyl group. Of these, vinyl group and allyl group are more preferable.

In case R¹¹ and R¹² are an aralkyl group, the number of carbon atoms of the aralkyl group is usually 7 or more, and usually 12 or less, preferably 8 or less. If this upper limit is exceeded, similarly to the case of alkyl group, aryl group and alkenyl group, the solubility of α-substituted lactone compound in the non-aqueous electrolyte solution decreases and the viscosity and, therefore, resistance of the non-aqueous electrolyte solution containing α-substituted lactone compound increases, leading possibly to insufficient battery capacity of a lithium secondary battery based on this non-aqueous electrolyte solution.

Concrete examples of aralkyl groups preferable as R¹¹ and R¹² include benzyl group, α-phenethyl group and β-phenethyl group. Of these, benzyl group is more preferable.

In case R¹¹ and R¹² are a halogen group, concrete examples include fluoro group, chloro group, bromo group and iodo group. Of these, fluoro group is more preferable because lactones containing fluoro group are stable in electrolyte solutions.

As at least either one of R¹¹ and R¹² is a substituent, it is preferable that at least either one of R¹¹ and R¹² is selected from the group consisting of alkyl group, aryl group, alkenyl group, aralkyl group and halogen group.

Furthermore, it is more preferable that at least either one of R¹¹ and R¹² is a methyl group or phenyl group because of moderate electron-donating effect and sufficient stability in the electrolyte solution.

Of the possible combinations of R¹¹ and R¹² exemplified above, preferable ones are methyl group and hydrogen atom, methyl group and methyl group, phenyl group and hydrogen atom, phenyl group and phenyl group, tolyl group and tolyl group, and naphthyl group and naphthyl group. These combinations are superior because they are then easy to prepare and stable in the non-aqueous electrolyte solution of the present invention.

In case R¹¹ and R¹² are a hydrocarbon group, the hydrocarbon group may have an additional substituent. There is no special limitation on the kind of the substituent belonging to the hydrocarbon group. Halogen group and alkoxy group are possible examples. As concrete examples of R¹¹ and R¹², in which hydrocarbon group has an additional substituent, can be cited fluorophenyl group, chlorophenyl group, difluorophenyl group, methoxyphenyl group and ethoxyphenyl group.

In the above formula (1-1), R¹³ represents a bivalent substituent having 1 to 8 carbon atoms. There is no special limitation on the concrete kind of R¹³. Examples are alkylene group such as methylene group, ethylene group, propylene group and butylene group, and substituted alkylene group such as methylmethylene group and methylethylene group.

Of these, preferable as R¹³ are ethylene group, substituted ethylene group, propylene group and substituted propylene group. In case R¹³ is ethylene group or substituted ethylene group, the lactone ring of the α-substituted lactone compound is 5-membered and in case it is propylene group or substituted propylene group, the lactone ring is 6-membered. As mentioned previously, it is preferable that the lactone ring of the α-substituted lactone compound is 5-membered or 6-membered, because they are easy to prepare, chemically stable and inexpensive.

In the above formula (1-2), R¹⁴ to R¹⁷ represent a hydrogen atom or a substituent, and at least one of R¹⁴ and R¹⁵ is a substituent and at least one of R¹⁶ and R¹⁷ is a substituent. This is instrumental in suppressing the decomposition reaction mainly at the negative electrode.

Furthermore, it is more preferable that both R¹⁴ and R¹⁵, and both R¹⁶ and R¹⁷ are substituents. This is because the decomposition reaction is remarkably suppressed at the negative electrode.

In case R¹⁴ to R¹⁷ are substituents, there is no special limitation on their kind. Usually, a hydrocarbon group and halogen group are preferred. This is because these compounds are relatively stable in the non-aqueous electrolyte solution.

The number of carbon atoms and concrete examples of R¹⁴ to R¹⁷ are similar to those of R¹¹ and R¹². Furthermore, preferable combination of R¹⁴ and R¹⁵, and of R¹⁶ and R¹⁷ is similar to that of R¹¹ and R¹².

In case R¹⁴ to R¹⁷ are a hydrocarbon group, that hydrocarbon group may have an additional substituent respectively, similarly to R¹¹ and R¹².

The molecular weight of the α-substituted lactone compound is usually 85 or higher, preferably 100 or higher, and usually 400 or lower, preferably 300 or lower. If this upper limit is exceeded, the solubility in the non-aqueous electrolyte solution of the present invention may decrease and improvement in storage characteristics at high temperature may not be expected.

Concrete examples of the α-substituted lactone compounds include: β-propiolactone compounds such as α-methyl-β-propiolactone, α-ethyl-β-propiolactone, α-propyl-β-propiolactone, α-vinyl-β-propiolactone, α-allyl-β-propiolactone, α-phenyl-β-propiolactone, α-tolyl-β-propiolactone, α-naphthyl-β-propiolactone, α-fluoro-β-propiolactone, α-chloro-β-propiolactone, α-bromo-β-propiolactone, α-iodo-β-propiolactone, α,α-dimethyl-β-propiolactone, α,α-diethyl-β-propiolactone, α-ethyl-α-methyl-β-propiolactone, α-methyl-α-phenyl-β-propiolactone, α,α-diphenyl-β-propiolactone, α,α-ditolyl-β-propiolactone, α,α-bis(dimethylphenyl)-β-propiolactone, α,α-dinaphthyl-β-propiolactone, α,α-divinyl-β-propiolactone, α,α-diallyl-β-propiolactone, α,α-dibenzyl-β-propiolactone, α,α-diphenethyl-β-propiolactone, α,α-difluoro-β-propiolactone, α,α-dichloro-β-propiolactone, α,α-dibromo-β-propiolactone, α,α-diiodo-β-propiolactone;

β-butyrolactone compounds such as α-methyl-β-butyrolactone, α-ethyl-β-butyrolactone, α-propyl-β-butyrolactone, α-vinyl-β-butyrolactone, α-allyl-β-butyrolactone, α-phenyl-β-butyrolactone, α-tolyl-β-butyrolactone, α-naphthyl-β-butyrolactone, α-fluoro-β-butyrolactone, α-chloro-β-butyrolactone, α-bromo-β-butyrolactone, α-iodo-β-butyrolactone, α,α-dimethyl-β-butyrolactone, α,α-diethyl-β-butyrolactone, α-ethyl-α-methyl-β-butyrolactone, α-methyl-α-phenyl-β-butyrolactone, α,α-diphenyl-β-butyrolactone, α,α-ditolyl-β-butyrolactone, α,α-bis(dimethylphenyl)-β-butyrolactone, α,α-dinaphthyl-β-butyrolactone, α,α-divinyl-β-butyrolactone, α,α-diallyl-β-butyrolactone, α,α-dibenzyl-β-butyrolactone, α,α-diphenethyl-β-butyrolactone, α,α-difluoro-β-butyrolactone, α,α-dichloro-β-butyrolactone, α,α-dibromo-β-butyrolactone, α,α-diiodo-β-butyrolactone;

γ-butyrolactone compounds such as α-methyl-γ-butyrolactone, α-ethyl-γ-butyrolactone, α-propyl-γ-butyrolactone, α-vinyl-γ-butyrolactone, α-allyl-γ-butyrolactone, α-phenyl-γ-butyrolactone, α-tolyl-γ-butyrolactone, α-naphthyl-γ-butyrolactone, α-fluoro-γ-butyrolactone, α-chloro-γ-butyrolactone, α-bromo-γ-butyrolactone, α-iodo-γ-butyrolactone, α,α-dimethyl-γ-butyrolactone, α,α-diethyl-γ-butyrolactone, α-ethyl-α-methyl-γ-butyrolactone, α-methyl-α-phenyl-γ-butyrolactone, α,α-diphenyl-γ-butyrolactone, α,α-ditolyl-γ-butyrolactone, α,α-bis(dimethylphenyl)-γ-butyrolactone, α,α-dinaphthyl-γ-butyrolactone, α,α-divinyl-γ-butyrolactone, α,α-diallyl-γ-butyrolactone, α,α-dibenzyl-γ-butyrolactone, α,α-diphenethyl-γ-butyrolactone, α,α-difluoro-γ-butyrolactone, α,α-dichloro-γ-butyrolactone, α,α-dibromo-γ-butyrolactone, α,α-diiodo-γ-butyrolactone;

γ-valerolactone compounds such as α-methyl-γ-valerolactone, α-ethyl-γ-valerolactone, α-propyl-γ-valerolactone, α-vinyl-γ-valerolactone, α-allyl-γ-valerolactone, α-phenyl-γ-valerolactone, α-tolyl-γ-valerolactone, α-naphthyl-γ-valerolactone, α-fluoro-γ-valerolactone, α-chloro-γ-valerolactone, α-bromo-γ-valerolactone, α-iodo-γ-valerolactone, α,α-dimethyl-γ-valerolactone, α,α-diethyl-γ-valerolactone, α-ethyl-α-methyl-γ-valerolactone, α-methyl-α-phenyl-γ-valerolactone, α,α-diphenyl-γ-valerolactone, α,α-ditolyl-γ-valerolactone, α,α-bis(dimethylphenyl)-γ-valerolactone, α,α-dinaphthyl-γ-valerolactone, α,α-divinyl-γ-valerolactone, α,α-diallyl-γ-valerolactone, α,α-dibenzyl-γ-valerolactone, α,α-diphenethyl-γ-valerolactone, α,α-difluoro-γ-valerolactone, α,α-dichloro-γ-valerolactone, α,α-dibromo-γ-valerolactone, α,α-diiodo-γ-valerolactone;

δ-valerolactone compounds such as α-methyl-δ-valerolactone, α-ethyl-δ-valerolactone, α-propyl-δ-valerolactone, α-vinyl-δ-valerolactone, α-allyl-δ-valerolactone, α-phenyl-δ-valerolactone, α-tolyl-δ-valerolactone, α-naphthyl-δ-valerolactone, α-fluoro-δ-valerolactone, α-chloro-δ-valerolactone, α-bromo-δ-valerolactone, α-iodo-δ-valerolactone, α,α-dimethyl-δ-valerolactone, α,α-diethyl-δ-valerolactone, α-ethyl-α-methyl-δ-valerolactone, α-methyl-α-phenyl-δ-valerolactone, α,α-diphenyl-δ-valerolactone, α,α-ditolyl-δ-valerolactone, α,α-bis(dimethylphenyl)-δ-valerolactone, α,α-dinaphthyl-δ-valerolactone, α,α-divinyl-δ-valerolactone, α,α-diallyl-δ-valerolactone, α,α-dibenzyl-δ-valerolactone, α,α-diphenethyl-δ-valerolactone, α,α-difluoro-δ-valerolactone, α,α-dichloro-δ-valerolactone, α,α-dibromo-δ-valerolactone, α,α-diiodo-δ-valerolactone;

γ-caprolactone compounds such as α-methyl-γ-caprolactone, α-ethyl-γ-caprolactone, α-propyl-γ-caprolactone, α-vinyl-γ-caprolactone, α-allyl-γ-caprolactone, α-phenyl-γ-caprolactone, α-tolyl-γ-caprolactone, α-naphthyl-γ-caprolactone, α-fluoro-γ-caprolactone, α-chloro-γ-caprolactone, α-bromo-γ-caprolactone, α-iodo-γ-caprolactone, α,α-dimethyl-γ-caprolactone, α,α-diethyl-γ-caprolactone, α-ethyl-α-methyl-γ-caprolactone, α-methyl-α-phenyl-γ-caprolactone, α,α-diphenyl-γ-caprolactone, α,α-ditolyl-γ-caprolactone, α,α-bis(dimethylphenyl)-γ-caprolactone, α,α-dinaphthyl-γ-caprolactone, α,α-divinyl-γ-caprolactone, α,α-diallyl-γ-caprolactone, α,α-dibenzyl-γ-caprolactone, α,α-diphenethyl-γ-caprolactone, α,α-difluoro-γ-caprolactone, α,α-dichloro-γ-caprolactone, α,α-dibromo-γ-caprolactone, α,α-diiodo-γ-caprolactone;

δ-caprolactone compounds such as α-methyl-δ-caprolactone, α-ethyl-δ-caprolactone, α-propyl-δ-caprolactone, α-vinyl-δ-caprolactone, α-allyl-δ-caprolactone, α-phenyl-δ-caprolactone, α-tolyl-δ-caprolactone, α-naphthyl-δ-caprolactone, α-fluoro-δ-caprolactone, α-chloro-δ-caprolactone, α-bromo-δ-caprolactone, α-iodo-δ-caprolactone, α,α-dimethyl-δ-caprolactone, α,α-diethyl-δ-caprolactone, α-ethyl-α-methyl-δ-caprolactone, α-methyl-α-phenyl-δ-caprolactone, α,α-diphenyl-δ-caprolactone, α,α-ditolyl-δ-caprolactone, α,α-bis(dimethylphenyl)-δ-caprolactone, α,α-dinaphthyl-δ-caprolactone, α,α-divinyl-δ-caprolactone, α,α-diallyl-δ-caprolactone, α,α-dibenzyl-δ-caprolactone, α,α-diphenethyl-δ-caprolactone, α,α-difluoro-δ-caprolactone, α,α-dichloro-δ-caprolactone, α,α-dibromo-δ-caprolactone, α,α-diiodo-δ-caprolactone;

∈-caprolactone compounds such as α-methyl-∈-caprolactone, α-ethyl-∈-caprolactone, α-propyl-∈-caprolactone, α-vinyl-∈-caprolactone, α-allyl-∈-caprolactone, α-phenyl-∈-caprolactone, α-tolyl-∈-caprolactone, α-naphthyl-∈-caprolactone, α-fluoro-∈-caprolactone, α-chloro-∈-caprolactone, α-bromo-∈-caprolactone, α-iodo-∈-caprolactone, α,α-dimethyl-∈-caprolactone, α,α-diethyl-∈-caprolactone, α-ethyl-α-methyl-∈-caprolactone, α-methyl-α-phenyl-∈-caprolactone, α,α-diphenyl-∈-caprolactone, α,α-ditolyl-∈-caprolactone, α,α-bis(dimethylphenyl)-∈-caprolactone, α,α-dinaphthyl-∈-caprolactone, α,α-divinyl-∈-caprolactone, α,α-diallyl-∈-caprolactone, α,α-dibenzyl-∈-caprolactone, α,α-diphenethyl-∈-caprolactone, α,α-difluoro-∈-caprolactone, α,α-dichloro-∈-caprolactone, α,α-dibromo-∈-caprolactone, α,α-diiodo-∈-caprolactone; and

condensation products of hydroxyl carboxylic acids, such as lactide (3,6-dimethyl-1,4-dioxane-2,5-dione), 3,6-diethyl-1,4-dioxane-2,5-dione, 3,6-dipropyl-1,4-dioxane-2,5-dione, 3,6-diphenyl-1,4-dioxane-2,5-dione, 3-ethyl-6-methyl-1,4-dioxane-2,5-dione, 3-methyl-6-phenyl-1,4-dioxane-2,5-dione.

Of the above listed compounds, preferable ones are as follows: α-methyl-substituted lactones such as α-methyl-γ-butyrolactone, α-methyl-γ-valerolactone, α-methyl-δ-valerolactone, α-methyl-δ-caprolactone; α-phenyl-substituted lactones such as α-phenyl-γ-butyrolactone, α-phenyl-γ-valerolactone, α-phenyl-δ-valerolactone, α-phenyl-δ-caprolactone; α,α-dimethyl-substituted lactones such as α,α-dimethyl-γ-butyrolactone, α,α-dimethyl-γ-valerolactone, α,α-dimethyl-δ-valerolactone, α,α-dimethyl-γ-caprolactone, α,α-dimethyl-δ-caprolactone; α,α-diphenyl-substituted lactones such as α,α-diphenyl-γ-butyrolactone, α,α-diphenyl-γ-valerolactone, α,α-diphenyl-δ-valerolactone, α,α-diphenyl-γ-caprolactone, α,α-diphenyl-δ-caprolactone; condensation products of hydroxyl carboxylic acids such as lactide (3,6-dimethyl-1,4-dioxane-2,5-dione), 3,6-diethyl-1,4-dioxane-2,5-dione, 3,6-diphenyl-1,4-dioxane-2,5-dione, 3-ethyl-6-methyl-1,4-dioxane-2,5-dione, 3-methyl-6-phenyl-1,4-dioxane-2,5-dione. Particularly preferable are lactide, α-methyl-γ-butyrolactone, α-phenyl-γ-butyrolactone, α,α-dimethyl-γ-butyrolactone and α,α-diphenyl-γ-butyrolactone. These lactones have moderate oxidation-resistant property and can form a stable coat on the positive electrode when contained in a non-aqueous electrolyte solution, leading to an improvement in storage characteristics of a lithium secondary battery based on the non-aqueous electrolyte solution.

The above α-substituted lactones can be used either singly or as a mixture of two or more kinds in any combination and in any ratio.

[I-2-1-2. Composition of Lactone Compound Having a Substituent at its α Position]

In case the non-aqueous electrolyte solution of the present invention contains α-substituted lactone compound, the content of the α-substituted lactone compound in the non-aqueous electrolyte solution of the present invention is usually 0.01 weight % or higher, preferably 0.1 weight % or higher, and usually 5 weight % or lower, preferably 3 weight % or lower. When the content is below the above lower limit, it may not be possible for the non-aqueous electrolyte solution of the present invention to improve storage characteristics at high temperature. On the other hand, when the content exceeds the upper limit, a thick coat will be formed on the positive electrode and, because of high resistance of this coat, migration of lithium ions between the non-aqueous electrolyte solution and the positive electrode becomes difficult, leading possibly to deterioration of battery characteristics such as rate characteristics. In case two or more kinds of α-substituted lactone compounds are used in combination, the sum of the concentration of those lactone compounds should be adjusted to fall within the above range.

[I-2-2. Non-Aqueous Solvent]

In case the non-aqueous electrolyte solution of the present invention contains the α-substituted lactone compound, there is no special limitation on the kind of non-aqueous solvent and any known non-aqueous solvent can be used. For example, non-aqueous solvents, similar to those described in [I-1-4. Non-aqueous solvent] as non-aqueous solvents which can be used in case the non-aqueous electrolyte solution of the present invention contains both vinylethylene carbonate compound and vinylene carbonate compound, can be used.

It is possible that the non-aqueous solvent contains cyclic esters, namely lactones. If those lactones have a substituent at its α position, then, they are regarded as the α-substituted lactone compounds, of the present invention, mentioned above. If the non-aqueous solvent contains unsaturated carbonate compound, then, those unsaturated carbonate compound is regarded as coat-forming material mentioned later.

[I-2-3. Electrolyte]

In case the non-aqueous electrolyte solution of the present invention contains the α-substituted lactone compound, there is no special limitation on the kind of electrolytes used and any known electrolytes, which are used as electrolytes of a lithium secondary battery, can be used. For example, electrolytes, similar to those described in [I-1-5. Electrolyte] as electrolytes which can be used in case the non-aqueous electrolyte solution of the present invention contains both vinylethylene carbonate compound and vinylene carbonate compound, can be used.

[I-2-4. Coat-Forming Material]

In case the non-aqueous electrolyte solution of the present invention contains α-substituted lactone compound, it is preferable that the non-aqueous electrolyte solution of the present invention contains unsaturated carbonate compound as coat-forming material so that a coat is formed on the negative electrode with improvement in battery characteristics. There is no special limitation on the kind of the unsaturated carbonate compound so long as it is at least one unsaturated carbonate compound selected from the group of unsaturated carbonate compounds each of which possesses a carbon-carbon unsaturated bond. Any known unsaturated carbonate can be used. Examples are carbonates having an aromatic ring and a carbonate having a unsaturated carbon-carbon bond such as carbon-carbon double bond or carbon-carbon triple bond.

As concrete examples of the unsaturated carbonate compounds can be cited vinylene carbonate compounds such as vinylene carbonate, methylvinylene carbonate, 1,2-dimethylvinylene carbonate, phenylvinylene carbonate and 1,2-diphenylvinylene carbonate; ethylene carbonate compounds having a substituent containing an unsaturated carbon-carbon bond such as vinylethylene carbonate, 1,2-divinylethylene carbonate, phenylethylene carbonate and 1,2-diphenylethylene carbonate; phenyl carbonates such as diphenyl carbonate, methylphenyl carbonate and t-butylphenyl carbonate; vinyl carbonates such as divinyl carbonate and methylvinyl carbonate; allyl carbonates such as diallyl carbonate and allylmethyl carbonate. Of these, preferable are vinylene carbonate compounds and ethylene carbonate compounds substituted by a substituent containing an unsaturated carbon-carbon bond. Particularly, more preferable are vinylene carbonate, 1,2-diphenylvinylene carbonate, 1,2-dimethylvinylene carbonate and vinylethylene carbonate. When the unsaturated carbonate compound like these is used, a stable interface-protective coat is formed on the negative electrode, retention capacity after high temperature storage is improved and cycle characteristics of a lithium secondary battery is also improved.

Unsaturated carbonate compound can be used either singly or as a mixture of more than one kind in any combination and in any ratio.

The number of carbon atoms of the unsaturated carbonate compound is usually 3 or more, and usually 20 or less, preferably 15 or less. When the upper limit of the above range is exceeded, the solubility in the electrolyte solution decreases.

There is no special limitation on the molecular weight of the unsaturated carbonate compound. The molecular weight is usually 80 or higher, and usually 250 or lower, preferably 150 or lower. When the molecular weight is too high, the solubility in the electrolyte solution becomes small and improvement of continuous charge characteristics and cycle characteristics, which is the advantage of the present invention, is not realized adequately.

The concentration of the unsaturated carbonate compound in the non-aqueous electrolyte solution is usually 0.01 weight % or higher, preferably 0.1 weight % or higher, more preferably 0.3 weight % or higher, and usually 10 weight % or lower, preferably 7 weight % or lower, more preferably 5 weight % or lower. When the concentration of the unsaturated carbonate compound is too high, high temperature-storage characteristics tend to deteriorate and the volume of gas evolved on battery use tends to increase, leading possibly to lowering of capacity retention rate. Furthermore, when the concentration of the unsaturated carbonate compound is too high, the coat formed on the negative electrode becomes thick causing high resistance, and capacity of the battery may decrease. On the other hand, when the concentration of the unsaturated carbonate compound is too low, there is a possibility that the advantage of the present invention is not realized adequately. In case two or more kinds of unsaturated carbonate compounds are used together, the sum of the concentration of the unsaturated carbonate compound used should be adjusted to fall within the above range.

The explanation will be given here why it is preferable that the non-aqueous electrolyte solution of the present invention contains unsaturated carbonate compound. On initial charge, a part or all of the unsaturated carbonate compound is decomposed on the negative electrode and a coat is formed. This suppresses subsequent reductive decomposition reaction of the non-aqueous solvent, bringing about an increase in retention capacity of the lithium secondary battery after high temperature storage and improvement in cycle characteristics. However, when the unsaturated carbonate compound remain in the non-aqueous electrolyte solution after initial charge, the unsaturated carbonate compound is liable to undergo oxidation reaction at the positive electrode and, therefore, tend to evolve gas during storage at high temperature. On the other hand, α-substituted lactone compound forms a coat on the positive electrode and suppress oxidative decomposition reaction of the unsaturated carbonate compound and non-aqueous solvent subsequently. In other words, it is one of the advantages of the present invention that, by introducing α-substituted lactone compound, the problem of evolved gas due to unsaturated carbonate compound can be solved.

[I-2-5. Other Auxiliary Agent]

In case the non-aqueous electrolyte solution of the present invention contains the α-substituted lactone compound, the non-aqueous electrolyte solution of the present invention may contain other auxiliary agent in order to improve such characteristics as permeability of the non-aqueous electrolyte solution and overcharge characteristics of the battery, insofar as the advantage of the present invention is not significantly impaired. For example, auxiliary agents, similar to those described in [I-1-6. Other auxiliary agent] as auxiliary agents which can be used in case the non-aqueous electrolyte solution of the present invention contains both vinylethylene carbonate compound and vinylene carbonate compound, can be used.

[I-2-6. State of Non-Aqueous Electrolyte Solution]

In case the non-aqueous electrolyte solution of the present invention contains the α-substituted lactone compound, the state of the non-aqueous electrolyte solution is similar to that described in [I-1-7. State of non-aqueous electrolyte solution] for the non-aqueous electrolyte solution containing both vinylethylene carbonate compound and vinylene carbonate compound.

[I-2-7. Production Method of Non-Aqueous Electrolyte Solution]

In case the non-aqueous electrolyte solution of the present invention contains the α-substituted lactone compound, the non-aqueous electrolyte solution of the present invention can be prepared by dissolving in the non-aqueous solvent electrolyte, the α-substituted lactone compound, and, as needed, coat-forming material and other auxiliary agent.

Similarly to what has been described in [I-1-8. Production method of non-aqueous electrolyte solution] for the non-aqueous electrolyte solution of the present invention, containing both vinylethylene carbonate compound and vinylene carbonate compound, it is preferable that each material for the non-aqueous electrolyte solution, namely electrolyte, the α-substituted lactone compound, non-aqueous solvent, the unsaturated carbonate compound and other auxiliary agent, is dehydrated before use. The preferable extent of dehydration is also similar.

[I-3. In Case the Non-Aqueous Electrolyte Solution of the Present Invention Contains Lactone Compound Having an Unsaturated Carbon-Carbon Bond in an Amount of 0.01 Weight % or More and 5 Weight % or Less.]

[I-3-1. Lactone Compound Having an Unsaturated Carbon-Carbon Bond]

[I-3-1-1. Kind of Lactone Compound Having an Unsaturated Carbon-Carbon Bond]

The lactone compound having an unsaturated carbon-carbon bond contained in the non-aqueous electrolyte solution of the present invention (hereinafter referred to as “the unsaturated lactone compound” as appropriate) is at least one lactone selected from the group of lactones each of which possesses an unsaturated carbon-carbon bond. Any such lactone can be used. That unsaturated carbon-carbon bond may be located either in the lactone ring or outside the lactone ring. Of unsaturated carbon-carbon bonds, carbon-carbon double bond is preferable because the compound is then easy to prepare and inexpensive.

The ring size of the lactones is arbitrary. However, a 5-membered lactone and 6-membered lactone are preferable because they are easy to prepare, chemically stable and inexpensive.

Furthermore, as the unsaturated lactone compound, α,β-unsaturated lactone compound or β,γ-unsaturated lactone compound are preferable. Here, α,β-unsaturated lactone compound indicates the lactone compound having an unsaturated carbon-carbon bond between α-carbon and β-carbon of the lactone ring, and β,γ-unsaturated lactone compound indicates the lactone compound having an unsaturated carbon-carbon bond between β-carbon and γ-carbon of the lactone ring.

As the unsaturated lactone compound, usually preferred are those represented by the formulae (2-1) to (2-3) below, because they are stable in the non-aqueous electrolyte solution of the present invention, relatively easy to prepare and inexpensive. The unsaturated lactone compounds represented by the formulae (2-1) and (2-2) belong to α,β-lactone and that represented by the formula (2-3) belongs to β,γ-lactone.

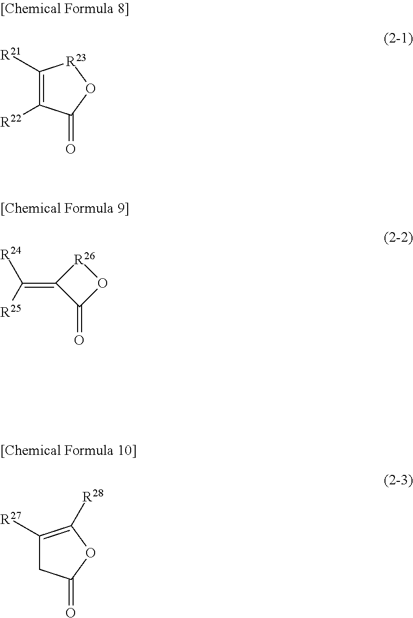

In the above formula (2-1), R²¹ and R²² represent, independently of each other, a hydrogen atom or a univalent hydrocarbon group.

In case R²¹ and R²² are a hydrocarbon group, the numbers of their carbon atoms are usually one or more, and usually 8 or less.

There is no special limitation on the kind of hydrocarbon groups represented as R²¹ and R²². Examples are an alkyl group, alkenyl group, aryl group and aralkyl group.

In case R²¹ and R²² are an alkyl group, the number of carbon atoms of that alkyl group is usually one or more, and usually 6 or less, preferably 4 or less, more preferably 2 or less. If this upper limit is exceeded, the compatibility or solubility of the unsaturated lactone compound in the non-aqueous electrolyte solution decreases and the protective coat formed on the positive electrode becomes fragile, leading possibly to insufficient battery capacity of a lithium secondary battery based on this non-aqueous electrolyte solution.

In case R²¹ and R²² are an alkyl group, preferable concrete examples of the alkyl group include methyl group, ethyl group, propyl group and butyl group. Of these, more preferable are methyl group, ethyl group and propyl group.

In case R²¹ and R²² are an alkenyl group, the number of carbon atoms of that alkenyl group is usually 2 or more, and usually 6 or less, preferably 4 or less. If this upper limit is exceeded, similarly to the case of alkyl group, the compatibility or solubility of the unsaturated lactone compound in the non-aqueous electrolyte solution decreases and the protective coat formed on the positive electrode becomes fragile, leading possibly to insufficient battery capacity of a lithium secondary battery based on this non-aqueous electrolyte solution.

In case R²¹ and R²² are an alkenyl group, concrete examples of the alkenyl group preferable as R²¹ and R²² include vinyl group, isopropenyl group and allyl group. Of these, vinyl group and allyl group are more preferable.

In case R²¹ and R²² are an aryl group, the number of carbon atoms of that aryl group is usually 6 or more, and usually 8 or less, preferably 7 or less. If this upper limit is exceeded, similarly to the case of alkyl group and alkenyl group, the compatibility or solubility of the unsaturated lactone compound in the non-aqueous electrolyte solution decreases and the protective coat formed on the positive electrode becomes fragile, leading possibly to insufficient battery capacity of a lithium secondary battery based on this non-aqueous electrolyte solution.

In case R²¹ and R²² are an aryl group, concrete examples of the aryl group preferable as R²¹ and R²² include phenyl group, tolyl group, ethylphenyl group and dimethylphenyl group. Of these, phenyl group and tolyl group are more preferable.

In case R²¹ and R²² are an aralkyl group, the number of carbon atoms of that aralkyl group is usually 7 or 8. If the number of carbon atoms is larger than 8, similarly to the case of alkyl group, alkenyl group and aryl group, the compatibility or solubility of the unsaturated lactone compound in the non-aqueous electrolyte solution decreases and the protective coat formed on the positive electrode becomes fragile, leading possibly to insufficient battery capacity of a lithium secondary battery based on this non-aqueous electrolyte solution.

In case R²¹ and R²² are an aralkyl group, concrete examples of the aralkyl group preferable as R²¹ and R²² include benzyl group, α-phenethyl group and β-phenethyl group. Of these, benzyl group is more preferable.

Of those mentioned above, a hydrogen atom and an alkyl group are particularly preferable as R²¹ and R²². It is most preferable that one of R²¹ and R²² is a hydrogen atom and the other is an alkyl group. Here, the number of the carbon atoms of the alkyl group is preferably one or more, and 3 or less. This is because the reactivity in the non-aqueous electrolyte solution is then maintained at a suitable level and, when used for a lithium secondary battery, an effective protective coat can be formed on the positive electrode.

A hydrocarbon group represented as R²¹ and R²² may have an additional substituent. There is no special limitation on the kind of this substituent. Concrete examples include alkoxy group, ester group, amide group and halogen group. These substituents may constitute a ring.

In the above formula (2-1), R²³ represents a bivalent hydrocarbon group. The number of carbon atoms of R²³ is usually one or more, and usually 5 or less.

There is no special limitation on the kind of R²³. Examples are an alkylene group such as methylene group, ethylene group, propylene group and butylene group, and alkenylene group such as vinylene group. Of these, preferable are methylene group, ethylene group and vinylene group.

The hydrocarbon group used as R²³ may have an additional substituent. There is no special limitation on the kind of this substituent. As concrete examples can be cited a hydrocarbon group including alkyl group such as methyl group and ethyl group, alkenyl group such as vinyl group and allyl group; alkoxy group such as methoxy group and ethoxy group; halogen group such as fluoro group, chloro group and bromo group. In case the substituent belonging to R²³ is an organic group, it is preferable that the number of its carbon atom is usually one or more, and usually 3 or less.

In the above formula (2-2), R²⁴ and R²⁵ represent, independently of each other, a hydrogen atom or a univalent hydrocarbon group.

In case R²⁴ and R²⁵ are a hydrocarbon group, the numbers of their carbon atoms are usually one or more, and usually 8 or less.

There is no special limitation on the kind of hydrocarbon groups represented as R²⁴ and R²⁵. Examples are an alkyl group, alkenyl group, aryl group and aralkyl group.

In case R²⁴ and R²⁵ belong to any one of alkyl group, alkenyl group, aryl group and aralkyl group, the numbers of their carbon atoms and concrete examples are similar to what have been described for the alkyl group, alkenyl group, aryl group and aralkyl group in the explanation of the formula (2-1), when R²¹ and R²² are hydrocarbon group.

Of these, a hydrogen atom and an alkyl group are preferable as R²⁴ and R²⁵. It is most preferable that both of R²⁴ and R²⁵ are hydrogen atoms. This is because the reactivity in the non-aqueous electrolyte solution is then maintained at a suitable level and, when used for a lithium secondary battery, an effective protective coat can be formed on the positive electrode.

Similarly to R²¹ and R²², a hydrocarbon group represented as R²⁴ and R²⁵ may have an additional substituent. There is no special limitation on the kind of this substituent. Concrete examples include alkoxy group, ester group, amide group and halogen group. These substituents may constitute a ring.

In the above formula (2-2), R²⁶ represents a bivalent hydrocarbon group. The number of carbon atoms of R²⁶ is usually one or more, and usually 6 or less.

There is no special limitation on the kind of R²⁶. Examples are an alkylene group such as methylene group, ethylene group, propylene group and butylene group, and alkenylene group such as vinylene group. Of these, preferable are ethylene group and propylene group.

Furthermore, R²⁶ may have an additional substituent. There is no special limitation on the kind of this substituent. As concrete examples can be cited those previously cited as substituents that may belong to R²³. However, in case the substituent belonging to R²⁶ is a hydrocarbon group, it is preferable that the number of its carbon atom is usually one or more, and usually 4 or less.

In the above formula (2-3), R²⁷ and R²⁸ represent, independently of each other, a hydrogen atom or a univalent hydrocarbon group.

In case R²⁷ and R²⁸ are a hydrocarbon group, the numbers of their carbon atoms are usually one or more, and usually 8 or less.

There is no special limitation on the kind of hydrocarbon groups represented as R²⁷ and R²⁸. Examples are an alkyl group, alkenyl group, aryl group and aralkyl group.

In case R²⁷ and R²⁸ belong to any one of alkyl group, alkenyl group, aryl group and aralkyl group, its number of carbon atoms and concrete examples are similar to what have been described for the alkyl group, alkenyl group, aryl group and aralkyl group in the explanation of the formula (2-1), when R²¹ and R²² are hydrocarbon group.

Of these, a hydrogen atom and an alkyl group are preferable as R²⁷ and R²⁸. It is particularly preferable that R²⁷ is a hydrogen atom and R²⁸ is an alkyl group. Here, the number of carbon atoms of the alkyl group is preferably one or more, and preferably 3 or less. This is because the reactivity of the non-aqueous electrolyte solution is then maintained at a suitable level and, when used for a lithium secondary battery, an effective protective coat can be formed on the positive electrode.

Similarly to R²¹, R²², R²⁴ and R²⁵, the hydrocarbon group represented as R²⁷ and R²⁸ may have an additional substituent. There is no special limitation on the kind of this substituent. Concrete examples include alkoxy group, ester group, amide group and halogen group. These substituents may constitute a ring.

The molecular weight of the unsaturated lactone compound is usually 70 or higher, and usually 250 or lower, preferably 200 or lower, more preferably 150 or lower. If the upper limit of this range is exceeded, the compatibility or solubility of the unsaturated lactone compound in the non-aqueous electrolyte solution decreases and the protective coat formed on the positive electrode becomes fragile, leading possibly to insufficient battery capacity of a lithium secondary battery based on this non-aqueous electrolyte solution.

Concrete examples of the unsaturated lactone compounds are listed below. It is to be understood that this list does not represent an exhaustive listing of the unsaturated lactone compound. In the mark < >, which follows each compound, are indicated R²¹ to R²⁸ in the formula (2-1) to (2-3), as applied to each compound. In the following explanation, Me, Et, Pr and Ph indicate methyl group, ethyl group, propyl group and phenyl group, respectively.

Concrete examples of the unsaturated lactone compounds include 2(5H)-furanone compounds such as 2(5H)-furanone <R²¹, R²²=H, R²³=methylene group>, 5-methoxy-2(5H)-furanone <R²¹, R²²=H, R²³=methoxymethylene group>, 5-ethoxy-2(5H)-furanone <R²¹, R²²=H, R²³=ethoxymethylene group>, 5-methoxymethyl-2(5H)-furanone <R²¹, R²²=H, R²³=methoxymethylmethylene group>, 5-acetoxy-2(5H)-furanone <R²¹, R²²=H, R²³=acetoxymethylene group>, 5-chloro-2(5H)-furanone <R²¹, R²²=H, R²³=chloromethylene group>, 3-methyl-2(5H)-furanone <R²¹=H, R²²=Me, R²³=methylene group>, 4-methyl-2(5H)-furanone <R²¹=Me, R²²=H, R²³=methylene group>, 5-methyl-2(5H)-furanone <R²¹, R²²=H, R²³=methylmethylene group>, 3-ethyl-2(5H)-furanone <R²¹=H, R²²=Et, R²³=methylene group>, 4-ethyl-2(5H)-furanone <R²¹=Et, R²²=H, R²³=methylene group>, 5-ethyl-2(5H)-furanone <R²¹, R²²=H, R²³=ethylmethylene group>, 3-vinyl-2(5H)-furanone <R²¹=H, R²²=vinyl group, R²³=methylene group>, 4-vinyl-2(5H)-furanone <R²¹=vinyl group, R²²=H, R²³=methylene group>, 5-vinyl-2(5H)-furanone <R²¹, R²²=H, R²³=vinylmethylene group>, 3-phenyl-2(5H)-furanone <R²¹=H, R²²=Ph, R²³=methylene group>, 4-phenyl-2(5H)-furanone <R²¹=Ph, R²²=H, R²³=methylene group>, 3-benzyl-2(5H)-furanone <R²²=H, R²²=benzyl group, R²³=methylene group>, 4-benzyl-2(5H)-furanone <R²¹=benzyl group, R²²=H, R²³=methylene group>, 3,4-dimethyl-2(5H)-furanone <R²¹=Me, R²²=Me, R²³=methylene group>, 3,5-dimethyl-2(5H)-furanone <R²¹=H, R²²=Me, R²³=methylmethylene group> and 4,5-dimethyl-2(5H)-furanone <R²¹=Me, R²²=H, R²³=methylmethylene group>;

5,6-dihydro-2H-pyran-2-one compounds such as 5,6-dihydro-2H-pyran-2-one <R²¹, R²²=H, R²³=ethylene group>, 5,6-dihydro-3-methyl-2H-pyran-2-one <R²¹=H, R²²=Me, R²³=ethylene group>, 5,6-dihydro-4-methyl-2H-pyran-2-one <R²¹=Me, R²²=H, R²³=ethylene group>, 5,6-dihydro-5-methyl-2H-pyran-2-one <R²¹=H, R²²=H, R²³=β-methylethylene group>, 5,6-dihydro-6-methyl-2H-pyran-2-one <R²¹=H, R²²=H, R²³=α-methylethylene group>, 5,6-dihydro-3-ethyl-2H-pyran-2-one <R²¹=H, R²²=Et, R²³=ethylene group>, 5,6-dihydro-4-ethyl-2H-pyran-2-one <R²¹=Et, R²²=H, R²³=ethylene group>, 5,6-dihydro-5-ethyl-2H-pyran-2-one <R²¹=H, R²²=H, R²³=β-ethylethylene group>, 5,6-dihydro-6-ethyl-2H-pyran-2-one <R²¹=H, R²²=H, R²³=α-ethylethylene group>, 5,6-dihydro-3-phenyl-2H-pyran-2-one <R²¹=H, R²²=Ph, R²³=ethylene group> and 5,6-dihydro-4-phenyl-2H-pyran-2-one <R²¹=Ph, R²²=H, R²³=ethylene group>;

α-Pyrone compounds such as α-pyrone <R²¹=H, R²²=H, R²³=vinylene group>, 3-methyl-α-pyrone <R²¹=H, R²²=Me, R²³=vinylene group>, 4-methyl-α-pyrone <R²¹=Me, R²²=H, R²³=vinylene group>, 5-methyl-α-pyrone <R²¹, R²²=H, R²³=β-methylvinylene group>, 6-methyl-α-pyrone <R²¹, R²²=H, R²³=α-methylvinyle group>, 3-ethyl-α-pyrone <R²¹=H, R²²=Et, R²³=vinylene group>, 4-ethyl-α-pyrone <R²¹=Et, R²²=H, R²³=vinylene group>, 5-ethyl-α-pyrone <R²¹, R²²=H, R²³=β-ethylvinylene group>, 6-ethyl-α-pyrone <R²¹, R²²=H, R²³=α-ethylvinylene group>, 6-propyl-α-pyrone <R²¹, R²²=H, R²³=α-propylvinylene group>, 3-phenyl-α-pyrone <R²¹=H, R²²=Ph, R²³=vinylene group>, 4-phenyl-α-pyrone <R²¹=Ph, R²²=H, R²³=vinylene group>, 4,6-dimethyl-α-pyrone <R²¹=Me, R²²=H, R²³=α-methylvinylene group>, 4,6-diethyl-α-pyrone <R²¹=Et, R²²=H, R²³=α-ethylvinylene group> and 4,6-dipropyl-α-pyrone <R²¹=Pr, R²²=H, R²³=α-propylvinylene group>;

propiolactone compounds such as α-methylene-β-propiolactone <R²⁴, R²⁵=H, R²⁶=methylene group>, α-ethylidene-β-propiolactone <R²⁴=H, R²⁵=Me, R²⁶=methylene group> and α-benzylidene-β-propiolactone <R²⁴=H, R²⁵=Ph, R²⁶=methylene group>;

butyrolactone compounds such as α-methylene-β-butyrolactone <R²⁴, R²⁵=H, R²⁶=methylmethylene group>, α-methylene-γ-butyrolactone <R²⁴, R²⁵=H, R²⁶=ethylene group>, α-ethylidene-β-butyrolactone <R²⁴=H, R²⁵=Me, R²⁶=methylmethylene group>, α-ethylidene-γ-butyrolactone <R²⁴=H, R²⁵=Me, R²⁶=ethylene group>, α-benzylidene-β-butyrolactone <R²⁴=H, R²⁵=Ph, R²⁶=methylmethylene group> and α-benzylidene-γ-butyrolactone <R²⁴=H, R²⁵=Ph, R²⁶=ethylene group>;

valerolactone compounds such as α-methylene-γ-valerolactone <R²⁴, R²⁵=H, R²⁶=α-methylethylene group>, α-methylene-δ-valerolactone <R²⁴, R²⁵=H, R²⁶=propylene group>, α-ethylidene-γ-valerolactone <R²⁴=H, R²⁵=Me, R²⁶=α-methylethylene group>, α-ethylidene-δ-valerolactone <R²⁴=H, R²⁵=Me, R²⁶=propylene group>, α-benzylidene-γ-valerolactone <R²⁴=H, R²⁵=Ph, R²⁶=α-methylethylene group> and α-benzylidene-δ-valerolactone <R²⁴=H, R²⁵=Ph, R²⁶=propylene group>;

caprolactone compounds such as α-methylene-γ-caprolactone <R²⁴, R²⁵=H, R²⁶=α-ethylethylene group>, α-methylene-δ-caprolactone <R²⁴, R²⁵=H, R²⁶=α-methylpropylene group>, α-methylene-∈-caprolactone <R²⁴, R²⁵=H, R²⁶=butylene group>, α-ethylidene-γ-caprolactone <R²⁴=H, R²⁵=Me, R²⁶=α-ethylethylene group>, α-ethylidene-δ-caprolactone <R²⁴=H, R²⁵=Me, R²⁶=α-methylpropylene group>, α-ethylidene-∈-caprolactone <R²⁴=H, R²⁵=Me, R²⁶=butylene group>, α-benzylidene-γ-caprolactone <R²⁴=H, R²⁵=Ph, R²⁶=α-ethylethylene group>, α-benzylidene-δ-caprolactone <R²⁴=H, R²⁵=Ph, R²⁶=α-methylpropylene group> and α-benzylidene-∈-caprolactone <R²⁴=H, R²⁵=Ph, R²⁶=butylene group>; and

dihydrofuran-2-one compounds such as dihydrofuran-2-one <R²⁷, R²⁸=Me>, α-angelicalactone <R²⁷=H, R²⁸=Me>, 5-ethyl-dihydrofuran-2-one <R²⁷=H, R²⁸=Et>, 5-propyl-dihydrofuran-2-one <R²⁷=H, R²⁸=Pr>, 5-phenyl-dihydrofuran-2-one <R²⁷=H, R²⁸=Ph> and 4,5-dimethyl-dihydrofuran-2-one <R²⁷=Me, R²⁸=Me>.

Of the examples shown, preferable 2(5H) furanone compounds are 2(5H)-furanone, 3-methyl-2(5H)-furanone, 4-methyl-2(5H)-furanone, 5-methyl-2(5H)-furanone, 3-ethyl-2(5H)-furanone, 4-ethyl-2(5H)-furanone and 5-ethyl-2(5H)-furanone. Preferable 5,6-dihydro-2H-pyran-2-one compounds are 5,6-dihydro-2H-pyran-2-one, 5,6-dihydro-3-methyl-2H-pyran-2-one, 5,6-dihydro-4-methyl-2H-pyran-2-one, 5,6-dihydro-5-methyl-2H-pyran-2-one and 5,6-dihydro-6-methyl-2H-pyran-2-one. Preferable α-pyrone compounds are α-pyrone, 3-methyl-α-pyrone, 4-methyl-α-pyrone, 5-methyl-α-pyrone, 6-methyl-α-pyrone, 4,6-dimethyl-α-pyrone, 4,6-diethyl-α-pyrone and 4,6-dipropyl-α-pyrone.

Preferable propiolactone compounds are α-methylene-β-propiolactone and α-benzylidene-β-propiolactone. Preferable butyrolactone compounds are α-methylene-β-butyrolactone, α-methylene-γ-butyrolactone, α-benzylidene-β-butyrolactone and α-benzylidene-γ-butyrolactone. Preferable valerolactone compounds are α-methylene-γ-valerolactone, α-methylene-δ-valerolactone, α-benzylidene-γ-valerolactone and α-benzylidene-δ-valerolactone. Preferable caprolactone compounds are α-methylene-∈-caprolactone and α-benzylidene-∈-caprolactone. Preferable dihydrofuran-2-one compounds are α-angelicalactone and 5-phenyl-dihydrofuran-2-one.

Of these compounds, particularly preferable 2(5H)-furanone compounds are 2(5H)-furanone, 3-methyl-2(5H)-furanone and 3-ethyl-2(5H)-furanone. Particularly preferable 5,6-dihydro-2H-pyran-2-one compound is 5,6-dihydro-2H-pyran-2-one. Particularly preferable α-pyrone compounds are α-pyrone, 6-methyl-α-pyrone, 4,6-dimethyl-α-pyrone and 4,6-diethyl-α-pyrone.

Particularly preferable butyrolactone compounds are α-methylene-γ-butyrolactone and α-benzylidene-γ-butyrolactone. Particularly preferable valerolactone compounds are α-methylene-γ-valerolactone and α-methylene-δ-valerolactone. Particularly preferable dihydrofuran-2-one compound is α-angelicalactone.

Of the above preferable compounds, still more preferable are 3-methyl-2(5H)-furanone, 2(5H)-furanone, 5,6-dihydro-2H-pyran-2-one, α-pyrone, 4,6-dimethyl-α-pyrone, α-methylene-γ-butyrolactone and α-angelicalactone. These unsaturated lactone compounds have moderate oxidation-resistant property and can form a stable coat on the positive electrode when contained in a non-aqueous electrolyte solution, leading to an improvement in storage characteristics of a lithium secondary battery based on the non-aqueous electrolyte solution.

The above unsaturated lactone compounds can be used either singly or as a mixture of 2 or more compounds in any combination and in any ratio.

[I-3-1-2. Composition of Lactone Compound Having an Unsaturated Carbon-Carbon Bond]

In case the non-aqueous electrolyte solution of the present invention contains the unsaturated lactone compound, the content of the unsaturated lactone compound in the non-aqueous electrolyte solution of the present invention is usually 0.01 weight % or higher, preferably 0.1 weight % or higher, and usually 5 weight % or lower, preferably 2 weight % or lower. When the content is below the lower limit of this range, it may not be possible to improve storage characteristics at high temperature of the non-aqueous electrolyte solution of the present invention. On the other hand, when the content exceeds the upper limit, a thick coat will be formed on the positive electrode and, because of high resistance of this coat, migration of lithium ions between the non-aqueous electrolyte solution and the positive electrode becomes difficult, leading possibly to deterioration of battery characteristics such as rate characteristics. In case two or more kinds of the unsaturated lactone compounds are used in combination, the sum of the concentration of those lactone compounds should be adjusted to fall within the above range.

[I-3-2. Non-Aqueous Solvent]

In case the non-aqueous electrolyte solution of the present invention contains the unsaturated lactone compound, there is no special limitation on the kind of non-aqueous solvent and any known non-aqueous solvent can be used. For example, non-aqueous solvents, similar to those described in [I-1-4. Non-aqueous solvent] as non-aqueous solvents which can be used in case the non-aqueous electrolyte solution of the present invention contains both vinylethylene carbonate compound and vinylene carbonate compound, can be used.

It is possible that the non-aqueous solvent contains cyclic esters, namely lactones. If those lactones have an unsaturated carbon-carbon bond, then, they are regarded as the unsaturated lactone compounds mentioned above. If the non-aqueous solvent contains the unsaturated carbonate compounds, then, those unsaturated carbonate compounds are regarded as coat-forming material mentioned later.

[I-3-3. Electrolyte]

In case the non-aqueous electrolyte solution of the present invention contains the unsaturated lactone compound, there is no special limitation on the kind of electrolytes used and any known electrolytes, which are used as electrolytes of a lithium secondary battery, can be used. For example, electrolytes, similar to those described in [I-1-5. Electrolyte] as electrolytes which can be used in case the non-aqueous electrolyte solution of the present invention contains both vinylethylene carbonate compound and vinylene carbonate compound, can be used.

[I-3-4. Coat-Forming Material]

In case the non-aqueous electrolyte solution of the present invention contains the unsaturated lactone compound, it is preferable that the non-aqueous electrolyte solution contains a coat-forming material, similarly to the case that it contains the α-substituted lactone compound. As for this coat-forming material, coat-forming materials similar to those described in [I-2-4. Coat-forming material] for the non-aqueous electrolyte solution of the present invention containing the α-substituted lactone compound can be used.

The reason why it is preferable that the non-aqueous electrolyte solution of the present invention contains the unsaturated carbonate compound is similar to what has been described for the non-aqueous electrolyte solution containing the α-substituted lactone compound. Namely, on initial charge, a part or all of the unsaturated carbonate compound is decomposed on the negative electrode and a coat is formed. This suppresses subsequent reductive decomposition reaction of the non-aqueous solvent, bringing about an increase in retention capacity after high temperature storage and improvement in cycle characteristics of the lithium secondary battery. However, when the unsaturated carbonate compound remains in the non-aqueous electrolyte solution after initial charge, the unsaturated carbonate compound is liable to undergo oxidation reaction at the positive electrode and, therefore, tend to evolve gas during storage at high temperature. On the other hand, the unsaturated lactone compound forms a coat on the positive electrode and suppress oxidative decomposition reaction of the unsaturated carbonate compound and non-aqueous solvent subsequently. In other words, it is one of the advantages of the present invention that, by introducing the unsaturated lactone compound, the problem of evolved gas due to the unsaturated carbonate compound can be solved.

[I-3-5. Other Auxiliary Agent]

In case the non-aqueous electrolyte solution of the present invention contains the unsaturated lactone compound, the non-aqueous electrolyte solution of the present invention may contain other auxiliary agent in order to improve such characteristics as permeability of the non-aqueous electrolyte solution and overcharge characteristics of the battery, insofar as the advantage of the present invention is not significantly impaired. As for the auxiliary agent, for example, auxiliary agents, similar to those described in [I-1-6. Other auxiliary agent] as auxiliary agents which can be used in case the non-aqueous electrolyte solution of the present invention contains both vinylethylene carbonate compound and vinylene carbonate compound, can be used.

[I-3-6. State of Non-Aqueous Electrolyte Solution]

In case the non-aqueous electrolyte solution of the present invention contains the unsaturated lactone compound, the state of the non-aqueous electrolyte solution of the present invention is similar to that described in [I-1-7. State of non-aqueous electrolyte solution] for the non-aqueous electrolyte solution of the present invention containing both vinylethylene carbonate compound and vinylene carbonate compound.

[I-3-7. Production Method of Non-Aqueous Electrolyte Solution]

In case the non-aqueous electrolyte solution of the present invention contains the unsaturated lactone compound, the non-aqueous electrolyte solution of the present invention can be prepared by dissolving in the non-aqueous solvent electrolyte, the unsaturated lactone compound, and, as needed, coat-forming material and other auxiliary agent.

Similarly to what has been described in [I-1-8. Production method of non-aqueous electrolyte solution] for the non-aqueous electrolyte solution of the present invention, containing both vinylethylene carbonate compound and vinylene carbonate compound, it is preferable that each material for non-aqueous electrolyte solution, namely electrolyte, the unsaturated lactone compound, non-aqueous solvent, unsaturated carbonates and other auxiliary agent, is dehydrated before use. The preferable extent of dehydration is also similar.

[I-4. In Case the Non-Aqueous Electrolyte Solution of the Present Invention Contains Sulfonate Compound Represented by the Formula (3-1)]

[I-4-1. Sulfonate Compound]

[I-4-1-1. Kind of Sulfonate Compound]

Sulfonate compound contained in the non-aqueous electrolyte solution of the present invention (hereinafter referred to as “sulfonate compound of the present invention” as appropriate) is represented by the formula (3-1) below.

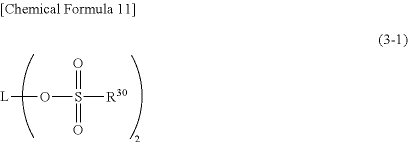

In the formula (3-1), L represents a bivalent connecting group consisting of at least one carbon atom and hydrogen atoms. R³⁰ represents, independently of each other, an unsubstituted or fluorine-substituted aliphatic saturated hydrocarbon group.

More detailed explanation of the formula (3-1) will be given below.

In the above formula (3-1), L represents a bivalent connecting group consisting of at least one carbon atom and hydrogen atoms.

There is no special limitation on the number of carbon atom constituting the connecting group L, insofar as the advantage of the present invention is not significantly impaired. It is usually 2 or more, and usually 10 or less, preferably 6 or less, more preferably 4 or less.

As concrete examples of the connecting group L can be cited in the following:

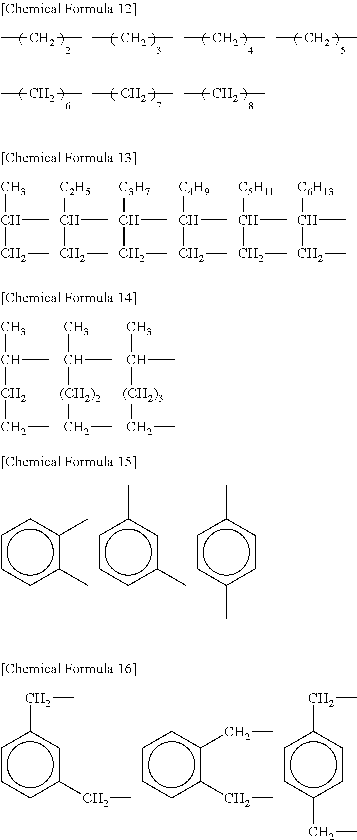

In the formula (3-1), R³⁰ represents an unsubstituted or fluorine-substituted aliphatic saturated hydrocarbon group. In case R³⁰ has a fluorine substituent, the fluorine substitution can be either for a part of the hydrogen atoms of R³⁰ or for all of the hydrogen atoms of R³⁰.

It is preferable that, R³⁰ is aliphatic saturated hydrocarbon group of which at least a part, or all of the hydrogen atoms are substituted by fluorine atom.

There is no special limitation on the number of carbon atom constituting R³⁰, insofar as the advantage of the present invention is not significantly impaired. It is usually one or more, and usually 8 or less, preferably 4 or less, more preferably 2 or less. If this upper limit is exceeded, compatibility or solubility of the sulfonate compound in the non-aqueous electrolyte solution decreases, leading possibly to insufficient suppression of evolved gas on continuous charge and inadequate improvement of cycle characteristics of a lithium secondary battery of the present invention, based on the non-aqueous electrolyte solution.

In the formula (3-1), there are two R³⁰ groups in one molecule. These two R³⁰ groups can be either the same group or different groups. However, it is preferable that they are the same group, because it is then easy to prepare the sulfonate compound of the present invention.

As concrete examples of R³⁰ can be cited the following: alkyl group such as methyl group, ethyl group, propyl group, butyl group, pentyl group and hexyl group; straight chain perfluoroalkyl group such as trifluoromethyl group, pentafluoroethyl group, heptafluoropropyl group, perfluorobutyl group, perfluoropentyl group, perfluorohexyl group, perfluoroheptyl group and perfluorooctyl group; branched chain perfluoroalkyl group such as perfluoro-1-methylethyl group, perfluoro-t-butyl group, perfluoro-3-methylbutyl group and perfluoro-5-methylhexyl group; partially fluorine-substituted straight chain alkyl group such as fluoromethyl group, difluoromethyl group, 2-fluoroethyl group, 1,1-difluoroethyl group, 1,2-difluoroethyl group, 2,2-difluoroethyl group, 1,1,2-trifluoroethyl group, 2,2,2-trifluoroethyl group, 1,2,2-trifluoroethyl group, 1,1,2,2-tetrafluoroethyl group, 1,2,2,2-tetrafluoroethyl group and 1,2,2,3,3,4,4,4-octafluorobutyl group; partially fluorine-substituted branched chain alkyl group such as di(fluoromethyl)methyl group, bis(trifluoromethyl)methyl group, 1-trifluoromethyl-ethyl group, 1,1-bis(trifluoromethyl)ethyl group, 1-methyl-1-trifluoromethylethyl group, 1-trifluoromethylhexyl group, 1-fluoro-1-methylethyl group, 1,2,2,2-tetrafluoro-1-methylethyl group, 1,1-difluoro-2-methylpropyl group, and 1,2,2,3,3,3-hexafluoro-1-methylpropyl group.

Of the above groups, preferable are those whose number of carbon atoms is 4 or less. Examples are as follows: methyl group, ethyl group, propyl group, butyl group, trifluoromethyl group, pentafluoroethyl group, heptafluoropropyl group, perfluorobutyl group, perfluoro-1-methylethyl group, perfluoro-t-butyl group, fluoromethyl group, difluoromethyl group, 2-fluoroethyl group, 1,1-difluoroethyl group, 1,2-difluoroethyl group, 2,2-difluoroethyl group, 1,1,2-trifluoroethyl group, 2,2,2-trifluoroethyl group, 1,2,2-trifluoroethyl group, 1,1,2,2-tetrafluoroethyl group, 1,2,2,2-tetrafluoroethyl group, di(fluoromethyl)methyl group, bis(trifluoromethyl)methyl group, 1-trifluoromethyl-ethyl group, 1,1-bis(trifluoromethyl)ethyl group, 1-methyl-1-trifluoromethylethyl group, 1-fluoro-1-methylethyl group, 1,2,2,2-tetrafluoro-1-methylethyl group, 1,1-difluoro-2-methylpropyl group and 1,2,2,3,3,3-hexafluoro-1-methylpropyl group.

More preferable are those whose number of carbon atoms is 2 or less. Examples are as follows: methyl group, ethyl group, trifluoromethyl group, pentafluoroethyl group, fluoromethyl group, difluoromethyl group, 2-fluoroethyl group, 1,1-difluoroethyl group, 1,2-difluoroethyl group, 2,2-difluoroethyl group, 1,1,2-trifluoroethyl group, 2,2,2-trifluoroethyl group, 1,2,2-trifluoroethyl group, 1,1,2,2-tetrafluoroethyl group and 1,2,2,2-tetrafluoroethyl group.

Still more preferable are those containing fluorine atoms. Examples are as follows: trifluoromethyl group, pentafluoroethyl group, fluoromethyl group, difluoromethyl group, 2-fluoroethyl group, 1,1-difluoroethyl group, 1,2-difluoroethyl group, 2,2-difluoroethyl group, 1,1,2-trifluoroethyl group, 2,2,2-trifluoroethyl group, 1,2,2-trifluoroethyl group, 1,1,2,2-tetrafluoroethyl group and 1,2,2,2-tetrafluoroethyl group.

There is no special limitation on the molecular weight of the sulfonate compound of the present invention, insofar as the advantage of the present invention is not significantly impaired. The molecular weight is usually 200 or higher, and usually 800 or lower, preferably 600 or lower, more preferably 450 or lower. If this upper limit is exceeded, compatibility or solubility of the sulfonate compound in the non-aqueous electrolyte solution decreases, leading possibly to insufficient suppression of evolved gas on continuous charge and inadequate improvement of cycle characteristics of a lithium secondary battery of the present invention, based on the non-aqueous electrolyte solution.

Concrete examples of the sulfonate compound of the present invention are listed below. It is to be noted that this list is by no means an exhaustive one.

Concrete examples of the sulfonate compounds of the present invention are ethanediol disulfonates such as ethanediol dimethane sulfonate, ethanediol diethane sulfonate, ethanediol dipropane sulfonate, ethanediol dibutane sulfonate, ethanediol bis(trifluoromethane sulfonate), ethanediol bis(pentafluoroethane sulfonate), ethanediol bis(heptafluoropropane sulfonate), ethanediol bis(perfluorobutane sulfonate), ethanediol bis(perfluoropentane sulfonate), ethanediol bis(perfluorohexane sulfonate), ethanediol bis(perfluorooctane sulfonate), ethanediol bis(perfluoro-1-methylethane sulfonate), ethanediol bis(perfluoro-1,1-dimethylethane sulfonate), ethanediol bis(perfluoro-3-methylbutane sulfonate), ethanediol di(fluoromethane sulfonate), ethanediol bis(difluoromethane sulfonate), ethanediol di(2-fluoroethane sulfonate), ethanediol bis(1,1-difluoroethane sulfonate), ethanediol bis(1,2-difluoroethane sulfonate), ethanediol bis(2,2-difluoroethane sulfonate), ethanediol bis(1,1,2-trifluoroethane sulfonate), ethanediol bis(1,2,2-trifluoroethane sulfonate), ethanediol bis(2,2,2-trifluoroethane sulfonate), ethanediol bis(1,1,2,2-tetrafluoroethane sulfonate), ethanediol bis(1,2,2,2-tetrafluoroethane sulfonate), ethanediol di(1-fluoro-1-methylethane sulfonate), ethanediol bis(1,2,2,2-tetrafluoro-1-methylethane sulfonate), ethanediol bis(1,1-difluoro-2-methylpropane sulfonate), ethanediol bis(1,2,2,3,3,3-hexafluoro-1-methylpropane sulfonate), ethanediol di(2-fluoro-1-fluoromethylethane sulfonate), ethanediol bis(2,2,2-trifluoro-1-trifluoromethylethane sulfonate), ethanediol bis(1-trifluoromethylethane sulfonate), ethanediol di(1-methyl-1-trifluoromethylethane sulfonate) and ethanediol bis(1-trifluoromethylhexane sulfonate);

1,2-propanediol disulfonates such as 1,2-propanediol dimethane sulfonate, 1,2-propanediol diethane sulfonate, 1,2-propanediol dipropane sulfonate, 1,2-propanediol dibutane sulfonate, 1,2-propanediol bis(trifluoromethane sulfonate), 1,2-propanediol bis(pentafluoroethane sulfonate), 1,2-propanediol bis(heptafluoropropane sulfonate), 1,2-propanediol bis(perfluorobutane sulfonate), 1,2-propanediol bis(perfluoropentane sulfonate), 1,2-propanediol bis(perfluorohexane sulfonate), 1,2-propanediol bis(perfluorooctane sulfonate), 1,2-propanediol bis(perfluoro-1-methylethane sulfonate), 1,2-propanediol bis(perfluoro-1,1-dimethylethane sulfonate), 1,2-propanediol bis(perfluoro-3-methylbutane sulfonate), 1,2-propanediol di(fluoromethane sulfonate), 1,2-propanediol bis(difluoromethane sulfonate), 1,2-propanediol di(2-fluoroethane sulfonate), 1,2-propanediol bis(1,1-difluoroethane sulfonate), 1,2-propanediol bis(1,2-difluoroethane sulfonate), 1,2-propanediol bis(2,2-difluoroethane sulfonate), 1,2-propanediol bis(1,1,2-trifluoroethane sulfonate), 1,2-propanediol bis(1,2,2-trifluoroethane sulfonate), 1,2-propanediol bis(2,2,2-trifluoroethane sulfonate), 1,2-propanediol bis(1,1,2,2-tetrafluoroethane sulfonate), 1,2-propanediol bis(1,2,2,2-tetrafluoroethane sulfonate), 1,2-propanediol di(1-fluoro-1-methylethane sulfonate), 1,2-propanediol bis(1,2,2,2-tetrafluoro-1-methylethane sulfonate), 1,2-propanediol bis(1,1-difluoro-2-methylpropane sulfonate), 1,2-propanediol bis(1,2,2,3,3,3-hexafluoro-1-methylpropane sulfonate), 1,2-propanediol di(2-fluoro-1-fluoromethylethane sulfonate), 1,2-propanediol bis(2,2,2-trifluoro-1-trifluoromethylethane sulfonate), 1,2-propanediol bis(1-trifluoromethylethane sulfonate), 1,2-propanediol di(1-methyl-1-trifluoromethylethane sulfonate) and 1,2-propanediol bis(1-trifluoromethylhexane sulfonate);

1,3-propanediol disulfonates such as 1,3-propanediol dimethane sulfonate, 1,3-propanediol diethane sulfonate, 1,3-propanediol dipropane sulfonate, 1,3-propanediol dibutane sulfonate, 1,3-propanediol bis(trifluoromethane sulfonate), 1,3-propanediol bis(pentafluoroethane sulfonate), 1,3-propanediol bis(heptafluoropropane sulfonate), 1,3-propanediol bis(perfluorobutane sulfonate), 1,3-propanediol bis(perfluoropentane sulfonate), 1,3-propanediol bis(perfluorohexane sulfonate), 1,3-propanediol bis(perfluorooctane sulfonate), 1,3-propanediol bis(perfluoro-1-methylethane sulfonate), 1,3-propanediol bis(perfluoro-1,1-dimethylethane sulfonate), 1,3-propanediol bis(perfluoro-3-methylbutane sulfonate), 1,3-propanediol di(fluoromethane sulfonate), 1,3-propanediol bis(difluoromethane sulfonate), 1,3-propanediol di(2-fluoroethane sulfonate), 1,3-propanediol bis(1,1-difluoroethane sulfonate), 1,3-propanediol bis(1,2-difluoroethane sulfonate), 1,3-propanediol bis(2,2-difluoroethane sulfonate), 1,3-propanediol bis(1,1,2-trifluoroethane sulfonate), 1,3-propanediol bis(1,2,2-trifluoroethane sulfonate), 1,3-propanediol bis(2,2,2-trifluoroethane sulfonate), 1,3-propanediol bis(1,1,2,2-tetrafluoroethane sulfonate), 1,3-propanediol bis(1,2,2,2-tetrafluoroethane sulfonate), 1,3-propanediol di(1-fluoro-1-methylethane sulfonate), 1,3-propanediol bis(1,2,2,2-tetrafluoro-1-methylethane sulfonate), 1,3-propanediol bis(1,1-difluoro-2-methylpropane sulfonate), 1,3-propanediol bis(1,2,2,3,3,3-hexafluoro-1-methylpropane sulfonate), 1,3-propanediol di(2-fluoro-1-fluoromethylethane sulfonate), 1,3-propanediol bis(2,2,2-trifluoro-1-trifluoromethylethane sulfonate), 1,3-propanediol bis(1-trifluoromethylethane sulfonate), 1,3-propanediol di(1-methyl-1-trifluoromethylethane sulfonate) and 1,3-propanediol bis(1-trifluoromethylhexane sulfonate);

1,2-butanediol disulfonates such as 1,2-butanediol dimethane sulfonate, 1,2-butanediol diethane sulfonate, 1,2-butanediol bis(trifluoromethane sulfonate), 1,2-butanediol bis(pentafluoroethane sulfonate), 1,2-butanediol bis(heptafluoropropane sulfonate), 1,2-butanediol bis(perfluorobutane sulfonate), 1,2-butanediol bis(perfluoro-1-methylethane sulfonate), 1,2-butanediol bis(perfluoro-1,1-dimethylethane sulfonate), 1,2-butanediol di(fluoromethane sulfonate), 1,2-butanediol bis(difluoromethane sulfonate), 1,2-butanediol di(2-fluoroethane sulfonate), 1,2-butanediol bis(2,2-difluoroethane sulfonate), 1,2-butanediol bis(2,2,2-trifluoroethane sulfonate), 1,2-butanediol di(1-fluoro-1-methylethane sulfonate), 1,2-butanediol di(2-fluoro-1-fluoromethylethane sulfonate), 1,2-butanediol bis(2,2,2-trifluoro-1-trifluoromethylethane sulfonate), 1,2-butanediol bis(1-trifluoromethylethane sulfonate), 1,2-butanediol di(1-methyl-1-trifluoromethylethane sulfonate) and 1,2-butanediol bis(1-trifluoromethylhexane sulfonate);

1,3-butanediol disulfonates such as 1,3-butanediol dimethane sulfonate, 1,3-butanediol diethane sulfonate, 1,3-butanediol bis(trifluoromethane sulfonate), 1,3-butanediol bis(pentafluoroethane sulfonate), 1,3-butanediol bis(heptafluoropropane sulfonate), 1,3-butanediol bis(perfluorobutane sulfonate), 1,3-butanediol bis(perfluoro-1-methylethane sulfonate), 1,3-butanediol bis(perfluoro-1,1-dimethylethane sulfonate), 1,3-butanediol di(fluoromethane sulfonate), 1,3-butanediol bis(difluoromethane sulfonate), 1,3-butanediol di(2-fluoroethane sulfonate), 1,3-butanediol bis(2,2-difluoroethane sulfonate), 1,3-butanediol bis(2,2,2-trifluoroethane sulfonate), 1,3-butanediol di(1-fluoro-1-methylethane sulfonate), 1,3-butanediol di(2-fluoro-1-fluoromethylethane sulfonate), 1,3-butanediol bis(2,2,2-trifluoro-1-trifluoromethylethane sulfonate), 1,3-butanediol bis{(1-trifluoromethyl)ethane sulfonate}, 1,3-butanediol di(1-methyl-1-trifluoromethylethane sulfonate) and 1,3-butanediol bis(1-trifluoromethylhexane sulfonate);

1,4-butanediol disulfonates such as 1,4-butanediol dimethane sulfonate, 1,4-butanediol diethane sulfonate, 1,4-butanediol dipropane sulfonate, 1,4-butanediol dibutane sulfonate, 1,4-butanediol bis(trifluoromethane sulfonate), 1,4-butanediol bis(pentafluoroethane sulfonate), 1,4-butanediol bis(heptafluoropropane sulfonate), 1,4-butanediol bis(perfluorobutane sulfonate), 1,4-butanediol bis(perfluoropentane sulfonate), 1,4-butanediol bis(perfluorohexane sulfonate), 1,4-butanediol bis(perfluorooctane sulfonate), 1,4-butanediol bis(perfluoro-1-methylethane sulfonate), 1,4-butanediol bis(perfluoro-1,1-dimethylethane sulfonate), 1,4-butanediol bis(perfluoro-3-methylbutane sulfonate), 1,4-butanediol di(fluoromethane sulfonate), 1,4-butanediol bis(difluoromethane sulfonate), 1,4-butanediol di(2-fluoroethane sulfonate), 1,4-butanediol bis(1,1-difluoroethane sulfonate), 1,4-butanediol bis(1,2-difluoroethane sulfonate), 1,4-butanediol bis(2,2-difluoroethane sulfonate), 1,4-butanediol bis(1,1,2-trifluoroethane sulfonate), 1,4-butanediol bis(1,2,2-trifluoroethane sulfonate), 1,4-butanediol bis(2,2,2-trifluoroethane sulfonate), 1,4-butanediol bis(1,1,2,2-tetrafluoroethane sulfonate), 1,4-butanediol bis(1,2,2,2-tetrafluoroethane sulfonate), 1,4-butanediol di(1-fluoro-1-methylethane sulfonate), 1,4-butanediol bis(1,2,2,2-tetrafluoro-1-methylethane sulfonate), 1,4-butanediol bis(1,1-difluoro-2-methylpropane sulfonate), 1,4-butanediol bis(1,2,2,3,3,3-hexafluoro-1-methylpropane sulfonate), 1,4-butanediol di(2-fluoro-1-fluoromethylethane sulfonate), 1,4-butanediol bis(2,2,2-trifluoro-1-trifluoromethylethane sulfonate), 1,4-butanediol bis(1-trifluoromethylethane sulfonate), 1,4-butanediol di(1-methyl-1-trifluoromethylethane sulfonate) and 1,4-butanediol bis(1-trifluoromethylhexane sulfonate); and

1,4-benzenediol disulfonates such as 1,4-benzenediol dimethane sulfonate, 1,4-benzenediol diethane sulfonate, 1,4-benzenediol bis(trifluoromethane sulfonate), 1,4-benzenediol bis(pentafluoroethane sulfonate), 1,4-benzenediol bis(heptafluoropropane sulfonate), 1,4-benzenediol bis(perfluorobutane sulfonate), 1,4-benzenediol bis(perfluoro-1-methylethane sulfonate), 1,4-benzenediol bis(perfluoro-1,1-dimethylethane sulfonate), 1,4-benzenediol di(fluoromethane sulfonate), 1,4-difluoromethane sulfonate, 1,4-benzenediol di(2-fluoroethane sulfonate), 1,4-benzenediol bis(2,2-difluoroethane sulfonate), 1,4-benzenediol bis(2,2,2-trifluoroethane sulfonate), 1,4-benzenediol di(1-fluoro-1-methylethane sulfonate), 1,4-benzenediol di(2-fluoro-1-fluoromethylethane sulfonate), 1,4-benzenediol bis(2,2,2-trifluoro-1-trifluoromethylethane sulfonate), 1,4-benzenediol bis(1-trifluoromethylethane sulfonate), 1,4-benzenediol di(1-methyl-1-trifluoromethylethane sulfonate) and 1,4-benzenediol bis(1-trifluoromethylhexane sulfonate).

Of the above compounds, preferable are those whose number of carbon atoms of R³⁰ is 1 or 2. Examples are as follows: ethanediol disulfonates such as ethanediol dimethane sulfonate, ethanediol diethane sulfonate, ethanediol bis(trifluoromethane sulfonate), ethanediol bis(pentafluoroethane sulfonate), ethanediol di(fluoromethane sulfonate), ethanediol bis(difluoromethane sulfonate), ethanediol di(2-fluoroethane sulfonate), ethanediol bis(2,2-difluoroethane sulfonate) and ethanediol bis(2,2,2-trifluoroethane sulfonate);

1,2-propanediol disulfonates such as 1,2-propanediol dimethane sulfonate, 1,2-propanediol diethane sulfonate, 1,2-propanediol bis(trifluoromethane sulfonate), 1,2-propanediol bis(pentafluoroethane sulfonate), 1,2-propanediol di(fluoromethane sulfonate), 1,2-propanediol bis(difluoromethane sulfonate), 1,2-propanediol di(2-fluoroethane sulfonate), 1,2-propanediol bis(2,2-difluoroethane sulfonate) and 1,2-propanediol bis(2,2,2-trifluoroethane sulfonate);

1,3-propanediol disulfonates such as 1,3-propanediol dimethane sulfonate, 1,3-propanediol diethane sulfonate, 1,3-propanediol bis(trifluoromethane sulfonate), 1,3-propanediol bis(pentafluoroethane sulfonate), 1,3-propanediol di(fluoromethane sulfonate), 1,3-propanediol bis(difluoromethane sulfonate), 1,3-propanediol di(2-fluoroethane sulfonate), 1,3-propanediol bis(2,2-difluoroethane sulfonate) and 1,3-propanediol bis(2,2,2-trifluoroethane sulfonate);

1,2-butanediol disulfonates such as 1,2-butanediol dimethane sulfonate, 1,2-butanediol diethane sulfonate, 1,2-butanediol bis(trifluoromethane sulfonate), 1,2-butanediol bis(pentafluoroethane sulfonate), 1,2-butanediol di(fluoromethane sulfonate), 1,2-butanediol bis(difluoromethane sulfonate), 1,2-butanediol di(2-fluoroethane sulfonate), 1,2-butanediol bis(2,2-difluoroethane sulfonate) and 1,2-butanediol bis(2,2,2-trifluoroethane sulfonate);

1,3-butanediol disulfonates such as 1,3-butanediol dimethane sulfonate, 1,3-butanediol diethane sulfonate, 1,3-butanediol bis(trifluoromethane sulfonate), 1,3-butanediol bis(pentafluoroethane sulfonate), 1,3-butanediol di(fluoromethane sulfonate), 1,3-butanediol bis(difluoromethane sulfonate), 1,3-butanediol di(2-fluoroethane sulfonate), 1,3-butanediol bis(2,2-difluoroethane sulfonate) and 1,3-butanediol bis(2,2,2-trifluoroethane sulfonate); and

1,4-butanediol disulfonates such as 1,4-butanediol dimethane sulfonate, 1,4-butanediol diethane sulfonate, 1,4-butanediol bis(trifluoromethane sulfonate), 1,4-butanediol bis(pentafluoroethane sulfonate), 1,4-butanediol di(fluoromethane sulfonate), 1,4-butanediol bis(difluoromethane sulfonate), 1,4-butanediol di(2-fluoroethane sulfonate), 1,4-butanediol bis(2,2-difluoroethane sulfonate) and 1,4-butanediol bis(2,2,2-trifluoroethane sulfonate).

Of these compounds, particularly preferable are those in which R³⁰ is an aliphatic saturated hydrocarbon group, with 1 or 2 carbon atoms, having fluorine substituents. Examples are ethanediol disulfonates such as ethanediol bis(trifluoromethane sulfonate), ethanediol bis(pentafluoroethane sulfonate), ethanediol di(fluoromethane sulfonate), ethanediol di(2-fluoroethane sulfonate) and ethanediol bis(2,2,2-trifluoroethane sulfonate);

1,2-propanediol disulfonates such as 1,2-propanediol bis(trifluoromethane sulfonate), 1,2-propanediol bis(pentafluoroethane sulfonate), 1,2-propanediol di(fluoromethane sulfonate), 1,2-propanediol di(2-fluoroethane sulfonate) and 1,2-propanediol bis(2,2,2-trifluoroethane sulfonate);

1,3-propanediol disulfonates such as 1,3-propanediol bis(trifluoromethane sulfonate), 1,3-propanediol bis(pentafluoroethane sulfonate), 1,3-propanediol di(2-fluoroethane sulfonate) and 1,3-propanediol bis(2,2,2-trifluoroethane sulfonate);

1,2-butanediol disulfonates such as 1,2-butanediol bis(trifluoromethane sulfonate), 1,2-butanediol bis(pentafluoroethane sulfonate), 1,2-butanediol di(fluoromethane sulfonate), 1,2-butanediol di(2-fluoroethane sulfonate) and 1,2-butanediol bis(2,2,2-trifluoroethane sulfonate);

1,3-butanediol disulfonates such as 1,3-butanediol bis(trifluoromethane sulfonate), 1,3-butanediol bis(pentafluoroethane sulfonate), 1,3-butanediol di(fluoromethane sulfonate), 1,3-butanediol di(2-fluoroethane sulfonate) and 1,3-butanediol bis(2,2,2-trifluoroethane sulfonate); and

1,4-butanediol disulfonates such as 1,4-butanediol bis(trifluoromethane sulfonate), 1,4-butanediol bis(pentafluoroethane sulfonate), 1,4-butanediol di(fluoromethane sulfonate), 1,4-butanediol di(2-fluoroethane sulfonate) and 1,4-butanediol bis(2,2,2-trifluoroethane sulfonate).

These sulfonate compound are not too large in their molecular weight, dissolve easily in the non-aqueous electrolyte solution, and behave at the positive electrode and negative electrode, leading to improvement in continuous charge characteristics and cycle characteristics of a lithium secondary battery, especially, of a high voltage.

The sulfonate compounds of the present invention mentioned above can be used either singly or as a mixture of two or more compounds in any combination or in any ratio.

[I-4-1-2. Composition of Sulfonate Compound]

In case the non-aqueous electrolyte solution of the present invention contains the sulfonate compound, there is no special limitation on the content of the sulfonate compound of the present invention in the non-aqueous electrolyte solution of the present invention, so long as the advantage of the present invention is not significantly impaired. The content of the sulfonate compound of the present invention in the non-aqueous electrolyte solution of the present invention is usually 0.01 weight % or higher, preferably 0.1 weight % or higher, and usually 10 weight % or lower, preferably 5 weight % or lower, more preferably 3 weight % or lower, still more preferably 2 weight % or lower. When the content is below the above lower limit, it may not be possible to improve continuous charge characteristics and cycle characteristics of the non-aqueous electrolyte solution of the present invention. On the other hand, when the content exceeds the upper limit of this range, a thick coat will be formed on the negative electrode and, because of high resistance of this coat, migration of lithium ions between the non-aqueous electrolyte solution and the negative electrode becomes difficult, leading possibly to deterioration of battery characteristics such as rate characteristics. In case two or more kinds of sulfonate compounds of the present invention are used in combination, the sum of the content of those sulfonate compounds should be adjusted to fall within the above range.

[I-4-2. Non-Aqueous Solvent]

In case the non-aqueous electrolyte solution of the present invention contains the sulfonate compound of the present invention, there is no special limitation on the non-aqueous solvent and any known non-aqueous solvent can be used. For example, non-aqueous solvents, similar to those described in [I-1-4. Non-aqueous solvent] as non-aqueous solvents which can be used in case the non-aqueous electrolyte solution of the present invention contains both vinylethylene carbonate compound and vinylene carbonate compound, can be used. If the non-aqueous solvent contains the unsaturated carbonate compound, then, the unsaturated carbonate compound is regarded as coat-forming material mentioned later.

[I-4-3. Electrolyte]

In case the non-aqueous electrolyte solution of the present invention contains sulfonate compound of the present invention, there is no special limitation on the electrolyte used and any known electrolyte, which is used as electrolyte of a lithium secondary battery, can be used. For example, electrolytes, similar to those described in [I-1-5. Electrolyte] as electrolytes which can be used in case the non-aqueous electrolyte solution of the present invention contains both vinylethylene carbonate compound and vinylene carbonate compound, can be used.

[I-4-4. Coat-Forming Material]

In case the non-aqueous electrolyte solution of the present invention contains the sulfonate compound of the present invention, it is preferable that the non-aqueous electrolyte solution contains a coat-forming material, similarly to the case that it contains the α-substituted lactone compound or the unsaturated lactone compound. As for this coat-forming material, coat-forming materials similar to those described in [I-2-4. Coat-forming material] for the non-aqueous electrolyte solution of the present invention containing the α-substituted lactone compound can be used.

The explanation will be given here why it is preferable that the non-aqueous electrolyte solution of the present invention contains the unsaturated carbonate compound. On initial charge, a part or all of the sulfonate compound of the present invention is decomposed on the negative electrode and a coat is formed. This suppresses subsequent reductive decomposition reaction of the non-aqueous solvent, bringing about improvement in cycle characteristics of a lithium secondary battery. However, the coat formed from the sulfonate compound is comparatively high in resistance, leading occasionally to lowering of capacity retention rate on charge/discharge cycle, depending on charge/discharge rate.

On the other hand, if the unsaturated carbonate compound is contained in the non-aqueous electrolyte solution, the sulfonate compound and the unsaturated carbonate compound are both reduced in a concerted manner on initial charge and a hybrid coat originating from both compounds is formed on the negative electrode. This hybrid coat is low in resistance and superior in heat stability and solvent stability, bringing about improvement in cycle characteristics of a lithium secondary battery of the present invention.

[I-4-5. Other Auxiliary Agent]

In case the non-aqueous electrolyte solution of the present invention contains sulfonate compound of the present invention, the non-aqueous electrolyte solution of the present invention may contain other auxiliary agent in order to improve such characteristics as permeability of the non-aqueous electrolyte solution and overcharge characteristics of the battery, insofar as the advantage of the present invention is not significantly impaired. For example, auxiliary agents, similar to those described in [I-1-6. Other auxiliary agent] as auxiliary agents which can be used in case the non-aqueous electrolyte solution of the present invention contains both vinylethylene carbonate compound and vinylene carbonate compound, can be used.

[I-4-6. State of Non-Aqueous Electrolyte Solution]

In case the non-aqueous electrolyte solution of the present invention contains the sulfonate compound of the present invention, the state of the non-aqueous electrolyte solution of the present invention is similar to that described in [I-1-7. State of non-aqueous electrolyte solution] for the non-aqueous electrolyte solution of the present invention containing both vinylethylene carbonate compound and vinylene carbonate compound.

[I-4-7. Production Method of Non-Aqueous Electrolyte Solution]

In case the non-aqueous electrolyte solution of the present invention contains the sulfonate compound of the present invention, the non-aqueous electrolyte solution of the present invention can be prepared by dissolving in the non-aqueous solvent electrolyte, the sulfonate compound of the present invention, and, as needed, coat-forming material and other auxiliary agent.

Similarly to what has been described in [I-1-8. Production method of non-aqueous electrolyte solution] for the non-aqueous electrolyte solution of the present invention, containing both vinylethylene carbonate compound and vinylene carbonate compound, it is preferable that each material for non-aqueous electrolyte solution, namely electrolyte, the sulfonate compound, non-aqueous solvent, the unsaturated carbonate compound and other auxiliary agent, is dehydrated before use. The preferable extent of dehydration is also similar.

[II. Lithium Secondary Battery]

The non-aqueous electrolyte solution of the present invention can be widely used where an ordinary electrolyte solution is used. It is particularly preferable for the use as electrolyte solution of a lithium secondary battery.

The lithium secondary battery of the present invention comprises the non-aqueous electrolyte solution of the present invention described above, positive electrode and negative electrode. The lithium secondary battery of the present invention may comprise other components. For example, the lithium secondary battery usually comprises a spacer.

[II-1. Positive Electrode]

A positive electrode is capable of absorbing and releasing lithium. If this requirement is met, there is no other limitation, insofar as the advantage of the present invention is not significantly impaired.

Usually, a layer of positive electrode active material is formed on the current collector and used as positive electrode. A positive electrode may comprise other layer if necessary.

[II-1-1. Layer of Positive Electrode Active Material]

A positive electrode active material layer is designed to contain positive electrode active material. There is no special limitation on the kind of positive electrode active material, insofar as it can absorb and release lithium ions. As examples can be cited oxides of such transition metals as Fe, Co, Ni and Mn, composite oxides of transition metals and lithium, and sulfides of transition metals.

As concrete examples of oxides of transition metals can be cited MnO, V₂O₅, V₆O₁₃ and TiO₂.

As concrete examples of composite oxides of transition metals and lithium can be cited lithium nickel composite oxide whose basic composition is LiNiO₂ or the like; lithium cobalt composite oxides whose basic composition is LiCoO₂ or the like; lithium manganese composite oxides whose basic composition is LiMnO₂, LiMnO₄ or the like.

As concrete examples of sulfide of transition metals can be cited TiS₂ and FeS.

Of these, composite oxides of lithium and transition metals are preferable because they can achieve both large capacity and high cycle characteristics of the lithium secondary battery.

In the above mentioned composite oxides of transition metals and lithium, it is preferable that a part of transition metal atoms, which constitute main part of the composite oxides, is replaced by other metals such as Al, B, Ti, Zr, V, Cr, Mn, Fe, Co, Ni, Cu, Zn, Mg, Ca and Ga, because the replacement increases stability. Particularly preferable are Al, Mg, Ca, Ti, Zr, Co, Ni and Mn, because the replacement then suppresses deterioration of the positive electrode at a high voltage.

Furthermore, it is preferable that the surface of the above mentioned composite oxide of transition metal and lithium is coated by oxides of such metals as Al, B, Ti, Zr, V, Cr, Mn, Fe, Co, Ni, Cu, Zn, Mg, Ca and Ga, because oxidation reaction of solvents at a high voltage is suppressed. Of these metal oxides, particularly preferable are Al₂O₃, TiO₂, ZrO₂ and MgO, because they are of high strength and can exert stable coating effect.

These positive electrode active materials can be used either with single kind thereof, or as a mixture of two or more kinds in any combination and in any ratio.

There is no special limitation on the specific surface area of the positive electrode active material, insofar as the advantage of the present invention is not significantly impaired. It is usually 0.1 m²/g or more, preferably 0.2 m²/g or more, and usually 10 m²/g or less, preferably 5.0 m²/g or less, more preferably 3.0 m²/g or less. If the specific surface area is too small, rate characteristics may deteriorate and capacity may decrease. On the other hand, if it is too large, positive electrode active material and non-aqueous electrolyte solution may cause an undesirable interaction, leading to deterioration of cycle characteristics.

There is no special limitation on the average secondary particle diameter of the positive electrode active material, insofar as the advantage of the present invention is not significantly impaired. It is usually 0.2 μm or larger, preferably 0.3 μm or larger, and usually 20 μm or smaller, preferably 10 μm or smaller. If the average secondary particle diameter is too small, cycle deterioration of a lithium secondary battery may become marked or handling of the battery may become difficult. If it is too large, internal resistance of the battery may become large, leading to insufficient output.

There is no special limitation on the thickness of the positive electrode active material layer, insofar as the advantage of the present invention is not significantly impaired. The thickness is usually 1 μm or larger, preferably 10 μm or larger, more preferably 20 μm or larger, most preferably 40 μm or larger, and usually 200 μm or smaller, preferably 150 μm or smaller, more preferably 100 μm or smaller. If it is too thin, not only application is difficult and uniformity of the layer is difficult to achieve, but capacity of the lithium secondary battery of the present invention may become small. On the other hand, if it is too thick, rate characteristics may deteriorate.

For the preparation of positive electrode active material layer, for example, the above-mentioned positive electrode active material, binder and various auxiliary agent, if necessary, can be made into a slurry using a solvent and this slurry can be applied onto a current collector, followed by drying. Otherwise, the above positive electrode active material can be roll-molded into a sheet electrode, or compression-molded into a pellet electrode.

In the following, explanation will be given for the case of application and drying of a slurry on the positive electrode current collector.

There is no special limitation on the kind of a binder, insofar as it is stable in the non-aqueous solvent used for a non-aqueous electrolyte solution, and in the solvent used for preparation of the electrode. It is preferable that the binder is selected, taking into consideration its weatherability, stability against chemicals, heat resistance, incombustibility or the like. As examples can be cited inorganic materials such as silicate and liquid glass; alkane type polymers such as polyethylene, polypropylene and poly-1,1-dimethylethylene; unsaturated polymers such as polybutadiene and polyisoprene; polymers possessing a ring such as polystyrene, polymethylstyrene, polyvinylpyridine and poly-N-vinylpyrrolidone; acryl compound polymers such as methyl polymetacrylate, ethyl polymetacrylate, butyl polymetacrylate, methyl polyacrylate, ethyl polyacrylate, polyacrylic acid, polymetacrylic acid and polyacrylamide; fluorinated resins such as polyfluorinated vinyl, polyfluorinated vinylidene and polytetrafluoroethylene; CN-containing polymer such as polyacrylonitrile and polyvinylidene cyanide; polyvinyl alcohol type polymers such as polyvinyl acetate and polyvinyl alcohol; halogen-containing polymers such as polychlorinated vinyl and polychlorinated vinylidene; and electroconductive polymer such as polyaniline.

Also applicable are a mixture, modification, derivative, random copolymer, alternating copolymer, graft copolymer and block copolymer or the like of the above polymers.

Of these, preferable as binder is fluorinated resin and CN-containing polymer.

The binder can be used either singly or as a mixture of two or more kinds in any combination and in any ratio.

In case resin is used as binder, there is no special limitation on the weight average molecular weight of the resin, insofar as the advantage of the present invention is not significantly impaired. It is usually 10,000 or higher, preferably 100,000 or higher, and usually 3,000,000 or lower, preferably 1,000,000 or lower. If the molecular weight is too low, the strength of the electrode tends to be low. On the other hand, if the molecular weight is too high, viscosity tends to be high, making electrode formation difficult.

There is no special limitation on the amount of the binder used, insofar as the advantage of the present invention is not significantly impaired. For 100 weight parts of positive electrode active material (negative electrode active material when used for negative electrode. Hereinafter referred to simply as “active material” when no distinction is made between the two electrodes), the amount used is usually 0.1 weight part or more, preferably 1 weight part or more, and usually 30 weight parts or less, preferably 20 weight parts or less. If the amount of the binder is too small, the strength of the electrode tends to decrease. If the amount of the binder is too large, ion conductivity tends to decrease.

Furthermore, to the electrode may be added various auxiliary agent or the like as mentioned above. Examples of the auxiliary agents or the like include conductive material which heightens electrical conductivity of the electrode and reinforcing material which increases mechanical strength of the electrode.

The conductive material can be any material which can be added to active material in a proper amount and can impart electric conductivity. Usually, as concrete examples can be cited carbon powders such as acetylene black, carbon black and graphite, and various metal fiber and foil.

As concrete examples of reinforcing material can be cited various inorganic and organic, spherical and fibrous filler.

Above-cited auxiliary agent or the like can be used either singly or as a mixture of more than one kind in any combination and in any ratio.

There is no special limitation on the kind of solvent used for preparing a slurry, insofar as it can dissolve or disperse active material, binder, and, as needed, auxiliary agent. Either aqueous solvent or organic solvent can be used.

As examples of aqueous solvent can be cited water and alcohol. As organic solvent can be cited N-methylpyrrolidone (NMP), dimethylformamide, dimethylacetamide, methylethyl ketone, cyclohexanone, methyl acetate, methyl acrylate, diethyltriamine, N,N-dimethylaminopropylamine, ethylene oxide, tetrahydrofuran (THF), toluene, acetone, dimethyether, dimethylacetamide, hexamethylphosphoramide, dimethylsulfoxide, benzene, xylene, quinoline, pyridine, methylnaphthalene and hexane.

Above-cited solvent can be used either singly or as a mixture of two or more kinds in any combination and in any ratio.

It is preferable that an active material layer, prepared by coating and drying, is compressed by such means as roller pressing in order to increase the filling density of the positive electrode active material.

[II-1-2. Current Collector]

Any material known for such a purpose as material of a collector can be used. Usually, metal or alloy is used. As concrete examples of a current collector of positive electrode can be cited aluminium, nickel and SUS (stainless steel). Of these, aluminium is preferable as current collector of the positive electrode. Above-cited material can be used either singly or as a mixture of more than one kind in any combination and in any ratio.

In order to increase the bindability of the current collector to the active material layer formed thereon, it is preferable that the collector surface is subjected to roughening procedure in advance. Examples of surface roughening methods include: blasting procedure; rolling with a rough-surfaced roll; mechanical polishing in which the collector surface is polished with such means as an abrasive cloth or abrasive paper onto which abradant particles are adhered, a whetstone, an emery buff and a wire brush equipped with steel wire; electropolishing; and chemical polishing.

There is no limitation on the shape of the collector. In order to decrease the battery weight and increase energy density per unit weight, it is also possible to use a perforated-type current collectors such as an expanded metal or a punching metal. This type of collector is freely adjustable in its weight by means of adjusting its ratio of perforation. Besides, when the application layer is formed on both sides of this perforated-type of collector, the application layer is riveted at these perforations and becomes resistant to exfoliation of the application layer. However, if the ratio of perforation is too high, bond strength may rather decrease because the contact area between the application layer and the current collector becomes too small.

In case a thin film is used as positive electrode current collector, there is no special limitation on its thickness, insofar as the advantage of the present invention is not significantly impaired. It is usually 1 μm or larger, preferably 5 μm or larger, and usually 100 μm or smaller, preferably 50 μm or smaller. If it is too thick, battery capacity as a whole becomes low, and if it is too thin, handling becomes difficult.

[II-2. Negative Electrode]

A negative electrode is capable of absorbing and releasing lithium. If this requirement is met, there is no other limitation, insofar as the advantage of the present invention is not significantly impaired.

Usually, similarly to the case of positive electrode, a layer of negative electrode active material is formed on the current collector and used as negative electrode. A negative electrode may comprise other layer if necessary, similarly to the case of positive electrode.

[II-2-1. Negative Electrode Active Material]

There is no special limitation on the material used as negative electrode active material, insofar as it can absorb and release lithium ions. Any known negative electrode active material can be used. Preferable, for example, are carbonaceous materials such as coke, acetylene black, mesophase microbeads and graphite; metallic lithium; and lithium alloys such as lithium-silicone and lithium-tin.

Lithium alloy is particularly preferable because it has high capacity per unit weight and is excellent in safety. From the standpoint of cycle characteristics and safety, it is also particularly preferable to use carbonaceous material.

Negative electrode active material can be used either singly or as a mixture of two or more compounds in any combination and in any ratio.

There is no special limitation on the particle diameter of negative electrode active material, insofar as the advantage of the present invention is not significantly impaired. In order to guarantee excellent battery characteristics in terms of initial efficiency, rate characteristics and cycle characteristics, it is usually 1 μm or larger, preferably 15 μm or larger, and usually 50 μm or smaller, preferably 30 μm or smaller.

Also preferable as carbonaceous material are, for example, the above carbonaceous material which is calcined after being coated with organic substance such as pitch, and carbonaceous material onto which more-amorphous carbon was layered by such means as chemical vacuum deposition (CVD). As organic substance used for coating can be cited: coal tar pitch ranging from soft pitch to hard pitch; coal-derived heavy oil such as dry distilled liquefied oil; heavy oil derived from straight distillation such as atmospheric residual oil and vacuum residual oil; petroleum-derived heavy oil such as heavy oil produced as by-product of pyrolysis of crude oil and naphtha (for example, ethylene heavy end). Also usable is a pulverized solid residue, 1 to 100 μm in diameter, obtained after distillation of the above heavy oil at 200 to 400° C. Further, polyvinyl chloride resin, phenol resin and imide resin are also applicable.

In order to be used as negative electrode active material layer, the above negative electrode active material can be, for example, roll-molded into a sheet electrode, or compression-molded into a pellet electrode. Usually, however, as is the case with the positive electrode active material layer, the above-mentioned negative electrode active material, binder and various auxiliary agent, if necessary, can be made into a slurry using a solvent and this slurry can be applied onto a current collector, followed by drying, so as to form a negative electrode active material layer. The solvent, binder, and auxiliary agent that are similar to those used for positive electrode active material can be used to form the slurry.

[II-2-2. Current Collector]

As material of a current collector of the negative electrode, any known material can be used. For example, metallic materials such as copper, nickel and SUS can be used. Copper is particularly preferable from the standpoint of ease of manipulation and cost.

It is preferable that the surface of the current collector of the negative electrode has been subjected to roughening procedure in advance, similarly to the case of the positive electrode collector.

There is no limitation on the shape of the current collector, similarly to the case of the positive electrode. It is possible to use a perforated-type current collectors such as an expanded metal or a punching metal. In case a thin film is used as current collector, the desirable thickness is similar to that of the positive electrode.

[II-3. Spacer]

Usually, a spacer is installed between the positive electrode and the negative electrode to prevent short circuit. There is no special limitation on the material or shape of the spacer. It is preferable that the spacer is stable in the non-aqueous electrolyte solution mentioned above, is superior in liquid-retaining property and can prevent short circuit between the electrodes without fail.

As material of the spacer can be used, for example, polyolefins such as polyethylene and polypropylene, polytetrafluoroethylene and polyether sulfone. Preferable is polyolefin.

As for the shape of the spacer, porous material is preferable. In this case, the non-aqueous electrolyte solution is used being impregnated within the porous spacer.

There is no special limitation on the thickness of the spacer, insofar as the advantage of the present invention is not significantly impaired. It is usually 1 μm or larger, preferably 5 μm or larger, more preferably 10 μm or larger, and usually 50 μm or smaller, preferably 40 μm or smaller, more preferably 30 μm or smaller. If the spacer is too thin, insulation performance or mechanical strength may be inadequate. If it is too thick, not only battery performance such as rate characteristics may deteriorate but energy density of the entire battery may decline.

In case a porous membrane is used as spacer, there is no special limitation on the porosity of the spacer, insofar as the advantage of the present invention is not significantly impaired. The porosity is usually 20% or more, preferably 35% or more, more preferably 45% or more, and usually 90% or less, preferably 85% or less, more preferably 75% or less. If the porosity is too low, membrane resistance increases and rate characteristics tend to deteriorate. If it is too high, the mechanical strength of the membrane decreases and insulation performance tends to decline.

In case a porous membrane is used as spacer, there is no special limitation on the average pore diameter of the spacer, insofar as the advantage of the present invention is not significantly impaired. It is usually 0.5 μm or smaller, preferably 0.2 μm or smaller, and usually 0.05 μm or larger. If it is too large, short circuit is liable to occur. If it is too small, membrane resistance may become large and rate characteristics may decline.

[II-4. Assembling of Lithium Secondary Battery]

A lithium secondary battery of the present invention is manufactured by assembling the non-aqueous electrolyte solution of the present invention described above, the positive electrode, the negative electrode and, as needed, a spacer into a suitable shape. In addition, other components such as outer casing may be used, as needed. There is no special limitation on the shape of the lithium secondary battery of the present invention. Of various shapes generally employed, an appropriate one can be adopted depending on its use. Examples are a coin type battery, cylindrical type battery and square type battery. The method of assembling the battery is also arbitrary, and an appropriate one can be selected from among those usually employed, depending on the shape of the specific battery.

[II-5. Operation]

As described above, by using the non-aqueous electrolyte solution of the present invention for a lithium secondary battery of the present invention, even when charge is conducted until the terminal-to-terminal open circuit voltage reaches usually 4.25 V or higher, preferably 4.30 V or higher, more preferably 4.40 V or higher at the end of charge at 25° C., it is possible to suppress the reaction of the electrolyte solution, to suppress the evolution of gas markedly and to improve cycle characteristics substantially.

[III. Others]

[III-1. Terminal-to-Terminal Open Circuit Voltage at the End of Charge]

In this specification, a terminal-to-terminal open circuit voltage of a battery means a battery voltage when there is no current in the circuit. The method of its measurement is arbitrary. For example, it can be measured using a usual charge and discharge instrument.

[III-2. Charge]

When a lithium secondary battery is charged, charge is generally done with a portion corresponding to resistance voltage drop added to the voltage. Namely, charge voltage is a sum of the terminal-to-terminal open circuit voltage and the product of charge current and resistance. Therefore, as the charge current becomes large, or internal resistance of the lithium secondary battery or resistance of protection circuit becomes large, the difference between the charge voltage and terminal-to-terminal open circuit voltage becomes large.

In a lithium secondary battery of the present invention, the method of charge is not particularly limited and any method of charge can be applied. For example, constant current charge (CC charge), constant current and constant voltage charge (CCCV charge), pulse charge and reverse taper charge can be used.

The end of charge can also be decided in various manners. For example, charge can be done for a predetermined period of time (for example, longer than was theoretically calculated for the completion of charge), or it can be done until the charge current decreases below a preset level, as well as until the voltage reaches a preset level.

In the current lithium secondary battery, a terminal-to-terminal open circuit voltage at the end of charge is usually in the range of 4.08 to 4.20 V. If this terminal-to-terminal open circuit voltage at the end of charge is higher, the capacity (mAh) of the lithium secondary battery is proportionally higher. Also, if the terminal-to-terminal open circuit voltage at the end of charge is higher, the voltage itself of the lithium secondary battery becomes higher and energy density per unit weight (mWh/kg) increases. Thus, a light lithium secondary battery with long duration is realized.

[III-3. Mechanism]

The mechanism through which the advantage of the present invention is achieved is not clear. The inventors' inference is as follows.

[III-3-1. Suggested Mechanism when the Non-Aqueous Electrolyte Solution Contains Vinylethylene Carbonate Compound and Vinylene Carbonate Compound]

As mentioned above, development of a lithium secondary battery has been desired, which has a high terminal-to-terminal open circuit voltage at the end of charge. According to previous technologies, under the condition of high voltage of 4.25 V or higher, oxidation reaction of the electrolyte solution mainly at the positive electrode was very extensive, resulting in deterioration of cycle characteristics, and the lithium secondary battery fell short of practical use.

The vinylethylene carbonate compound of the present invention forms a protective coat on the positive electrode under the condition of high voltage and inhibit the reaction between the positive electrode and electrolyte solution. However, the vinylethylene carbonate compound is partly reduced at the negative electrode at the initial stage of charge and form a thick fragile coat.

Therefore, vinylethylene carbonate compound alone can not achieve marked improvement in cycle characteristics, because of fragile nature of the coat on the negative electrode.

On the other hand, the vinylene carbonate compound of the present invention, is partly or entirely reduced at the negative electrode at the initial stage of charge and form a stable protective coat on the negative electrode. However, the vinylene carbonate compound remaining in the electrolyte solution after initial charge is decomposed at the positive and negative electrodes especially during cycle tests.

Furthermore, the vinylene carbonate compound, when decomposed at the negative electrode, works to repair the coat of the negative electrode, which is desirable. However, when it is decomposed at the positive electrode, the coat is not formed and gas is evolved. The decomposition at the positive electrode becomes more marked as the voltage of the lithium secondary battery becomes high.

Accordingly, in a high voltage battery, vinylene carbonate compound alone, although it improves the stability of the coat at the negative electrode, causes evolved gas at the positive electrode due to self decomposition, leading to inadequate improvement in cycle characteristics.

The non-aqueous electrolyte solution of the present invention contains both vinylethylene carbonate compound and vinylene carbonate compound and, therefore, can suppress reactions at both positive electrode and negative electrode, as described below. Namely, the two compounds are both reduced in a concerted manner on initial charge, resulting in the formation of a hybrid coat (protective coat) on the negative electrode. This coat is low in resistance and is superior in heat stability and solvent stability. On the other hand, the decomposition of vinylene carbonate compound is inhibited at the positive electrode by a protective coat originating from the vinylethylene carbonate compound, leading to remarkable improvement in cycle characteristics of a lithium secondary battery under the condition of high voltage.

[III-3-2. Suggested Mechanism when the Non-Aqueous Electrolyte Solution Contains Lactone Compound Having a Substituent at its α Position]

As mentioned above, development of a lithium secondary battery has been desired, which has a high terminal-to-terminal open circuit voltage at the end of charge. According to previous technologies, under the condition of high voltage of 4.25 V or higher, oxidation reaction of the electrolyte solution mainly at the positive electrode was very extensive, resulting in deterioration of cycle characteristics, and the lithium secondary battery fell short of practical use. On the other hand, in the lithium secondary battery of the present invention, the α-substituted lactone compound forms a protective coat on the positive electrode and suppress oxidation reaction of the non-aqueous electrolyte solution, making possible the lithium secondary battery with less deterioration and superior cycle characteristics and storage characteristics.

In general, lactone compound are decomposed at the positive electrode forming a coat, while they are decomposed at the negative electrode and evolve gas, which is a disadvantage. In the present invention, the lactone compound used is the α-substituted lactone compound having a substituent at the α position. Because of this substituent at the α position, α-substituted lactone compound is less liable to undergo evolved gas at the negative electrode, which proceeds via elimination of α-hydrogen. Accordingly, in the non-aqueous electrolyte solution also, the α-substituted lactone compound forms a protective coat on the positive electrode more easily and is less likely to cause gas-evolving reaction on the negative electrode, in comparison with other lactone compound. As a result, a terminal-to-terminal open circuit voltage at the end of charge of a lithium secondary battery of the present invention becomes higher and the amount of gas evolved is held at a low level on continuous charge.

In particular, when the substituent at the α position is an electron-donating groups such as alkyl group and aryl group, electron density of the carbonyl group increases and, as a result, oxidation-resistant property of the α-substituted lactone compound decreases. Accordingly, the α-substituted lactone compound is liable to undergo decomposition at the positive electrode and is capable of forming an effective protective coat. This is instrumental in suppressing the subsequent decomposition of the main solvent and decreasing evolved gas under the condition of continuous charge, which leads to less capacity deterioration.

[III-3-3. Suggested Mechanism when the Non-Aqueous Electrolyte Solution Contains Lactone Compound Having a Unsaturated Carbon-Carbon Bond]

As mentioned above, development of a lithium secondary battery has been desired, which has a high terminal-to-terminal open circuit voltage at the end of charge. According to previous technologies, under the condition of high voltage of 4.25 V or higher, oxidation reaction of the electrolyte solution mainly at the positive electrode was very extensive, resulting in deterioration of cycle characteristics, and the lithium secondary battery fell short of practical use. On the other hand, in the lithium secondary battery of the present invention, the unsaturated lactone compound forms a protective coat on the positive electrode and suppress oxidation reaction of the non-aqueous electrolyte solution. This is mainly instrumental in making possible the lithium secondary battery with less deterioration and superior cycle characteristics, storage characteristics and continuous charge characteristics.

Unsaturated lactone compound possesses an unsaturated carbon-carbon bond and, because of this, is liable to undergo polymerization reaction on oxidation. Furthermore, as lactone compound is a cyclic ester, they may also undergo ring-opening polymerization. This means that unsaturated lactone compound possesses two sites in the molecule, namely an unsaturated carbon-carbon bond and ester moiety, which can induce polymerization. Because of this property, it can form a solid coat of network structure on the surface of the positive electrode by polymerization reaction and can prevent the positive electrode active material from contacting the electrolyte solution. It is true that lactone compound without an unsaturated carbon-carbon bond can form a coat on the positive electrode. However, the structure of the coat is one-dimensional, which is not stable, and it is occasionally inadequate to guarantee excellent battery characteristics under the high voltage condition.

In addition, unsaturated lactone compound possessing an unsaturated carbon-carbon bond is easily reduced, as well as easily oxidized and, therefore, reacts also at the negative electrode. Namely, it is partly reduced at the initial stage of charge and forms a protective coat on the negative electrode and suppresses the reaction of the non-aqueous electrolyte solution at the negative electrode. In case a coat-forming material such as unsaturated carbonate compound is added, the reduction products of both compounds form a protective coat, leading to improvement in battery characteristics such as cycle characteristics and storage characteristics.

Namely, unsaturated lactone compound forms a stabler coat on the positive electrode more easily than other lactone compound, and it also forms a protective coat on the negative electrode. This is instrumental in making higher a terminal-to-terminal open circuit voltage at the end of charge of a lithium secondary battery of the present invention and also in suppressing evolved gas on continuous charge and in improving retention capacity.

[III-3-4. Suggested Mechanism when the Non-Aqueous Electrolyte Solution Contains Sulfonate Compound of the Present Invention]

Development of a lithium secondary battery has been desired, which has a high terminal-to-terminal open circuit voltage at the end of charge. According to previous technologies, under the condition of high voltage of 4.25 V or higher, oxidation reaction of the electrolyte solution mainly at the positive electrode was very extensive, resulting in deterioration of cycle characteristics, and the lithium secondary battery fell short of practical use.

On the other hand, in the lithium secondary battery of the present invention, the sulfonate compound of the present invention forms a protective coat on the positive electrode and suppresses oxidation reaction of the non-aqueous electrolyte solution, making possible the lithium secondary battery with less deterioration and superior cycle characteristics, storage characteristics and continuous charge characteristics.

As described above, the sulfonate compound of the present invention forms a protective coat at the positive electrode. The protective coat in this case includes not only a coat observed as such, but also a coat formed by chemical adsorption on the molecular level. Namely, the sulfonate compound of the present invention functions as an acid, covers basic sites of the positive electrode active material and is capable of suppressing decarboxylation reaction of the main solvent. This is thought to be instrumental in suppressing evolution of gas such as carbon dioxide.

Therefore, in case gas is evolved, liquid draining occurs at the electrode, with resistance increasing, and charge/discharge cycle characteristics of a lithium secondary battery deteriorates. In a lithium secondary battery of the present invention, the sulfonate compound of the present invention remains adsorbed securely under the high voltage condition of 4.25 V or higher and this is thought to bring about improvement in charge/discharge cycle characteristics.

Furthermore, the sulfonate compound of the present invention is liable to undergo reduction relatively easily and, therefore, is reduced partly at the negative electrode on initial charge of a lithium secondary battery of the present invention. The decomposition products formed are transferred to the positive electrode and undergo oxidation, forming a coat which is stable even under the high voltage condition of 4.25 V or higher. Accordingly, it is inferred that the subsequent decomposition of the main component solvent is suppressed by this coat, therefore in a lithium secondary battery of the present invention, leading to a decrease in evolved gas under the condition of continuous charge and a decrease in capacity deterioration under the charge/discharge cycle.

### EXAMPLES

The present invention will be explained in further detail below by referring to Examples, Comparative examples and Reference examples. It is to be understood that the present invention is not limited to these Examples, Comparative examples and Reference examples and any modification can be added thereto, insofar as it does not depart from the scope of the present invention.

<Explanation of Processes>

[Production of a Positive Electrode]

To a mixture of 92 weight parts of lithium cobaltic acid (LiCoO₂) as positive electrode active material, 4 weight parts of polyfluorovinylidene (hereinafter referred to as {PVdF} as appropriate) and 4 weight parts of acetylene black was added N-methylpyrrolidone, to make a slurry. This slurry was applied onto both sides of a current collector formed from aluminium and then dried to obtain the positive electrode.

[Production of a Negative Electrode]

To a mixture of 90 weight parts of graphite powder as negative electrode active material, and 10 weight parts of PVdF was added N-methylpyrrolidone to make a slurry. This slurry was applied onto both sides of a current collector formed from copper and then dried to obtain the negative electrode.

[Production of Lithium Secondary Battery]

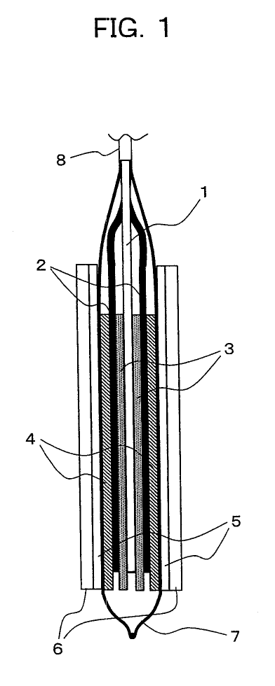

FIG. 1 shows a schematic cross-sectional view of a lithium secondary battery prepared in Examples, Comparative examples and Reference examples.

The above positive electrode, negative electrode and polyethylene-made biaxial stretched porous film (separator or spacer), with a film thickness of 16 μm, porosity of 45% and mean pore diameter of 0.05 μm, were coated and impregnated individually with an electrolyte solution to be described later. The negative electrode (2), separator (3), positive electrode (1), separator (3) and negative electrode (2) were layered in this order to make a battery element. The battery element thus obtained was sandwiched between polyethylene terephthalate (PET) films (4). The battery element was then covered with a laminated film (7) consisting of an aluminium foil on both sides of which was formed a resin layer, with the terminals of the positive electrode and negative electrode being allowed to protrude from the film, followed by vacuum sealing, to prepare a sheet-type lithium secondary battery. The terminals of the positive electrode and negative electrode were fitted with a lead (8) containing a sealing agent. Further, in order to secure tightness between the electrodes, the sheet-type battery was sandwiched by silicon rubber (5) and glass plate (6) and compressed at a pressure of 3.4×10⁻⁴ Pa.

[Capacity Evaluation]

Discharge capacity of cobaltic acid lithium was set at 160 mAh/g per hour and discharge rate 1 C was calculated from this value and the amount of active material of the positive electrode of the lithium secondary battery to be evaluated, which were rate setting. The lithium secondary battery was placed in a thermostat bath which was maintained at 25° C. and subjected to 0.2 C constant current and constant voltage charge (hereinafter referred to as “CCCV charge” as appropriate) until it reached 4.4 V. It was then discharged with a 0.2 C constant current until it reached 3 V for initial formation. The battery was again subjected to 0.7 C CCCV charge until it reached 4.4 V, followed by 0.2 C discharge again until it reached 3 V, and initial discharge capacity was calculated. All the cut-off current on charge was set at 0.05 C.

[Evaluation of Continuous Charge Characteristics at 4.35 V]

The lithium secondary battery to be evaluated, for which capacity evaluation test had been completed, was placed in a thermostat bath which was maintained at 60° C. and charged with a 0.7 C constant current until it reached 4.35 V. Then, the battery was charged under constant voltage for 7 days and, after it was cooled to 25° C., a terminal-to-terminal open circuit voltage was measured. Thereafter, the battery was submerged in ethanol in an ethanol bath and buoyant force was measured according to Archimedes' principle. The amount of gas evolved was calculated from the buoyant force. Further, in order to evaluate the extent of capacity deterioration after continuous charge, the battery was discharged with a 0.2 C constant current until it reached 3 V and then charged with a 0.7 C constant current until it reached 4.4 V, followed by discharge with a 0.2 C constant current until it reached 3 V and then discharge capacity {retention capacity (mAh)} was measured. Retention capacity retention rate after continuous charge was calculated according to the following calculation formula. The larger value of this rate means less deterioration of the battery.

Retention capacity retention rate after 7 days of continuous charge(%)=(retention capacity after 7 days of continuous charge/initial discharge capacity)×100 [Mathematical Formula 1]

[Evaluation of Continuous Charge Characteristics at 4.45 V]

The lithium secondary battery to be evaluated, for which capacity evaluation test had been completed, was placed in a thermostat bath which was maintained at 60° C. and charged with a 0.7 C constant current until it reached 4.45 V. Then, the battery was charged under constant voltage for 7 days and, after it was cooled to 25° C., a terminal-to-terminal open circuit voltage was measured. Thereafter, the battery was submerged in ethanol in an ethanol bath and buoyant force was measured according to Archimedes' principle. The amount of gas evolved was calculated from the buoyant force.

[Evaluation of Cycle Characteristics at 4.4 V]

The lithium secondary battery to be evaluated, for which capacity evaluation test had been completed, was placed in a thermostat bath which was maintained at 25° C. and subjected to 0.7 C CCCV charge until it reached 4.4 V (cut-off current was set at 0.05 C). The battery was then discharged with a 1 C constant current until it reached 3 V. This charge/discharge cycle was repeated 50 times. Capacity retention rate after 50 cycles was calculated according to the following calculation formula. The terminal-to-terminal open circuit voltage was also determined at the end of the first charge.

Capacity retention rate after 50 cycles(%)={50^{th} discharge capacity(mAh/g)/1^{st} discharge capacity(mAh/g)}×100 [Mathematical Formula 2]

[Evaluation of Cycle Characteristics at 4.2 V]

The lithium secondary battery to be evaluated, for which capacity evaluation test had been completed, was placed in a thermostat bath which was maintained at 25° C. and subjected to 0.7 C CCCV charge until it reached 4.2 V (cut-off current was set at 0.05 C). The battery was then discharged with a 1 C constant current until it reached 3 V. This charge/discharge cycle was repeated 200 times. However, rate setting in this case is as follows. Discharge capacity of cobaltic acid lithium was set at 140 mAh/g per hour and discharge rate 1 C was calculated from this value and the amount of active material of the positive electrode of the lithium secondary battery to be evaluated. Capacity retention rate after 200 cycles was calculated according to the following calculation formula. The terminal-to-terminal open circuit voltage was also determined at the end of the first charge.

Capacity retention rate after 200 cycles(%)={200^{th} discharge capacity(mAh/g)/1^{st} discharge capacity(mAh/g)}×100 [Mathematical Formula 3]

### 1. Examples and Comparative Examples of Lithium Secondary Battery Comprising Non-Aqueous Electrolyte Solution Containing Both Vinylethylene Carbonate Compound and Vinylene Carbonate Compound

### Example 1-1

A base electrolyte solution (1-I) was prepared by dissolving an electrolyte LiPF₆ at a concentration of 1 mol/L in a mixed solvent (volume ratio 1:3) of ethylene carbonate (EC) as a cyclic carbonate, and ethylmethyl carbonate (EMC) as a chain carbonate. To this base electrolyte solution (1-I) were added vinylethylene carbonate as vinylethylene carbonate compound and vinylene carbonate as vinylene carbonate compound so that the former represented 2 weight % and the latter also represented 2 weight % of the non-aqueous electrolyte solution, thus a non-aqueous electrolyte solution being obtained.

A lithium secondary battery was prepared by the method described previously using the non-aqueous electrolyte solution obtained, and 4.4 V cycle characteristics were evaluated. The results are shown in Table 1-1. In the Table 1-1, the numerical values shown in parentheses for the columns of vinylethylene carbonate compound, vinylene carbonate compound, and electrolyte and non-aqueous solvent indicate composition of each in the non-aqueous electrolyte solution, and numerical values in parentheses for the column of non-aqueous solvent indicate mixing ratio of non-aqueous solvents.

### Example 1-2

To the base electrolyte solution (1-I) were added vinylethylene carbonate as vinylethylene carbonate compound and vinylene carbonate as vinylene carbonate compound so that the former represented 0.5 weight % and the latter represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Example 1-3

To the base electrolyte solution (1-I) were added vinylethylene carbonate as vinylethylene carbonate compound and vinylene carbonate as vinylene carbonate compound so that the former represented 1 weight % and the latter represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Example 1-4

To the base electrolyte solution (1-I) were added vinylethylene carbonate as vinylethylene carbonate compound and vinylene carbonate as vinylene carbonate compound so that the former represented 3 weight % and the latter represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Example 1-5

To the base electrolyte solution (1-I) were added vinylethylene carbonate as vinylethylene carbonate compound and vinylene carbonate as vinylene carbonate compound so that the former represented 5 weight % and the latter represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Example 1-6

To the base electrolyte solution (1-I) were added vinylethylene carbonate as vinylethylene carbonate compound and vinylene carbonate as vinylene carbonate compound so that the former represented 1 weight % and the latter represented 3 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Example 1-7

To the base electrolyte solution (1-I) were added vinylethylene carbonate as vinylethylene carbonate compound and vinylene carbonate as vinylene carbonate compound so that the former represented 1 weight % and the latter represented 5 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Example 1-8

To the base electrolyte solution (1-I) were added 1,2-divinylethylene carbonate as vinylethylene carbonate compound and vinylene carbonate as vinylene carbonate compound so that the former represented 1 weight % and the latter represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Example 1-9

To the base electrolyte solution (1-I) were added 1-methyl-1-vinylethylene carbonate as vinylethylene carbonate compound and vinylene carbonate as vinylene carbonate compound so that the former represented 1 weight % and the latter represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Example 1-10

To the base electrolyte solution (1-I) were added vinylethylene carbonate as vinylethylene carbonate compound and 1,2-dimethylvinylene carbonate as vinylene carbonate compound so that the former represented 1 weight % and the latter represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Example 1-11

A base electrolyte solution (1-II) was prepared by dissolving an electrolyte LiPF₆ at a concentration of 1.25 mol/L in a mixed solvent (volume ratio 1:1:1) of ethylene carbonate (EC) as a cyclic carbonate, ethylmethyl carbonate (EMC) as a chain carbonate and diethylcarbonate (DEC) as a chain carbonate. To this base electrolyte solution (1-II) were added vinylethylene carbonate, which is a cyclic carbonate having an unconjugated unsaturated bond outside the ring, as vinylethylene carbonate compound and vinylene carbonate as vinylene carbonate compound so that the former represented 1 weight % and the latter also represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Comparative Example 1-1

A lithium secondary battery was prepared by the method described previously using the base electrolyte solution (1-I) itself, and 4.4 V cycle characteristics were evaluated. The results are shown in Table 1-1.

### Comparative Example 1-2

To the base electrolyte solution (1-I) was added vinylethylene carbonate as vinylethylene carbonate compound so that it represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

### Comparative Example 1-3

To the base electrolyte solution (1-I) was added vinylene carbonate as vinylene carbonate compound so that it represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 1-1.

TABLE 1-1

| | Composition of electrolyte solution | | | | cycle characteristics evaluation | | |
|---|---|---|---|---|---|---|---|
| | vinyl- | | | | | terminal-to- | |
| | ethylene | vinylene | | | | terminal open | capacity |
| | carbonate | carbonate | | non-aqueous | | circuit voltage | retention rate |
| | compound | compound | Electrolyte | solvent | cycle test | at the first | after cycle |
| | (weight %) | (weight %) | (M) | (mixing ratio) | condition | cycle (V) | test (%) |
| Example | vinyl- | vinylene | LiPF₆ | EC + EMC | 50 times | 4.39 | 96.5 |
| 1-1 | ethylene | carbonate | (1) | (1:3) | at 4.4 V | | |
| | carbonate | (2) | | | | | |
| | (2) | | | | | | |
| Example | vinyl- | vinylene | LiPF₆ | EC + EMC | 50 times | 4.40 | 95.7 |
| 1-2 | ethylene | carbonate | (1) | (1:3) | at 4.4 V | | |
| | carbonate | (1) | | | | | |
| | (0.5) | | | | | | |
| Example | vinyl- | vinylene | LiPF₆ | EC + EMC | 50 times | 4.40 | 96.1 |
| 1-3 | ethylene | carbonate | (1) | (1:3) | at 4.4 V | | |
| | carbonate | (1) | | | | | |
| | (1) | | | | | | |
| Example | vinyl- | vinylene | LiPF₆ | EC + EMC | 50 times | 4.39 | 95.4 |
| 1-4 | ethylene | carbonate | (1) | (1:3) | at 4.4 V | | |
| | carbonate | (1) | | | | | |
| | (3) | | | | | | |
| Example | vinyl- | vinylene | LiPF₆ | EC + EMC | 50 times | 4.38 | 93.7 |
| 1-5 | ethylene | carbonate | (1) | (1:3) | at 4.4 V | | |
| | carbonate | (1) | | | | | |
| | (5) | | | | | | |
| Example | vinyl- | vinylene | LiPF₆ | EC + EMC | 50 times | 4.39 | 96.0 |
| 1-6 | ethylene | carbonate | (1) | (1:3) | at 4.4 V | | |
| | carbonate | (3) | | | | | |
| | (1) | | | | | | |
| Example | vinyl- | vinylene | LiPF₆ | EC + EMC | 50 times | 4.39 | 94.1 |
| 1-7 | ethylene | carbonate | (1) | (1:3) | at 4.4 V | | |
| | carbonate | (5) | | | | | |
| | (1) | | | | | | |
| Example | 1,2- | vinylene | LiPF₆ | EC + EMC | 50 times | 4.40 | 94.8 |
| 1-8 | divinyl- | carbonate | (1) | (1:3) | at 4.4 V | | |
| | ethylene | (1) | | | | | |
| | carbonate | | | | | | |
| | (1) | | | | | | |
| Example | 1-methyl- | vinylene | LiPF₆ | EC + EMC | 50 times | 4.40 | 94.5 |
| 1-9 | 1-vinyl- | carbonate | (1) | (1:3) | at 4.4 V | | |
| | ethylene | (1) | | | | | |
| | carbonate | | | | | | |
| | (1) | | | | | | |
| Example | vinyl- | 1,2- | LiPF₆ | EC + EMC | 50 times | 4.40 | 93.8 |
| 1-10 | ethylene | dimethyl- | (1) | (1:3) | at 4.4 V | | |
| | carbonate | vinylene | | | | | |
| | (1) | carbonate | | | | | |
| | | (1) | | | | | |
| Example | vinyl- | vinylene | LiPF₆ | EC + EMC + | 50 times | 4.40 | 96.0 |
| 1-11 | ethylene | carbonate | (1.25) | DEC | at 4.4 V | | |
| | carbonate | (1) | | (1:1:1) | | | |
| | (1) | | | | | | |
| Comparative | None | None | LiPF₆ | EC + EMC | 50 times | 4.40 | 87.6 |
| example 1-1 | | | (1) | (1:3) | at 4.4 V | | |
| Comparative | vinyl- | None | LiPF₆ | EC + EMC | 50 times | 4.40 | 88.3 |
| example 1-2 | ethylene | | (1) | (1:3) | at 4.4 V | | |
| | carbonate | | | | | | |
| | (2) | | | | | | |
| Comparative | None | vinylene | LiPF₆ | EC + EMC | 50 times | 4.40 | 92.5 |
| example 1-3 | | carbonate | (1) | (1:3) | at 4.4 V | | |
| | | (2) | | | | | |

[Summary]

From Table 1-1, it is evident that the non-aqueous electrolyte solution of Example 1-1 to Example 1-11, which contains both vinylethylene carbonate compound and vinylene carbonate compound of the present invention, has a large capacity retention rate after cycle tests and can achieve excellent cycle characteristics, in comparison with the non-aqueous electrolyte solution which contains neither vinylethylene carbonate compound nor vinylene carbonate compound (Comparative example 1-1) or non-aqueous electrolyte solution which contains either one of these compounds (Comparative example 1-2, 1-3).

### 2. Examples and Comparative Examples of Lithium Secondary Battery Comprising Non-Aqueous Electrolyte Solution Containing Lactone Compound with a Substituent at its α Position

### Example 2-1

A base electrolyte solution (2-I) was prepared by dissolving an electrolyte LiPF₆ at a concentration of 1 mol/L in a mixed solvent (capacity ratio 1:3) of ethylene carbonate (EC) as a cyclic carbonate, and ethylmethyl carbonate (EMC) as a chain carbonate. To this base electrolyte solution (2-I) was added lactide as α-substituted lactone compound so that it represented 1 weight % of the non-aqueous electrolyte solution, thus a non-aqueous electrolyte solution being obtained.

A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1. In the Table 2-1, the numerical values shown in parentheses for the columns of the α-substituted lactone compound, the unsaturated carbonate compound and electrolyte indicate composition of each in the non-aqueous electrolyte solution, and numerical values in parentheses for the column of non-aqueous solvent indicate mixing ratio of non-aqueous solvents.

### Example 2-2

To the base electrolyte solution (2-I) was added lactide as α-substituted lactone compound so that it represented 3 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Example 2-3

To the base electrolyte solution (2-I) was added α,α-diphenyl-γ-butyrolactone as α-substituted lactone compound so that it represented 1 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Comparative Example 2-1

A lithium secondary battery was prepared by the method described previously using the base electrolyte solution (2-I) itself, and 4.35 V continuous charge characteristics as well as 4.45 V continuous charge characteristics were evaluated. The results are shown in Table 2-1.

### Comparative Example 2-2

To the base electrolyte solution (2-I) was added lactide as α-substituted lactone compound so that it represented 6 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Example 2-4

To the base electrolyte solution (2-I) was added lactide as α-substituted lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Example 2-5

To the base electrolyte solution (2-I) was added lactide as α-substituted lactone compound and vinylene carbonate as unsaturated carbonate compound so that the former represented 2 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Example 2-6

To the base electrolyte solution (2-I) was added α,α-diphenyl-γ-butyrolactone as α-substituted lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Example 2-7

To the base electrolyte solution (2-I) was added α,α-diphenyl-γ-butyrolactone as α-substituted lactone compound and vinylene carbonate as unsaturated carbonate compound so that the former represented 2 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Example 2-8

A base electrolyte solution (2-II) was prepared by dissolving an electrolyte LiPF₆ at a concentration of 1 mol/L in a mixed solvent (capacity ratio 1:1:1) of ethylene carbonate (EC) as a cyclic carbonate, ethylmethyl carbonate (EMC) as a chain carbonate and diethylcarbonate (DEC) as a chain carbonate. To this base electrolyte solution (2-II) were added α,α-diphenyl-γ-butyrolactone as α-substituted lactone compound and vinylene carbonate as unsaturated carbonate compound so that the former represented 1 weight % and the latter also represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Example 2-9

To the base electrolyte solution (2-I) were added α-methyl-γ-butyrolactone as α-substituted lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Comparative Example 2-3

To the base electrolyte solution (2-I) was added vinylene carbonate as unsaturated carbonate compound so that it represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Comparative Example 2-4

To the base electrolyte solution (2-I) were added γ-butyrolactone in place of α-substituted lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 2-1.

### Example 2-10

To the base electrolyte solution (2-I) was added lactide as α-substituted lactone compound so that it represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 2-2. In the Table 2-2, the numerical values shown in parentheses for the columns of the α-substituted lactone compound, the unsaturated carbonate compound and electrolyte indicate composition of each in the non-aqueous electrolyte solution, and numerical values in parentheses for the column of non-aqueous solvent indicate mixing ratio of non-aqueous solvents.

### Example 2-11

To the base electrolyte solution (2-I) was added lactide as α-substituted lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 2-2.

### Example 2-12

To the base electrolyte solution (2-I) was added lactide as α-substituted lactone compound and vinylene carbonate as unsaturated carbonate compound so that the former represented 2 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 2-2.

### Example 2-13

To the base electrolyte solution (2-I) was added lactide as α-substituted lactone compound and vinylene carbonate as unsaturated carbonate compound so that the former represented 3 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 2-2.

### Example 2-14

To the base electrolyte solution (2-I) was added α,α-diphenyl-γ-butyrolactone as α-substituted lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 2-2.

### Comparative Example 2-5

A lithium secondary battery was prepared by the method described previously using the base electrolyte solution (2-I) itself as non-aqueous electrolyte solution, and 4.4 V cycle characteristics were evaluated. The results are shown in Table 2-2.

TABLE 2-1

| | | | | | 4.35 V continuous charge | | | 4.45 V continuous charge | |
|---|---|---|---|---|---|---|---|---|---|
| | Composition of electrolyte solution | | | | characteristics evaluation | | | characteristics evaluation | |
| | α-substituted | unsaturated | | | terminal-to- | | retention | terminal-to- | |
| | lactone | carbonate | | non-aqueous | terminal open | amount of | capacity | terminal open | amount of |
| | compound | compound | Electrolyte | solvent | circuit voltage | evolved gas | retention | circuit voltage | evolved gas |
| | (weight %) | (weight %) | (M) | (mixing ratio) | (V) | (ml) | rate (%) | (V) | (ml) |
| Example | lactide | None | LiPF₆ | EC + EMC | 4.35 | 0.38 | 53.1 | 4.44 | 0.72 |
| 2-1 | (1) | | (1) | (1:3) | | | | | |
| Example | lactide | None | LiPF₆ | EC + EMC | 4.34 | 0.42 | 50.7 | 4.44 | 0.83 |
| 2-2 | (3) | | (1) | (1:3) | | | | | |
| Example | α,α- | None | LiPF₆ | EC + EMC | 4.35 | 0.41 | 54.1 | 4.44 | 0.77 |
| 2-3 | diphenyl-γ- | | (1) | (1:3) | | | | | |
| | butyrolactone | | | | | | | | |
| | (1) | | | | | | | | |
| Comparative | None | None | LiPF₆ | EC + EMC | 4.35 | 0.72 | 53.7 | 4.45 | 1.38 |
| example 2-1 | | | (1) | (1:3) | | | | | |
| Comparative | lactide | None | LiPF₆ | EC + EMC | 4.34 | 0.80 | 30.2 | 4.44 | 1.56 |
| example 2-2 | (6) | | (1) | (1:3) | | | | | |
| Example | lactide | vinylene | LiPF₆ | EC + EMC | 4.35 | 1.20 | 55.7 | 4.44 | 2.05 |
| 2-4 | (1) | carbonate | (1) | (1:3) | | | | | |
| | | (2) | | | | | | | |
| Example | lactide | vinylene | LiPF₆ | EC + EMC | 4.34 | 0.89 | 55.9 | 4.44 | 2.29 |
| 2-5 | (2) | carbonate | (1) | (1:3) | | | | | |
| | | (2) | | | | | | | |
| Example | α,α- | vinylene | LiPF₆ | EC + EMC | 4.35 | 1.22 | 62.8 | 4.44 | 2.47 |
| 2-6 | diphenyl-γ- | carbonate | (1) | (1:3) | | | | | |
| | butyrolactone | (2) | | | | | | | |
| | (1) | | | | | | | | |
| Example | α,α- | vinylene | LiPF₆ | EC + EMC | 4.34 | 1.25 | 60.9 | 4.44 | 2.05 |
| 2-7 | diphenyl-γ- | carbonate | (1) | (1:3) | | | | | |
| | butyrolactone | (2) | | | | | | | |
| | (2) | | | | | | | | |
| Example | α,α- | vinylene | LiPF₆ | EC + EMC + | 4.35 | 1.09 | 60.2 | 4.44 | 1.98 |
| 2-8 | diphenyl-γ- | carbonate | (1) | DEC | | | | | |
| | butyrolactone | (2) | | (1:1:1) | | | | | |
| | (1) | | | | | | | | |
| Example | α- | vinylene | LiPF₆ | EC + EMC | 4.35 | 1.46 | 56.3 | 4.44 | 2.52 |
| 2-9 | methyl-γ- | carbonate | (1) | (1:3) | | | | | |
| | butyrolactone | (2) | | | | | | | |
| | (1) | | | | | | | | |
| Comparative | None | vinylene | LiPF₆ | EC + EMC | 4.34 | 1.67 | 55.7 | 4.44 | 5.01 |
| example 2-3 | | carbonate | (1) | (1:3) | | | | | |
| | | (2) | | | | | | | |
| Comparative | γ- | vinylene | LiPF₆ | EC + EMC | 4.34 | 1.62 | 52.9 | 4.44 | 3.01 |
| example 2-4 | butyrolactone | carbonate | (1) | (1:3) | | | | | |
| | (1) | (2) | | | | | | | |

TABLE 2-2

| | | | | | cycle characteristics evaluation | | |
|---|---|---|---|---|---|---|---|
| | Composition of electrolyte solution | | | | | terminal-to- | |
| | α-substituted | unsaturated | | | | terminal open | capacity |
| | lactone | carbonate | | non-aqueous | | circuit voltage | retention rate |
| | compound | compound | Electrolyte | solvent | cycle test | at the first | after cycle |
| | (weight %) | (weight %) | (M) | (mixing ratio) | condition | cycle time (V) | test (%) |
| Example | lactide | None | LiPF₆ | EC + EMC | 50 times | 4.40 | 89.5 |
| 2-10 | (1) | | (1) | (1:3) | at 4.4 V | | |
| Example | lactide | vinylene | LiPF₆ | EC + EMC | 50 times | 4.40 | 93.5 |
| 2-11 | (1) | carbonate | (1) | (1:3) | at 4.4 V | | |
| | | (2) | | | | | |
| Example | lactide | vinylene | LiPF₆ | EC + EMC | 50 times | 4.39 | 93.3 |
| 2-12 | (2) | carbonate | (1) | (1:3) | at 4.4 V | | |
| | | (2) | | | | | |
| Example | lactide | vinylene | LiPF₆ | EC + EMC | 50 times | 4.39 | 92.8 |
| 2-13 | (3) | carbonate | (1) | (1:3) | at 4.4 V | | |
| | | (2) | | | | | |
| Example | α,α- | vinylene | LiPF₆ | EC + EMC | 50 times | 4.40 | 93.3 |
| 2-14 | diphenyl-γ- | carbonate | (1) | (1:3) | at 4.4 V | | |
| | butyrolactone | (1) | | | | | |
| | (1) | | | | | | |
| Comparative | None | None | LiPF₆ | EC + EMC | 50 times | 4.40 | 87.6 |
| example 2-5 | | | (1) | (1:3) | at 4.4 V | | |

From Table 2-1, it is evident that, by including the α-substituted lactone compound at the predetermined concentration in the non-aqueous electrolyte solution, it is possible to reduce the amount of gas evolved on continuous charge characteristics test when charge was done up to a high terminal-to-terminal open circuit voltage such as 4.35 V and 4.45 V, and to improve the retention capacity retention rate at 4.35 V. It was also evident that, by using the non-aqueous electrolyte solution containing unsaturated carbonate compound in particular, it is possible to achieve both reduction in evolved gas and improvement in retention capacity at a high level.

Furthermore, from Table 2-2, it was found possible, by including the α-substituted lactone compound in the non-aqueous electrolyte solution, to achieve improvement in capacity retention rate at a high voltage cycle test such as 4.4 V.

### 3. Examples and Comparative Examples of Lithium Secondary Battery Comprising Non-Aqueous Electrolyte Solution Containing Lactone Compound Having an Unsaturated Carbon-Carbon Bond

### Example 3-1

A base electrolyte solution (3-I) was prepared by dissolving an electrolyte LiPF₆ at a concentration of 1 mol/L in a mixed solvent (capacity ratio 1:3) of ethylene carbonate (EC) as a cyclic carbonate, and ethylmethyl carbonate (EMC) as a chain carbonate. To this base electrolyte solution (3-I) was added 3-methyl-2(5H)-furanone as unsaturated lactone compound so that it represented 1 weight % of the non-aqueous electrolyte solution, thus a non-aqueous electrolyte solution being obtained.

A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1. In the Table 3-1, the numerical values shown in parentheses for the columns of the unsaturated lactone compound, the unsaturated carbonate compound and electrolyte indicate composition of each in the non-aqueous electrolyte solution, and numerical values in parentheses for the column of non-aqueous solvent indicate mixing ratio of non-aqueous solvents.

### Example 3-2

To the base electrolyte solution (3-I) was added α-methylene-γ-butyrolactone as unsaturated lactone compound so that it represented 1 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Example 3-3

To the base electrolyte solution (3-I) was added α-methylene-γ-butyrolactone as unsaturated lactone compound so that it represented 3 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Comparative Example 3-1

A lithium secondary battery was prepared by the method described previously using the base electrolyte solution (3-I) itself, and 4.35 V continuous charge characteristics as well as 4.45 V continuous charge characteristics were evaluated. The results are shown in Table 3-1.

### Comparative Example 3-2

To the base electrolyte solution (3-I) was added α-methylene-γ-butyrolactone as unsaturated lactone compound so that it represented 6 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Example 3-4

To the base electrolyte solution (3-I) was added 3-methyl-2(5H)-furanone as unsaturated lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Example 3-5

To the base electrolyte solution (3-I) was added α-methylene-γ-butyrolactone as unsaturated lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Example 3-6

To the base electrolyte solution (3-I) was added α-angelica lactone as unsaturated lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Example 3-7

To the base electrolyte solution (3-I) was added 4,6-dimethyl-α-pyrone as unsaturated lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Example 3-8

To the base electrolyte solution (3-I) was added 5,6-dihydro-2H-pyran-2-one as unsaturated lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Example 3-9

A base electrolyte solution (3-II) was prepared by dissolving an electrolyte LiPF₆ at a concentration of 1 mol/L in a mixed solvent (volume ratio 1:1:1) of ethylene carbonate (EC) as a cyclic carbonate, ethylmethyl carbonate (EMC) as a chain carbonate and diethylcarbonate (DEC) as a chain carbonate. To this base electrolyte solution (3-II) were added 3-methyl-2(5H)-furanone as unsaturated lactone compound and vinylene carbonate as unsaturated carbonate compound so that the former represented 1 weight % and the latter also represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Comparative Example 3-3

To the base electrolyte solution (3-I) was added vinylene carbonate as unsaturated carbonate compound so that it represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Comparative Example 3-4

To the base electrolyte solution (3-I) were added γ-butyrolactone in place of unsaturated lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 3-1.

### Example 3-10

To the base electrolyte solution (3-I) was added 3-methyl-2(5H)-furanone as unsaturated lactone compound so that it represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 3-2. In the Table 3-2, the numerical values shown in parentheses for the columns of the unsaturated lactone compound, the unsaturated carbonate compound and electrolyte indicate composition of each in the non-aqueous electrolyte solution, and numerical values in parentheses for the column of non-aqueous solvent indicate mixing ratio of non-aqueous solvents.

### Example 3-11

To the base electrolyte solution (3-I) was added 5,6-dihydro-2H-pyran-2-one as unsaturated lactone compound and vinylene carbonate as unsaturated carbonate compound so that the former represented 0.5 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 3-2.

### Example 3-12

To the base electrolyte solution (3-I) was added 5,6-dihydro-2H-pyran-2-one as unsaturated lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 3-2.

### Example 3-13

To the base electrolyte solution (3-I) was added 5,6-dihydro-2H-pyran-2-one as unsaturated lactone compound and vinylene carbonate as unsaturated carbonate compound so that the former represented 2 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 3-2.

### Example 3-14

To the base electrolyte solution (3-I) was added 3-methyl-2(5H)-furanone as unsaturated lactone compound and vinylene carbonate as unsaturated carbonate compound so that the former represented 0.5 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 3-2.

### Example 3-15

To the base electrolyte solution (3-I) was added α-angelica lactone as unsaturated lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 3-2.

### Example 3-16

To the base electrolyte solution (3-I) was added α-methylene-γ-butyrolactone as unsaturated lactone compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 3-2.

### Comparative Example 3-5

A lithium secondary battery was prepared by the method described previously using the base electrolyte solution (3-I) itself as non-aqueous electrolyte solution, and 4.4 V cycle characteristics were evaluated. The results are shown in Table 3-2.

TABLE 3-1

| | | | | | 4.35 V continuous charge | | | 4.45 V continuous charge | |
|---|---|---|---|---|---|---|---|---|---|
| | Composition of electrolyte solution | | | | characteristics evaluation | | | characteristics evaluation | |
| | Unsaturated | unsaturated | | | terminal-to- | | retention | terminal-to- | |
| | lactone | carbonate | | non-aqueous | terminal open | amount of | capacity | terminal open | amount of |
| | compound | compound | Electrolyte | solvent | circuit voltage | evolved gas | retention | circuit voltage | evolved gas |
| | (weight %) | (weight %) | (M) | (mixing ratio) | (V) | (ml) | rate (%) | (V) | (ml) |
| Example | 3-methyl- | None | LiPF₆ | EC + EMC | 4.35 | 0.52 | 59.0 | 4.44 | 1.03 |
| 3-1 | 2(5H)- | | (1) | (1:3) | | | | | |
| | furanone | | | | | | | | |
| | (1) | | | | | | | | |
| Example | α- | None | LiPF₆ | EC + EMC | 4.35 | 0.54 | 57.9 | 4.44 | 0.86 |
| 3-2 | methylene-γ- | | (1) | (1:3) | | | | | |
| | butyrolactone | | | | | | | | |
| | (1) | | | | | | | | |
| Example | α- | None | LiPF₆ | EC + EMC | 4.34 | 0.56 | 53.3 | 4.44 | 0.79 |
| 3-3 | methylene-γ- | | (1) | (1:3) | | | | | |
| | butyrolactone | | | | | | | | |
| | (3) | | | | | | | | |
| Comparative | None | None | LiPF₆ | EC + EMC | 4.35 | 0.72 | 53.7 | 4.45 | 1.38 |
| example 3-1 | | | (1) | (1:3) | | | | | |
| Comparative | α- | None | LiPF₆ | EC + EMC | 4.34 | 0.83 | 35.6 | 4.44 | 1.46 |
| example 3-2 | methylene-γ- | | (1) | (1:3) | | | | | |
| | butyrolactone | | | | | | | | |
| | (6) | | | | | | | | |
| Example | 3-methyl- | vinylene | LiPF₆ | EC + EMC | 4.35 | 0.97 | 56.9 | 4.44 | 1.89 |
| 3-4 | 2(5H)- | carbonate | (1) | (1:3) | | | | | |
| | furanone | (2) | | | | | | | |
| | (1) | | | | | | | | |
| Example | α- | vinylene | LiPF₆ | EC + EMC | 4.34 | 1.30 | 57.5 | 4.44 | 2.13 |
| 3-5 | methylene-γ- | carbonate | (1) | (1:3) | | | | | |
| | butyrolactone | (2) | | | | | | | |
| | (1) | | | | | | | | |
| Example | α-angelica | vinylene | LiPF₆ | EC + EMC | 4.35 | 1.30 | 56.0 | 4.44 | 2.40 |
| 3-6 | lactone | carbonate | (1) | (1:3) | | | | | |
| | (1) | (2) | | | | | | | |
| Example | 4,6- | vinylene | LiPF₆ | EC + EMC | 4.35 | 1.34 | 59.6 | 4.44 | 2.15 |
| 3-7 | dimethyl- | carbonate | (1) | (1:3) | | | | | |
| | α-pyrone | (2) | | | | | | | |
| | (1) | | | | | | | | |
| Example | 5,6- | vinylene | LiPF₆ | EC + EMC | 4.35 | 1.27 | 61.7 | 4.44 | 2.04 |
| 3-8 | dihydro- | carbonate | (1) | (1:3) | | | | | |
| | 2H-pyran- | (2) | | | | | | | |
| | 2-one (1) | | | | | | | | |
| Example | 3-methyl- | vinylene | LiPF₆ | EC + EMC + | 4.35 | 0.93 | 61.2 | 4.44 | 1.82 |
| 3-9 | 2(5H)- | carbonate | (1) | DEC | | | | | |
| | furanone | (2) | | (1:1:1) | | | | | |
| | (1) | | | | | | | | |
| Comparative | None | vinylene | LiPF₆ | EC + EMC | 4.34 | 1.67 | 55.7 | 4.44 | 5.01 |
| example 3-3 | | carbonate | (1) | (1:3) | | | | | |
| | | (2) | | | | | | | |
| Comparative | γ- | vinylene | LiPF₆ | EC + EMC | 4.34 | 1.62 | 52.9 | 4.44 | 3.01 |
| example 3-4 | butyrolactone | carbonate | (1) | (1:3) | | | | | |
| | (1) | (2) | | | | | | | |

TABLE 3-2

| | | | | | cycle characteristics evaluation | | |
|---|---|---|---|---|---|---|---|
| | Composition of electrolyte solution | | | | | terminal-to- | |
| | Unsaturated | unsaturated | | | | terminal open | capacity |
| | lactone | carbonate | | non-aqueous | | circuit voltage | retention rate |
| | compound | compound | Electrolyte | solvent | cycle test | at the first | after cycle |
| | (weight %) | (weight %) | (M) | (mixing ratio) | condition | cycle time (V) | test (%) |
| Example | 3-methyl- | None | LiPF₆ | EC + EMC | 50 times | 4.40 | 88.7 |
| 3-10 | 2(5H)- | | (1) | (1:3) | at 4.4 V | | |
| | furanone | | | | | | |
| | (1) | | | | | | |
| Example | 5,6-dihydro- | Vinylene | LiPF₆ | EC + EMC | 50 times | 4.40 | 93.2 |
| 3-11 | 2H-pyran-2- | carbonate | (1) | (1:3) | at 4.4 V | | |
| | one (0.5) | (2) | | | | | |
| Example | 5,6-dihydro- | Vinylene | LiPF₆ | EC + EMC | 50 times | 4.40 | 93.0 |
| 3-12 | 2H-pyran-2- | carbonate | (1) | (1:3) | at 4.4 V | | |
| | one (1) | (2) | | | | | |
| Example | 5,6-dihydro- | Vinylene | LiPF₆ | EC + EMC | 50 times | 4.39 | 92.5 |
| 3-13 | 2H-pyran-2- | carbonate | (1) | (1:3) | at 4.4 V | | |
| | one (2) | (2) | | | | | |
| Example | 3-methyl- | Vinylene | LiPF₆ | EC + EMC | 50 times | 4.40 | 92.9 |
| 3-14 | 2(5H)- | carbonate | (1) | (1:3) | at 4.4 V | | |
| | furanone | (2) | | | | | |
| | (1) | | | | | | |
| Example | α- | Vinylene | LiPF₆ | EC + EMC | 50 times | 4.40 | 92.6 |
| 3-15 | angelica | carbonate | (1) | (1:3) | at 4.4 V | | |
| | lactone | (2) | | | | | |
| | (1) | | | | | | |
| Example | α- | Vinylene | LiPF₆ | EC + EMC | 50 times | 4.40 | 92.5 |
| 3-16 | methylene- | carbonate | (1) | (1:3) | at 4.4 V | | |
| | γ- | (2) | | | | | |
| | butyrolactone | | | | | | |
| | (1) | | | | | | |
| Comparative | None | None | LiPF₆ | EC + EMC | 50 times | 4.40 | 87.6 |
| example 3-5 | | | (1) | (1:3) | at 4.4 V | | |

From Table 3-1, it is evident that, by including the specified unsaturated lactone compound at the predetermined concentration in the non-aqueous electrolyte solution, it is possible to reduce the amount of gas evolved on continuous charge characteristics test when charge was done up to a high terminal-to-terminal open circuit voltage such as 4.35 V and 4.45 V, and to improve the retention capacity retention rate at 4.35 V. It was also evident that, by using the non-aqueous electrolyte solution containing unsaturated carbonate compound in particular, it is possible to achieve both reduction in evolved gas and improvement in retention capacity at a high level.

Furthermore, from Table 3-2, it was found possible, by including the unsaturated lactone compound in the non-aqueous electrolyte solution, to achieve improvement in capacity retention rate at a high voltage cycle test such as 4.4 V.

### 4. Examples, Comparative Examples and Reference Examples of Lithium Secondary Battery Comprising Non-Aqueous Electrolyte Solution Containing Sulfonate Compound of the Present Invention

### Example 4-1

A base electrolyte solution (4-I) was prepared by dissolving an electrolyte LiPF₆ at a concentration of 1 mol/L in a mixed solvent (volume ratio 1:3) of ethylene carbonate (EC) as a cyclic carbonate, and ethylmethyl carbonate (EMC) as a chain carbonate. To this base electrolyte solution (4-I) was added 1,4-butanediol bis(2,2,2-trifluoroethane sulfonate) as sulfonate compound so that it represented 1 weight % of the non-aqueous electrolyte solution, thus a non-aqueous electrolyte solution being obtained.

A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1. In the Table 4-1, the numerical values shown in parentheses for the columns of sulfonate compound, unsaturated carbonate compound and electrolyte indicate composition of each in the non-aqueous electrolyte solution, and numerical values in parentheses for the column of non-aqueous solvent indicate mixing ratio of non-aqueous solvents.

### Example 4-2

To the base electrolyte solution (4-I) was added 1,4-butanediol bis(2,2,2-trifluoroethane sulfonate) as sulfonate compound so that it represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Example 4-3

To the base electrolyte solution (4-I) was added 1,4-butanediol bis(2,2,2-trifluoroethane sulfonate) as sulfonate compound so that it represented 0.5 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Example 4-4

To the base electrolyte solution (4-I) was added 1,4-butanediol dimethanesulfonate as sulfonate compound so that it represented 1 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Example 4-5

To the base electrolyte solution (4-I) was added 1,4-butanediol bis(trifluoromethane sulfonate) as sulfonate compound so that it represented 0.5 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Comparative Example 4-1

A lithium secondary battery was prepared by the method described previously using the base electrolyte solution (4-I) itself, and 4.35 V continuous charge characteristics as well as 4.45 V continuous charge characteristics were evaluated. The results are shown in Table 4-1.

### Example 4-6

To the base electrolyte solution (4-I) was added 1,4-butanediol bis(2,2,2-trifluoroethane sulfonate) as sulfonate compound and vinylene carbonate (VC) as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Example 4-7

To the base electrolyte solution (4-I) was added 1,4-butanediol bis(2,2,2-trifluoroethane sulfonate) as sulfonate compound and vinylene carbonate as unsaturated carbonate compound so that the former represented 2 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Example 4-8

To the base electrolyte solution (4-I) was added 1,4-butanediol bis(2,2,2-trifluoroethane sulfonate) as sulfonate compound and vinylethylene carbonate (VEC) as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Example 4-9

To the base electrolyte solution (4-I) was added 1,4-butanediol dimethanesulfonate as sulfonate compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Example 4-10

To the base electrolyte solution (4-I) was added 1,4-butanediol bis(trifluoromethane sulfonate) as sulfonate compound and vinylene carbonate as unsaturated carbonate compound so that the former represented 0.5 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Example 4-11

A base electrolyte solution (4-II) was prepared by dissolving an electrolyte LiPF₆ at a concentration of 1.25 mol/L in a mixed solvent (volume ratio 1:1:1) of ethylene carbonate (EC) as a cyclic carbonate, ethylmethyl carbonate (EMC) as a chain carbonate and diethylcarbonate (DEC) as a chain carbonate. To this base electrolyte solution (4-II) were added 1,4-butanediol bis(2,2,2-trifluoroethane sulfonate) as sulfonate compound and vinylene carbonate as unsaturated carbonate compound so that the former represented 1 weight % and the latter also represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Comparative Example 4-2

To the base electrolyte solution (4-I) was added vinylene carbonate as unsaturated carbonate compound so that it represented 2 weight % of the non-aqueous electrolyte solution, thus a non-aqueous electrolyte solution being obtained. A lithium secondary battery was prepared by the method described previously using the non-aqueous electrolyte solution obtained, and 4.35 V continuous charge characteristics as well as 4.45 V continuous charge characteristics were evaluated. The results are shown in Table 4-1.

### Example 4-12

To the base electrolyte solution (4-I) was added 1,4-butanediol bis(2,2,2-trifluoroethane sulfonate) as sulfonate compound so that it represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 4-2. In the Table 4-2, the numerical values shown in parentheses for the columns of sulfonate compound, unsaturated carbonate compound and electrolyte indicate composition of each in the non-aqueous electrolyte solution, and numerical values in parentheses for the column of non-aqueous solvent indicate mixing ratio of non-aqueous solvents.

### Example 4-13

To the base electrolyte solution (4-I) was added 1,4-butanediol dimethanesulfonate as sulfonate compound so that it represented 1 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 4-2.

### Comparative Example 4-3

A lithium secondary battery was prepared by the method described previously using the base electrolyte solution (4-I) itself as non-aqueous electrolyte solution, and 4.4 V cycle characteristics were evaluated. The results are shown in Table 4-2.

### Example 4-14

To the base electrolyte solution (4-I) was added 1,4-butanediol bis(2,2,2-trifluoroethane sulfonate) as sulfonate compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 4-2.

### Example 4-15

To the base electrolyte solution (4-I) was added 1,4-butanediol dimethanesulfonate as sulfonate compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 4-2.

### Comparative Example 4-4

To the base electrolyte solution (4-I) was added vinylene carbonate as unsaturated carbonate compound so that it represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 4-2.

### Comparative Example 4-5

To the base electrolyte solution (4-I) were added cyclohexylbenzene in place of sulfonate compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 4-2.

### Reference Example 4-1

To the base electrolyte solution (4-I) was added 1,4-butanediol bis(2,2,2-trifluoroethane sulfonate) as sulfonate compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.4 V cycle characteristics were evaluated. The results are shown in Table 4-2.

### Reference Example 4-2

To the base electrolyte solution (4-I) was added vinylene carbonate as unsaturated carbonate compound so that it represented 2 weight % of the non-aqueous electrolyte solution, thus a non-aqueous electrolyte solution being obtained. A lithium secondary battery was prepared by the method described previously using the non-aqueous electrolyte solution obtained, and 4.2 V cycle characteristics were evaluated. The results are shown in Table 4-2.

### Reference Example 4-3

To the base electrolyte solution (4-I) were added cyclohexylbenzene in place of sulfonate compound and vinylene carbonate as unsaturated carbonate compound so that the former represented 1 weight % and the latter represented 2 weight % of the non-aqueous electrolyte solution, thus a non-aqueous electrolyte solution being obtained. A lithium secondary battery was prepared by the method described previously using the non-aqueous electrolyte solution obtained, and 4.2 V cycle characteristics were evaluated. The results are shown in Table 4-2.

TABLE 4-1

| | | | | | 4.35 V continuous charge | | | 4.45 V continuous charge | |
|---|---|---|---|---|---|---|---|---|---|
| | Composition of electrolyte solution | | | | characteristics evaluation | | | characteristics evaluation | |
| | | unsaturated | | | terminal-to- | | retention | terminal-to- | |
| | Sulfonate | carbonate | | non-aqueous | terminal open | amount of | capacity | terminal open | amount of |
| | compound | compound | Electrolyte | solvent | circuit voltage | evolved gas | retention | circuit voltage | evolved gas |
| | (weight %) | (weight %) | (M) | (mixing ratio) | (V) | (ml) | rate (%) | (V) | (ml) |
| Example | 1,4- | None | LiPF₆ | EC + EMC | 4.35 | 0.42 | 60.3 | 4.44 | 0.76 |
| 4-1 | butanediol | | (1) | (1:3) | | | | | |
| | bis (2,2,2- | | | | | | | | |
| | trifluoroethane | | | | | | | | |
| | sulfonate) | | | | | | | | |
| | (1) | | | | | | | | |
| Example | 1,4- | None | LiPF₆ | EC + EMC | 4.34 | 0.37 | 58.6 | 4.44 | 0.79 |
| 4-2 | butanediol | | (1) | (1:3) | | | | | |
| | bis (2,2,2- | | | | | | | | |
| | trifluoroethane | | | | | | | | |
| | sulfonate) | | | | | | | | |
| | (2) | | | | | | | | |
| Example | 1,4- | None | LiPF₆ | EC + EMC | 4.35 | 0.46 | 59.5 | 4.44 | 0.80 |
| 4-3 | butanediol | | (1) | (1:3) | | | | | |
| | bis (2,2,2- | | | | | | | | |
| | trifluoroethane | | | | | | | | |
| | sulfonate) | | | | | | | | |
| | (0.5) | | | | | | | | |
| Example | 1,4- | None | LiPF₆ | EC + EMC | 4.35 | 0.56 | 57.9 | 4.44 | 1.02 |
| 4-4 | butanediol- | | (1) | (1:3) | | | | | |
| | dimethane- | | | | | | | | |
| | sulfonate | | | | | | | | |
| | (1) | | | | | | | | |
| Example | 1,4- | None | LiPF₆ | EC + EMC | 4.35 | 0.51 | 57.4 | 4.44 | 0.88 |
| 4-5 | butanediol bis | | (1) | (1:3) | | | | | |
| | (trifluoromethane | | | | | | | | |
| | sulfonate) | | | | | | | | |
| | (0.5) | | | | | | | | |
| Comparative | None | None | LiPF₆ | EC + EMC | 4.35 | 0.72 | 53.7 | 4.45 | 1.38 |
| example 4-1 | | | (1) | (1:3) | | | | | |
| Example | 1,4- | vinylene | LiPF₆ | EC + EMC | 4.35 | 0.96 | 60.6 | 4.44 | 1.86 |
| 4-6 | butanediol | carbonate | (1) | (1:3) | | | | | |
| | bis (2,2,2- | (2) | | | | | | | |
| | trifluoroethane | | | | | | | | |
| | sulfonate) | | | | | | | | |
| | (1) | | | | | | | | |
| Example | 1,4- | vinylene | LiPF₆ | EC + EMC | 4.34 | 0.85 | 59.4 | 4.44 | 1.91 |
| 4-7 | butanediol | carbonate | (1) | (1:3) | | | | | |
| | bis (2,2,2- | (2) | | | | | | | |
| | trifluoroethane | | | | | | | | |
| | sulfonate) | | | | | | | | |
| | (2) | | | | | | | | |
| Example | 1,4-butanediol | vinylene | LiPF₆ | EC + EMC | 4.34 | 0.72 | 55.9 | 4.44 | 1.52 |
| 4-8 | bis (2,2,2- | carbonate | (1) | (1:3) | | | | | |
| | trifluoroethane | (2) | | | | | | | |
| | sulfonate) | | | | | | | | |
| | (1) | | | | | | | | |
| Example | 1,4- | vinylene | LiPF₆ | EC + EMC | 4.35 | 1.24 | 56.1 | 4.44 | 2.26 |
| 4-9 | butanediol- | carbonate | (1) | (1:3) | | | | | |
| | dimethane- | (2) | | | | | | | |
| | sulfonate | | | | | | | | |
| | (1) | | | | | | | | |
| Example | 1,4- | vinylene | LiPF₆ | EC + EMC | 4.35 | 1.07 | 58.2 | 4.44 | 2.00 |
| 4-10 | butanediol | carbonate | (1) | (1:3) | | | | | |
| | bis (trifluoro- | (2) | | | | | | | |
| | methane | | | | | | | | |
| | sulfonate) | | | | | | | | |
| | (0.5) | | | | | | | | |
| Example | 1,4- | vinylene | LiPF₆ | EC + EMC + | 4.34 | 0.90 | 58.7 | 4.44 | 1.78 |
| 4-11 | butanediol | carbonate | (1.25) | DEC | | | | | |
| | bis (2,2,2- | (2) | | (1:1:1) | | | | | |
| | trifluoroethane | | | | | | | | |
| | sulfonate) | | | | | | | | |
| | (1) | | | | | | | | |
| Comparative | None | vinylene | LiPF₆ | EC + EMC | 4.34 | 1.67 | 55.7 | 4.44 | 5.01 |
| example 4-2 | | carbonate | (1) | (1:3) | | | | | |
| | | (3) | | | | | | | |

TABLE 4-2

| | | | | | cycle characteristics evaluation | | |
|---|---|---|---|---|---|---|---|
| | Composition of electrolyte solution | | | | | terminal-to- | |
| | | unsaturated | | | | terminal open | capacity |
| | Sulfonate | carbonate | | non-aqueous | | circuit voltage | retention rate |
| | compound | compound | Electrolyte | solvent | cycle test | at the first | after cycle |
| | (weight %) | (weight %) | (M) | (mixing ratio) | condition | cycle time (V) | test (%) |
| Example | 1,4- | None | LiPF₆ | EC + EMC | 50 times | 4.40 | 91.7 |
| 4-12 | butanediol | | (1) | (1:3) | at 4.4 V | | |
| | bis (2,2,2- | | | | | | |
| | trifluoroethane | | | | | | |
| | sulfonate) | | | | | | |
| | (1) | | | | | | |
| Example | 1,4- | None | LiPF₆ | EC + EMC | 50 times | 4.40 | 90.3 |
| 4-13 | butanediol- | | (1) | (1:3) | at 4.4 V | | |
| | dimethane- | | | | | | |
| | sulfonate | | | | | | |
| | (1) | | | | | | |
| Comparative | None | None | LiPF₆ | EC + EMC | 50 times | 4.40 | 87.6 |
| example 4-3 | | | (1) | (1:3) | at 4.4 V | | |
| Example | 1,4- | Vinylene | LiPF₆ | EC + EMC | 50 times | 4.39 | 96.2 |
| 4-14 | butanediol | carbonate | (1) | (1:3) | at 4.4 V | | |
| | bis (2,2,2- | (2) | | | | | |
| | trifluroethane | | | | | | |
| | sulfonate) | | | | | | |
| | (1) | | | | | | |
| Example | 1,4- | Vinylene | LiPF₆ | EC + EMC | 50 times | 4.40 | 95.1 |
| 4-15 | butanediol- | carbonate | (1) | (1:3) | at 4.4 V | | |
| | dimethane- | (2) | | | | | |
| | sulfonate | | | | | | |
| | (1) | | | | | | |
| Comparative | None | Vinylene | LiPF₆ | EC + EMC | 50 times | 4.40 | 92.5 |
| example 4-4 | | carbonate | (1) | (1:3) | at 4.4 V | | |
| | | (2) | | | | | |
| Comparative | Cyclohexyl- | Vinylene | LiPF₆ | EC + EMC | 50 times | 4.40 | 85.1 |
| example 4-5 | benzene | carbonate | (1) | (1:3) | at 4.4 V | | |
| | (1) | (2) | | | | | |
| Reference | 1,4- | Vinylene | LiPF₆ | EC + EMC | 200 times | 4.20 | 90.9 |
| example 4-1 | butanediol | carbonate | (1) | (1:3) | at 4.2 V | | |
| | bis (2,2,2- | (2) | | | | | |
| | trifluoroethane | | | | | | |
| | sulfonate) | | | | | | |
| | (1) | | | | | | |
| Reference | None | Vinylene | LiPF₆ | EC + EMC | 200 times | 4.20 | 86.3 |
| example 4-2 | | carbonate | (1) | (1:3) | at 4.2 V | | |
| | | (2) | | | | | |
| Reference | Cyclohexyl- | Vinylene | LiPF₆ | EC + EMC | 200 times | 4.20 | 90.9 |
| example 4-3 | benzene | carbonate | (1) | (1:3) | at 4.2 V | | |
| | (1) | (2) | | | | | |

From Table 4-1, it is evident that, by including the sulfonate compound of the present invention in the non-aqueous electrolyte solution, it is possible to reduce the amount of gas evolved on continuous charge characteristics test when charge was done up to a high terminal-to-terminal open circuit voltage such as 4.35 V and 4.45 V, and to improve the retention capacity retention rate at 4.35 V. It was also evident that, by using the non-aqueous electrolyte solution containing unsaturated carbonate compound in particular (Examples 4-6 to 4-11), it is possible to achieve both reduction in evolved gas and improvement in retention capacity at a high level.

Furthermore, from Table 4-2, it was found possible, by including the sulfonate compound of the present invention in the non-aqueous electrolyte solution, to achieve improvement in capacity retention rate at a high voltage cycle test such as 4.4 V. Furthermore, from the results of Reference examples of 4-1 to 4-3 representing a cycle test at 4.2 V, and also the results of Example of 4-14 and Comparative examples of 4-4 and 4-5 representing a cycle test at 4.4 V, it was found that an additive such as cyclohexylbenzene, which has been known to improve cycle characteristics, may sometimes result in deterioration of the characteristics at a high voltage cycle test such as 4.4 V.

### INDUSTRIAL APPLICABILITY

The use of the lithium secondary battery of the present invention is not limited to special ones. It can be used for various known purposes. As concrete examples can be cited notebook computers, pen-input personal computers, mobile personal computers, electronic book players, cellular phones, portable facsimiles, portable copiers, portable printers, headphone stereos, videotape cameras, liquid crystal display televisions, handy cleaners, portable CD players, mini disc players, transceivers, electronic databooks, electronic calculators, memory cards, portable tape recorders, radios, backup power supplies, motors, illuminators, toys, game machines, watches, electrical flash, cameras, etc.

1. A method comprising operating a lithium secondary battery under a condition of a terminal-to-terminal open circuit voltage at 25° C. at the end of charge being 4.25V or higher, the lithium secondary battery comprising:
a positive electrode;
a negative electrode; and
a non-aqueous electrolyte solution comprising both at least one vinylethylene carbonate compound and at least one vinylene carbonate compound.

2. The method as defined in claim 1, wherein said vinylene carbonate compound is vinylene carbonate.

3. The method as defined in claim 1, wherein said vinylethylene carbonate compound is at least one type selected from the group consisting of vinylethylene carbonate, 1,2-divinylethylene carbonate and 1-methyl-1-vinylethylene carbonate.

4. The method as defined in claim 1, wherein the terminal-to-terminal open circuit voltage is 4.3 V or higher.

5. The method as defined in claim 1, wherein said non-aqueous electrolyte solution comprises said at least one vinylethylene carbonate compound in an amount of from 0.1 to 8 wt % and said at least one vinylene carbonate compound in an amount of from 0.1 to 10 wt %.

6. The method as defined in claim 1, wherein said non-aqueous electrolyte solution comprises said at least one vinylethylene carbonate compound in an amount of from 0.5 to 3 wt % and said at least one vinylene carbonate compound in an amount of from 0.5 to 3 wt %.

7. The method as defined in claim 1, wherein the molar ratio of said vinylethylene carbonate compound to the total number of moles of said vinylethylene carbonate compound and said vinylene carbonate compound is from 0.01 to 0.9.

8. The method as defined in claim 1, wherein the molar ratio of said vinylethylene carbonate compound to the total number of moles of said vinylethylene carbonate compound and said vinylene carbonate compound is from 0.2 to 0.7.

9. The method as defined in claim 1, wherein said non-aqueous electrolyte solution comprises a non-aqueous solvent selected from the group consisting of a chain carbonate, a cyclic carbonate, a chain ester, a cyclic ester, a chain ether, and a cyclic ether.

10. The method as defined in claim 9, wherein said non-aqueous solvent comprises a cyclic carbonate, and a chain carbonate or cyclic ester, in an amount of at least 70 wt % of said non-aqueous solvent.

11. The method as defined in claim 10, wherein said non-aqueous solvent comprises ethylene carbonate and ethylmethyl carbonate.

12. The method as defined in claim 11, wherein the ethylene carbonate and ethylmethyl carbonate are present in a molar ratio of 1:3.
